(19) United States
(12) Patent Application Publication
(10) Pub. No.: US 2025/0141370 A1
(43) Pub. Date: May 1, 2025

(54) NANOFIBER YARNS FOR ELECTROCHEMICALLY HARVESTING ELECTRICAL ENERGY FROM MECHANICAL DEFORMATION

(71) Applicants: Board of Regents, The University of Texas System, Austin, TX (US); Industry-University Cooperation Foundation Hanyang University, Seoul (KR)

(72) Inventors: Ray BAUGHMAN, Dallas, TX (US); Zhong WANG, Dallas, TX (US); Mengmeng ZHANG, Dallas, TX (US); Wenting CAI, Dallas, TX (US); Shaoli FANG, Richardson, TX (US); Seon Jeong KIM, Seoul (KR); Tae Jin MUN, Seoul (KR); Ji Hwan MOON, Seoul (KR)

(73) Assignees: BOARD OF REGENTS, THE UNIVERSITY OF TEXAS SYSTEM, Austin, TX (US); INDUSTRY-UNIVERSITY COOPERATION FOUNDATION HANYANG UNIVERSITY, Seoul, KR (KR)

(21) Appl. No.: 18/531,438

(22) Filed: Dec. 6, 2023

Related U.S. Application Data
(60) Provisional application No. 63/431,443, filed on Dec. 9, 2022.

(51) Int. Cl. H02N 1/08

(52) U.S. Cl. CPC H02N 1/08

(57) ABSTRACT

Improved electrochemical yarn energy harvesters that convert mechanical energy to electrical energy. These harvesters include an ionically conducting electrolyte, and an electronically conducting material, and a material that can undergo charge injection, which can also be the electronically conducting material. At least one device electrode is either twisted, twisted and coiled, or twisted and plied.

### CROSS-REFERENCE TO RELATED PATENT APPLICATIONS

This application claims priority to U.S. Patent Appl. Ser. No. 63/431,443, filed Dec. 9, 2022, entitled “Nanofiber Yarns For Electrochemically Harvesting Electrical Energy From Mechanical Deformation,” which patent application is commonly owned by the owner of the present invention. This patent application is incorporated herein in its entirety.

### STATEMENT OF GOVERNMENT INTEREST

This invention was made with government support under grant N68335-19-C-0303 from the Department of Defense (Navy) ONR/STTR and under grant FA9550-18-1-510 the Air Force Office of Scientific Research. This invention was also made with government support in Korea by the Creative Research Initiative Center for Self-Powered Actuation of the National Research Foundation and the Ministry of Science and ICT (MSIT). The United States government has certain rights in the invention.

### FIELD OF THE INVENTION

Yarn energy harvesters containing conducting nanomaterials, which yarn energy harvesters that can electrochemically convert the energy change of tensile or torsional deformations directly into electrical energy.

### BACKGROUND OF INVENTION

Improved means for converting mechanical energy to electricity are needed for diverse applications, from harvesting ocean wave energy to power cities to using body motion to power sensors and energy-storage devices in and on the human body. [Wang I 2017; Liu 2018; Vallem 2021; Xu 2020; Zhang 2018; Yang 2021].

Electromagnetic electric energy generators, which are basically motors operated in reverse, have been available for almost two centuries, and successfully meet many needs. However, they suffer from low power densities and high cost per Watt when scaled to the millimeter and smaller dimensions needed for emerging applications. Piezoelectric and ferroelectric harvesters work well for high-frequency, low-strain deformations, especially, when individual nanofibers are driven at ultrahigh resonant frequencies, but lack the elasticity needed for harvesting the energy of large tensile strains. Electrostatic harvesters based on triboelectric charge provide remarkable performance, and are promising for future applications. Harvesters using the coupling between flowing fluids and electronic charge are also receiving considerable attention, but need improvements to increase power output. Various types of electrochemically-based mechanical energy harvesters are known, including conducting polymer harvesters, lithium-battery-based bending harvesters, and ionic-polymer-metal-composite (IPMC) harvesters, but have so far not provided competitive performance. The capacitance change caused by mechanically changing the area of liquid contact with two charged or self-charged capacitor electrodes has been used for dielectric and electrochemical energy harvesting, but are in early development.

Rubber-based dielectric capacitors provide an especially attractive way to convert large-stroke mechanical energy into electrical energy. In commercial devices, a thin elastomeric sheet is sandwiched between two deformable electrodes. An applied voltage (V), typically about a thousand volts, is used to inject a charge, Q, into this elastomeric capacitor. When stretched, the Poisson's ratio causes the rubber dielectric to decrease thickness, thereby increasing capacitance (C). A stress-induced capacitance change (ΔC) produces a voltage change, according to Q=CV, which enables efficient harvesting of electrical energy.

Recently described coiled carbon nanotube (CNT) yarns, called twistrons [Kim 2017; Baughman '422 Patent], use stretch-induced changes in electrochemical capacitance to generate higher peak electrical power per harvester weight than generated by any prior-art mechanical energy harvester for mechanical frequencies between 6 and 600 Hz.

The electrochemical capacitance changes that produce electricity result from mechanically generated changes in yarn twist. Increasing yarn twist increases yarn density, compressing and partially eliminating the electrochemical double layers of CNTs, and twist release reverses this. These twist changes result from either twisting a non-coiled CNT yarn or stretching a torsionally-tethered coiled yarn, thereby reversibly converting the twist of coiling to yarn twist. While high performance non-electrochemical capacitance-based dielectric harvesters typically use thousand-volt-scale applied voltages [Pelrine 2001; Chiba 2008; Shian 2014], twistrons can harvest without an externally applied bias voltage [Kim 2017; Baughman '422 Patent] since the used electrolytes inject either electrons or holes into the CNTs. Such self-biasing was deployed for self-powered strain sensors that generate a voltage between opposite ends of a stretched coiled CNT yarn. [Li 2021].

However, increased gravimetric electrical power generation and increased energy conversion efficiencies are needed for these twistron devices.

### SUMMARY OF INVENTION

In general, in certain embodiments, the invention features methods for dramatically increasing twistron harvesting, which are primarily based on increasing mechanically-induced changes in electrochemical capacitance. These improvements can be achieved by incorporating conducting nanosheets in twistron yarn corridors, optimizing the alignment of precursor CNT forests, plastically stretching the precursor twisted yarn, applying much higher tensile loads during pre-coiling twist than for coiling, and using incandescent tension anneal process (ITAP) for electrothermal pulse annealing under tension. In contrast to prior methods, such Di 2016, it has been discovered that harvester performance is unexpectantly improved when ITAP was applied to a low twist yarn (such as with a bias angle of about 22°) when the yarn was under a relatively low tensile stress (such as about 34 MPa).

Such improved yarn energy harvesters containing conducing nanomaterials (such as carbon nanotube (CNT) yarn energy harvesters) can electrochemically convert tensile or torsional mechanical energy into electrical energy. In embodiments, the twistron harvesters of the present invention can generate a peak output power for a 1 Hz and a 30 Hz sinusoidal stretch of 0.73 and 3.19 kW/kg, which are 15-and 13-fold that of previous twistron harvesters at these respective frequencies. [Kim 2017; Baughman '422 Patent]. This performance at 30 Hz was over 12-fold that of other prior-art mechanical energy harvesters for frequencies between 1 Hz and 600 Hz. The maximum energy conversion efficiency was 7.2-fold that for previous twistrons. [Kim 2017; Baughman '422 Patent]. These advances were obtained by major improvements in the fabrication and structure of twistron harvesters, including transiting from twisted but not coiled and twisted and coiled harvesters to harvesters that are twisted and plied.

Thus, in embodiments of the present invention, using these improvements, the energy conversion efficiency of twistrons can be increased over 7-fold and the peak power output reached values that are 12-fold those reported for previous materials-based technologies for key frequency ranges. These powerful twistrons can be integrated into diverse devices and applications, such as hinged wine-rack frames and Scotch yokes to harvest tensile and torsional mechanical energy and used as self-powered strain sensors for recognizing sign language.

In general, in one embodiment, the invention features an electrochemical mechanical energy harvester operable to generate electricity both with and without an external bias voltage. The harvester includes a first electrode, a second electrode, and at least one electrolyte. At least one of the first electrode and the second electrode includes an electronically conducting yarn that is (i) twisted, (ii) twisted and coiled, (iii) twisted and plied, or (iv) twisted and coiled and then plied. Both the first electrode and the second electrode are electronically conducting, have a high electrochemical surface area, and are in direct contact with an electrolyte. A path for ionic conductivity exists between the first electrode and the second electrode. At least one of the first electrode and the second electrode is twisted, twisted and coiled, or twisted and plied, and wherein (i) both the first electrode and the second electrode have attachments that enable one of the first electrode and the second electrode to be mechanically deformed while mechanical deformation is released from the other electrode, (ii) at least one of the first electrode and the second electrode is twisted and plied, (iii) the first electrode and the second electrode are both twisted and coiled (wherein a heterochiral yarn is mandrel coiled around a self-coiled homochiral yarn with a solid or gel electrolyte electronically separating the first electrode and the second electrode), or (iv) a combination thereof

Implementations of the invention can include one or more of the following features:

The energy harvester can be operable to convert tensile deformation directly into electrical energy.

The energy harvester can be operable to convert torsional deformation directly into electrical energy.

Both the first electrode and the second electrode can have attachments that enable one of these electrodes to be mechanically deformed while mechanical deformation is released from the other electrode. One end of the first electrode can be mechanically connected to one end of the second electrode through an insulator and the opposite ends of the first electrode and the second electrode are torsionally and positionally tethered, so that displacement of the connection point can cause oppositely directed length changes of the first electrode and the second electrode.

Both the first electrode and the second electrodecan have attachments that enable one of these electrodes to be mechanically deformed while mechanical deformation is released from the other electrode. The electrode deformations can be produced by either the rotation of a Scotch yoke or the dimensional changes of a wine-rack configuration.

One of the first electrode and the second electrode is a harvesting electrode that can be deformed during harvesting and that can include a high surface-area carbon material.

The high-surface-area carbon material can be selected from a group consisting of carbon nanotubes, carbon nanohorns, graphene, fullerene, activated carbon, carbon black, carbon nanofibers, a pyrolized organic material, and combinations thereof.

The energy harvester can be operable to provide at least 50 W of peak electrical power per kilogram of the twisted, high-electrochemical-surface-area, conductive yarn when stretched at least one rate that is above 10 Hz.

The energy harvester can be operable to provide at least 50 J of electrical energy per kilogram of the twisted, high-electrochemical-surface-area, conductive yarn per mechanical cycle when stretched at a frequency that is below 1 Hz.

At least one of the first electrode and the second electrode can include an electronically conducting yarn that is (i) twisted, (ii) twisted and coiled, (iii) twisted and plied, or (iv) twisted and coiled and then plied, and the twisted yarn can have a diameter between 100 nm and 500 μm.

The energy harvester can be operable to generate a change of voltage of at least 150 mV during stretch.

At least one of first and second electrodes can include a twisted and plied yarn.

The twisted and plied yarn can include carbon nanotubes.

The chirality of yarn twist can be the same as the chirality of yarn plying.

Three yarns can be plied together.

The coil bias angle that results from plying can be over 25°.

The spring index of the yarn obtained by plying can be at most 1.2.

The three plied yarns can be coiled together.

The electrochemical mechanical energy harvester can be deployed as a self-powered strain sensor.

The electrochemical mechanical energy harvester can be deployed for converting wind or wave mechanical energy to electricity.

In general, in another embodiment, the invention features a self-powered strain sensor that includes an above-described electrochemical mechanical energy harvester.

Implementations of the invention can include one or more of the following features:

The electrochemical mechanical energy harvester can be a self-powered strain sensor

In general, in another embodiment, the invention features an apparatus for converting wind or wave mechanical energy to electricity that includes an above-described electrochemical mechanical energy harvester.

Implementations of the invention can include one or more of the following features:

The electrochemical mechanical energy harvester can be utilized to convert wind or wave mechanical energy to electricity

In general, in another embodiment, the invention features a textile that that includes an above-described electrochemical mechanical energy harvester.

In general, in another embodiment, the invention features an apparatus that includes an above-described electrochemical mechanical energy harvester connected to an energy storage device.

In general, in another embodiment, the invention features a system that includes a plurality of above-described electrochemical mechanical energy harvesters. The plurality of electrochemical mechanical energy harvester are connected (a) in series to increase output voltage, (b) in parallel to increase output current, (c) or a combination thereof.

In general, in another embodiment, the invention features a method of operating an above-described electrochemical mechanical energy harvester. A first time interval exists soon after electrode deformation to substantially the maximally deformed state. During the first time interval, further electrode deformation does not substantially occur, but during which mechanical energy harvesting is conducted.

Implementations of the invention can include one or more of the following features:

A second time interval can exists soon after deformation release to substantially the minimally deformed state. During the second time interval, further electrode deformation does not substantially occur, but during which mechanical energy harvesting is conducted

In general, in another embodiment, the invention features a method of operating an above-described electrochemical mechanical energy harvester. A first time interval exists soon after electrode deformation to substantially the minimal deformed state. During the first time interval, further electrode deformation does not substantially occur, but during which mechanical energy harvesting is conducted.

In general, in another embodiment, the invention features a method of operating an above-described electrochemical mechanical energy harvester. The output peak or average electrical energy for the same percent stretch is increased in the approximate frequency range of 0.1 to 5 Hz by applying a square-wave stretch, rather than a sinusoidal stretch.

In general, in another embodiment, the invention features a process for making a twisted and plied yarn electrode for a mechanical energy harvester. The method include that three twisted yarns having the same twist chirality are plied together using the same chirality of plying as for the chirality of yarn twist while under a mechanical stress that is less than one-half of the mechanical stress applied during the fabrication of these twisted yarns.

In general, in another embodiment, the invention features a process for making a twisted and coiled mechanical harvester yarn that includes carbon nanotubes. The process includes twist insertion into an oriented carbon nanotube sheet that has a Herman's orientation factor that is in the range between approximately 0.45 and approximately 0.75.

Implementations of the invention can include one or more of the following features:

The process can form a twisted and coiled mechanical harvester yarn including carbon nanotubes and graphene nanoplatelets, The process can include depositing graphene oxide nanoplatelets or graphene nanoplatelets on an oriented carbon nanotube sheet.

An incandescence tension anneal process can be applied to the twisted yarn before the yarn is coiled. The bias angle of the twisted yarn can be between 10° and 35°. The peak temperature applied during the incandescence tension anneal process can be above 2000° C.

An incandescence tension anneal process can be applied to the twisted yarn before the yarn is coiled. The applied stress can be between 10 MPa and 70 MPa. The treatment time can be between 5 seconds and 300 seconds at a temperature above 2000° C.

Irreversible plastic deformation can be applied to the twisted yarn before the yarn is coiled. The bias angle of the twisted yarn can be between 10° and 35°. The applied strain can be below a threshold that would cause the yarn to fracture.

In general, in another embodiment, the invention features a process for making a twisted and coiled yarn electrode for a mechanical energy harvester. The process includes that mechanical stress is applied during yarn twist that is more than two times the mechanical stress applied during yarn coiling.

Implementations of the invention can include one or more of the following features:

The mechanical loads applied during yarn twist and yarn coiling can be sufficient to provide a spring index that is between 0.3 and 0.8.

### BRIEF DESCRIPTION OF THE DRAWINGS

FIGS. 1A-1E show twistron fabrication, structure, and characterization, and the effects of CNT orientation on energy harvesting in 0.1 M aqueous HCl by using a 1 Hz, 35% sinusoidal stretch. FIG. 1A is SEM images and illustration of cone spinning for fabricating twisted and coiled neat CNT yarns from forest-drawn CNT sheets (method 101), its modification for making rGO@CNT yarns (method 102), and illustration of the electrochemical cell used for characterizing coiled harvester yarns (cell 103). FIG. 1B shows the time dependencies of applied tensile strain and resulting changes in open-circuit potential (OCP versus Ag/AgCl reference) and short-circuit current (SCC) for a coiled harvester. FIG. 1C shows the dependencies of the pre-stretch capacitance, peak OCV, peak electrical power, and energy per cycle, of coiled CNT twistrons on the HOF of the precursor forest-drawn CNT sheets. FIG. 1D shows, for a non-coiled, 30-mm-long, 100-μm-diameter CNT yarn being twisted and untwisted at 3.33 turn cm⁻¹ per second, the dependencies of the capacitance and OCP on isometric twist and untwist (with the inset showing the experimental apparatus). FIG. 1E shows the peak OCV and percent capacitance and resistance decreases (relative to their values at 12 turns cm⁻¹) as a function of twist density during isometric twist for non-coiled yarns made from CNT sheets having different values of HOF. A precursor CNT sheet with a HOF of 0.64 was used for FIGS. 1B and 1D.

FIGS. 2A-2B show the time dependencies of the open circuit potential during a 1 Hz, 35% stretch for coiled CNT harvesters fabricated from precursor sheets having a HOF of 0.49 (FIG. 2A) and 0.64 (FIG. 2B).

FIGS. 2C-2D show the time dependencies of power output during a 1 Hz, 35% stretch for coiled CNT harvesters fabricated from precursor sheets having a HOF of 0.49 (FIG. 2C) and 0.64 (FIG. 2D).

FIGS. 2E-2F show CV measurements showing the capacitance change for 35% stretch for coiled CNT harvesters fabricated from precursor sheets having a HOF of 0.49 (FIG. 2E showing 0% stretch and 35% stretch for plots 201-202, respectively) and 0.64 (FIG. 2F showing 0% stretch and 35% stretch for plots 211-212, respectively).

FIG. 3A-3D show energy harvesting by isometric twist and untwist for yarns made from forest-drawn CNT sheets having a HOF of 0.64, which are in the performance plot of FIG. 1E. FIG. 3A shows OCP versus time during twist and untwist between a twist density of 12 turns/cm and 24 turns/cm. FIG. 3B shows CV curves and corresponding capacitances for twistron having a twist density of 12 turns/cm and 24 turns/cm (plots 301-302, respectively). FIG. 3C shows power output during twist insertion and twist release at 900 rpm. FIG. 3D shows the dependence of peak power, average power, and energy per cycle on twist speed (plots 311-313, respectively).

FIGS. 4A-4G show using irreversible stretch and ITAP for increasing harvesting in 0.1 M aqueous HCl. FIG. 4A shows the dependencies of peak OCV, peak power, and energy per cycle for a 1 Hz, 35% stretch of coiled twistrons on the applied strain and the strain of irreversible stretch for the precursor twisted yarn (plots 401-403, respectively). FIG. 4B shows the frequency dependencies of peak power, average power, and energy per cycle for coiled twistron harvesters undergoing the above stretch, before (plots 411-413, respectively) and after (plots 421-423, respectively) using a 4% applied strain to provide irreversible stretch of the precursor twisted yarn. FIG. 4C shows an illustration 424 and photograph 425 of a CNT yarn during ITAP and SEM images of a CNT yarn before (SEM 426-427) and after (SEM 428-429) ITAP. FIG. 4D shows the dependence of coiled yarn capacitance and the surface HOF of precursor twisted yarn on ITAP time (plots 431-432, respectively). FIG. 4E shows the dependencies of peak OCV, peak power, and energy per cycle of coiled twistrons for a 45% stretch on ITAP time for a 1 Hz stretch (plots 441-443, respectively). FIG. 4F shows the dependencies of peak OCV, peak power, and energy per cycle of coiled twistrons for a 45% stretch on stretch frequency before (plots 451-453, respectively) and after (plots 461-463, respectively) a 90 s ITAP. FIG. 4G shows the dependencies of coiled yarn capacitance and the surface HOF for twisted yarns on the applied strain (plots 471-472, respectively) resulting in irreversible stretch for FIG. 4A.

FIGS. 5A-5D shows the performance of coiled CNT harvesters in 0.1 M aqueous HCl electrolyte as a function of the yarn's bias angle and the applied stress during ITAP. FIG. 5A shows the dependencies of peak OCV, peak power, and energy per cycle on yam bias angle during ITAP for a 1 Hz, 45% stretch of coiled harvesters (plots 501-503, respectively). FIG. 5B shows the dependencies of peak OCV, peak power, and energy per cycle on the applied stress during ITAP for a 1 Hz, 45% stretch of coiled harvesters (plots 511-513, respectively). FIG. 5C shows the dependence of the capacitance of fabricated coiled twistron yam on the stress applied during ITAP to the twisted yam. FIG. 5D shows the frequency dependence of average power for CNT twistron harvesters before and after ITAP (plots 521-522, respectively).

FIGS. 6A-6G show the tension optimization process (TOP) and the performance of TOP twistron harvesters in 0.1 M aqueous HCl. FIG. 6A shows the yam's Herman's orientation factor (HOF) and density as a function of the applied stress during twisting (plots 601-602, respectively). FIG. 6B shows, for a 77% sinusoidal stretch at 1 Hz, the peak power, average power, and maximum measured capacitance change of the coiled yam as a function of the HOF for the fully twisted yam (plots 611-613, respectively). All coiled yams of FIG. 6B were fabricated from the twisted yams using a coiling stress of 3.2 MPa. FIG. 6C show the spring index and total strain as a function of the isobaric stress applied during coiling (plots 621-622, respectively), when the stress during twist was 140.7 MPa. FIG. 6D shows, for the maximum strain of each spring index from FIG. 6C at 1 Hz, the peak power, average power, and maximum measured capacitance change as a function of the spring index (plots 631-633, respectively). FIG. 6E shows The frequency dependencies of peak power, average power, and energy per cycle for a 65% stretch, before (plots 671-673, respectively) and after (plots 661-663, respectively) incorporating a Pt wire into a coiled TOP twistron that was fabricated using a 140.7 MPa stress during twist and a 3.2 MPa stress during coiling. FIG. 6F shows the peak power, average power, and electrical energy per cycle during 30,000 stretch-and-release cycles to 60% total strain at 1 Hz for the twistron yam (plots 671-673, respectively). FIG. 6G shows output power versus time during typical cycles for FIG. 6F.

FIGS. 7A-7D shows relationships between total strain, volume change, and capacitance change for TOP CNT twistrons. FIG. 7A shows optical images of a twistron harvester that is stretched by 0, 51, and 77% (images 701-703, respectively). FIG. 7B shows the strain dependence of yam specific volume (calculated from optical images), specific capacitance, and capacitance change (plots 711-713, respectively). FIGS. 7A-7B were obtained for a TOP CNT twistron that used applied stresses of 140.7 and 3.2 MPa during twist insertion and coiling. FIG. 7C shows the specific capacitance and specific volume of a coiled yam as a function of the HOF calculated from surface images of the fully-twisted yam just before coiling (plots 721-722, respectfully, for 0% total strain and plots 731-732, respectfully, for 77% total strain). FIG. 7D shows the percent change in volume and capacitance for these yams shown in FIG. 7C as function of HOF. The progressively increasing HOFs in FIGS. 7C-7D were obtained for TOP CNT twistrons that used progressively increasing applied stresses of 3.3, 20.8, 42.5, 87.7, 140.7, and 191.2 MPa during twist insertion. The same 3.2 MPa stress was used during coiling for all twistrons.

FIGS. 8A-8B show the effect of snarling for TOP CNT twistrons. FIG. 8A shows the positive and negative strains (for non-snarled and snarled strain regions, respectively) for coiled yams as a function of the spring index (plots 801-802, respectively). FIG. 8B shows the spring index dependencies of the average power and energy per cycle for a stretch that uses the total strain (plots 811-812, respectively) and only the snarling-free strain (plots 821-822, respectively). The generated power and energy were obtained in 0.1 M HCl aqueous electrolyte for a 1 Hz stretch.

FIGS. 9A-9B shows the tensile energy conversion efficiency of a TOP CNT twistron. FIG. 9A shows stress-strain curves (during stretch and stretch release), which is used for calculating the input mechanical energy for a TOP twistron yam during a mechanical cycle to-and-from a total strain of 58%. The stretch-release cycle was at 0.1 Hz for a twistron whose performance was stabilized before the pictured 10th stress-strain cycle. Inset 901 shows an expanded stress scale, so that the effect of snarling can be better seen. FIG. 9B shows the dependencies of energy conversion efficiency, harvested energy, and input energy on total strain for a Pt-wire-wrapped TOP yam during cycling at 0.1 Hz (plots 911-913, respectively). The TOP CNT twistron was fabricated by applying a 140.7 MPa stress during twist insertion and a 3.2 MPa stress during coiling.

FIGS. 10A-10B shows energy harvesting in 0.1 M aqueous HCl electrolyte by inserting and removing twist from the coiled TOP yarn without changing the number of coils. FIG. 10A shows the twist speed dependencies of input mechanical energy per cycle, output electrical energy per cycle, and torsional energy conversion efficiency for a fully coiled TOP twistron during isometric twist insertion and removal (plots 1001-1003, respectfully). When normalized to the length of the coiled yam (18.1 mm), the change in twist density (with respect to the initial fully coiled yam) was a twist increase of 11 turns/cm. FIG. 10B shows the twist speed dependencies of peak power, average power, and energy per cycle for this fully coiled TOP twistron (plots 1011-1013, respectfully).

FIGS. 11A-11F shows harvesting by a biscrolled coiled rGO@CNT twistron in 0.1 M aqueous HCl. FIG. 11A shows the small-angle X-ray scattering intensity as a function of scattering vector for the twisted pristine yarn, 30 s ITAP-treated CNT yarn, GO@CNT yarn, and 30 s ITAP-treated rGO@CNT yarn (plots 1101-1104, respectively). FIG. 11B shows the 2D wide-angle X-ray scattering patterns for the twisted pristine yarn, 30 s ITAP-treated CNT yarn, GO@CNT yarn, and 30 s ITAP-treated rGO@CNT yarn. The diffraction peak corresponding to the interlayer separation in GO is marked by arrows in FIG. 11B. Due to the difficulty in precisely aligning the direction of the twistron with respect to the X-ray beam, there is no meaning to the deviation between equatorial and horizontal directions for images in FIG. 11B. FIG. 11C shows the dependencies of peak OCV, peak power, and energy per cycle on graphene content for a 1 Hz, 45% stretch of rGO@CNT harvesters (plots 1111-1113, respectively). FIGS. 11D shows the frequency dependencies of peak power, average power, and energy per cycle before (plots 1121-1123, respectively) and after (plots 1131-1133, respectively) including a Pt wire current collector. FIG. 11E shows peak power versus frequency for piezoelectric (PZ), electrostatic (ES), triboelectric (TEG), and dielectric elastomer (DEG), prior-art twistrons, and twistrons of the present invention electricity generators (symbols 1161-1166, respectively). FIG. 11F shows frequency-normalized peak power versus frequency for piezoelectric (PZ), electrostatic(ES), triboelectric (TEG), and dielectric elastomer (DEG), prior-art twistrons, and twistrons of the present invention electricity generators (symbols 1171-1176, respectively).

FIGS. 12A-12C shows the effect of an externally applied bias voltage on tensile energy harvesting for a rGO@CNT twistron harvester that is undergoing a 46% stretch at 0.25 Hz in 0.1 M HCl. FIG. 12A shows the energy delivered to an external resistive load, the energy consumed in providing the external bias voltage, and the net energy harvested (plots 1201-1203, respectively) as a function of the externally applied bias voltage. FIGS. 12B-12C show the energy delivered to an external resistive load (FIG. 12B) and the energy consumed in providing the external bias voltage (FIG. 12C) for an applied bias voltage of 0.4 V.

FIGS. 13A-13D show the performance of a rGO@CNT twistron harvester in an organic electrolyte (0.1 M LiBF4 in acetonitrile). FIG. 13A shows CV curves (at 50 m V/s scan rate) providing the capacitance and capacitance change for 48% stretch (plots 1301-1302, respectively). FIG. 13B shows the open-circuit voltage and the voltage across a 270 ohm load resistor for 48% stretch at 1 Hz. FIG. 13C shows the load resistance dependencies of peak voltage, peak power, and energy per cycle for a 1 Hz, 48% stretch (plots 1311-1313, respectively). FIG. 13D shows the frequency dependencies of peak power, peak OCV, and energy per cycle for a 48% stretch (plots 1311-1313, respectively).

FIGS. 14A-14C show the effect of an externally applied bias voltage on tensile energy harvesting by a rGO@CNT twistron harvester when using a 48% stretch at 0.25 Hz and an electrolyte comprising 0.1 M LiBF4 in acetonitrile. FIG. 14A shows the energy delivered to an external resistive load, the energy consumed in providing the external bias voltage, and the net energy harvested as a function of the externally applied bias voltage (plots 1401-1403, respectively). FIGS. 14B-14C show plots showing (shaded areas) the energy delivered to an external resistive load (FIG. 14B), and the energy consumed in providing the external bias voltage (FIG. 14C), for an applied bias voltage of 0.6 V.

FIGS. 15A-15F show performance comparison for square-wave and sinusoidal-wave energy harvesting by coiled TOP twistrons in 0.1 M aqueous HCl. FIG. 15A shows the time dependence for 1 Hz sinusoidal and square-wave applied strains of the applied strain (plots 1501-1502, respectively) and the produced output power (plots 1503-1504, respectively). FIG. 15B shows the peak power, average power, and energy per cycle for a 65% stretch as a function of the frequency of the applied square-wave (plots 1511-1513, respectively) and sinusoidal (plots 1521-1523, respectively) strains for a Pt-wire-wrapped TOP coiled yam. FIG. 15C shows peak power and average power versus load resistance for a 1 Hz, 65% total strain by square-wave (plots 1531-1532, respectively) and sinusoidal (plots 1541-1542, respectively) deformations for a TOP harvester. FIG. 15D shows the frequency dependencies of peak-power-optimizing and average-power-optimizing load resistances for sinusoidal (plot 1551) and square-wave (plots 1552-1553, respectively) applied strains for a Pt-wire-wrapped TOP harvester. (Inset) The load resistance that provides maximum peak power and average power for square-wave and sinusoidal deformation at different frequencies. FIG. 15E shows the time dependence of the output voltage of a twistron-powered boost-converter circuit that was used for lighting an LED, when powered by stretching a TOP twistron yam by 20%, using a square-wave (plot 1556) and sinusoidal (plot 1557) strain. FIG. 15F shows, for FIG. 15D, that the LED emits light only when powered by the square-wave (with plots 1561-1562 for peak power for sinusoidal and square-wave strains, respectively, and plots 1571-1572 for average power for sinusoidal and square-wave strains, respectively). An LTC-3108 was used for the boost-converter.

FIGS. 16A-16E show performance comparison for sinusoidal and square-wave energy harvesting by rGO@CNT twistrons in 0.1 M aqueous HCl. FIG. 16A shows the time dependence of the open circuit potential for square-wave, triangle, sinusoidal, and sawtooth applied strains to 38% at 1 Hz. FIG. 16B shows the dependence of peak OCV on frequency for sinusoidal and square-wave deformations (plots 1601-1602, respectively). FIG. 16C shows peak power and average power versus load resistance for a 1 Hz, 48% strain by sinusoidal (plots 1611-1612, respectively) and square-waves (plots 1621-1622, respectively). FIG. 16D shows peak power, average power, and energy per cycle for a 48% stretch as a function of the frequency of the applied sinusoidal (plots 1631-1633, respectively) and square-wave (plots 1641-1643, respectively) strains for the load resistance that maximizes these quantities. FIG. 16E shows, for FIG. 16B, the dependence of performance optimizing load resistances, which optimizes either peak or average power, on frequency for sinusoidal (plot 1651) and square-wave (plots 1652-1653) deformations.

FIG. 17A shows the frequency dependencies of energy per cycle (plot 1701), energy during stretch (plot 1702), energy during release (plot 1703), and their ratio (plot 1704) for continuous sinusoidal deformation of a twistron.

FIG. 17B shows the frequency dependencies of energy per cycle (plot 1711), energy by stretch (plot 1712), energy by release (plot 1713), and their ratio (plot 1713) for the process in which an extra 2 s of harvesting time is inserted after stretch and stretch release.

FIGS. 18A-18F show fabrication and characterization of 3-ply twisted yam harvesters. FIG. 18A shows the fabrication of a 3-ply CNT twisted yam harvester involves cone spinning 1801 of a CNT sheet, twist inserting to make a 81-μm-diameter single-ply twisted yam 1802 (twist density: 28 turns/cm) and twisting 3 identical yams to provide a 3-ply yarn 1803 with twist density of plying of 16 turns/cm (scale bar, 100 μm). The applied stress for single yam twist and for plying were 42 MPa and 18 MPa, respectively. The re-shaded SEM image 1804 shows the twist configuration of a 15%-untwisted 3-ply yam harvester (scale bar, 100 μm). FIG. 18B shows capacitance and OCV versus applied strain for a 3-ply yam harvester in 0.1 M aqueous Li Cl electrolyte (plots 1811-1812, respectively). Illustration of the electrochemical cell 1813 used for twistron characterization is also shown in FIG. 18B. FIG. 18C shows the frequency dependencies of peak power, average power, and energy per cycle for 40% stretch of the 3-ply yam harvester in 0.1 M LiCl aqueous electrolyte, without (plots 1821-1823, respectively) and with (plots 1831-1833, respectively) a coiled 25-μm-diameter platinum wire current collector. FIG. 18D shows peak power, average power, and electrical energy per cycle during 40,000 sinusoidal 1 Hz cycles to 25% strain (plots 1841-1843, respectively). FIG. 18E shows the frequency dependencies of input mechanical energy per cycle, output electrical energy per cycle, and energy conversion efficiency for 40% strain of a 3-ply yam harvester in 0.1 M HCl (plots 1851-1853, respectively) and 0.1 LiCl (plots 1861-1863, respectively) electrolyte. FIG. 18F shows the time dependence of output power during the stretch cycling for a 94 Q load resistance for FIG. 18D.

FIG. 19 shows the plied spring index dependence of output average power, capacitance decrease (%), and maximum stretch strain for 3-ply yam harvesters (plots 1901-1903, respectively). The isobaric stress used during plying 3 yams to obtain a particular spring index is provided in the upper x-axis. FIG. 19 also shows an illustration of precursor harvesters 1904 during isobaric plying. To obtain this results, the 3-ply yam harvesters were sinusoidally stretched to a maximum strain at 1 Hz in 0.1 M LiCl aqueous electrolyte.

FIG. 20A shows the time dependence of tensile stress for 40% strain of an OPS harvester in 0.1 M HCl aqueous electrolyte during 0.1 Hz sinusoidal stretch.

FIG. 20B shows the curves of tensile stress versus stretch strain for the OPS harvester. The mechanical energy inputted (the shaded areas) in one stretch cycle is 2186.2 J/kg.

FIG. 20C shows the generated voltage for an external load resistance of 157 Q when the OPS harvester was sinusoidally stretched to 40% strain at 0.1 Hz.

FIG. 20D shows the output electrical power versus time for the stretch cycling and load resistance used for FIG. 20C. The red areas under the power curves are the energy output during stretch cycles.

FIG. 21A shows the frequency (ranged from 0.1 to 60 Hz) dependence of OCV and peak power for an OPS harvester with and without incorporating Pt wire (plots 2101-2102, respectively).

FIG. 21B shows the frequency (ranged from 0.1 to 60 Hz) dependence of average power and energy per cycle for an OPS harvester with and without incorporating Pt wire (plots 2111-2112, respectively). The harvester for FIGS. 21A-21B was sinusoidally stretched to 40% strain in 0.1 M HCl aqueous solution.

FIG. 22A shows the frequency dependencies of OCV and peak power for an OPS harvester for frequencies from 0.01 to 60 Hz (plots 2201-2202, respectively).

FIG. 22B shows the frequency dependencies of peak power, average power, and energy per cycle for an OPS harvester for the frequency range from 0.01 to 120 Hz (plots 2211-2213, respectively). For FIG. 22A-22B, the performance for the OPS harvester were obtained by sinusoidal stretching to 40% strain in 0.1 M LiCl aqueous electrolyte.

FIG. 23A shows the time dependencies of OCV for the homochiral (plot 2301) and heterochiral (plot 2303) harvester when stretched sinusoidally to 10% strain at 1 Hz in 0.1 M LiCl aqueous electrolyte. FIG. 23A further shows SEM images of the homochiral harvester 2302 (S twist) and heterochiral harvester 2304 (Z twist).

FIG. 23B shows SEM images of the non-stretched heterochiral harvester 2311 and the heterochiral harvester stretched to 20% strain 2312, respectively. The scale bars in FIGS. 23A-23B are 100 μm long.

FIG. 23C shows the strain dependence of OCV for the homochiral harvester and the heterochiral harvester (plots 2321-2322, respectively).

FIG. 23D shows the strain dependence of average power for the homochiral harvester and the heterochiral harvester (plots 2331-2332, respectively).

FIGS. 24A-24D show the dependence of harvester performance on the relative chirality of plied yams in a 3-plied yam harvesters that is operated in 0.1 M Li Cl aqueous electrolyte. FIG. 23A shows SEM images (scale bar: 100 μm) and illustration of the twist configurations for a homochiral harvester 2401 and a harvester 2402 in which one of the plied yams has a different chirality than the other two plied yams. FIG. 24B shows the 1-Hz stretch strain dependence of OCV and peak power for the homochiral harvester (plots 2411-2412, respectively) and the semi-heterochiral harvester (plots 2421-2422, respectively). FIG. 24C shows the 1-Hz stretch strain dependence of average power and energy per cycle for the homochiral harvester (plot 2431) and the semi-heterochiral harvester (plot 2432). FIG. 24B shows the peak voltage and peak power versus load resistance for the homochiral harvester (plots 2441-2442, respectively) and the semi-heterochiral harvester (plots 2451-2452, respectively) for 40% stretch strain at 1 Hz.

FIG. 25A shows the ply number dependence of capacitance decrease, OCV, and peak power (plots 2501-2503, respectively).

FIG. 25B shows the ply number dependence of load resistance for maximizing output power, average power, and energy per cycle (plots 2511-2513, respectively).

FIG. 25C shows the ply number dependence of the potential of zero charge (pzc) (plots 2521-2522 for 0.1 M HC electrolyte and 0.1 M LiCl electrolyte, respectively). For FIGS. 25A-25C, the performances for the plied yam harvesters were obtained by sinusoidal stretching to maximum strain in a 0.1 M aqueous electrolyte or in both 0.1 M HCl and 0.1 M LiCl aqueous electrolytes.

FIGS. 26A-26E show the performance of OPS harvesters when operated in electrolytes comprising different ionic radius ions and when using different shapes of tensile deformations to 40% tensile strain. FIG. 26A shows the capacitance and pzc at 0% stretch (plots 2601-2602, respectively), and the difference between the OCP and the pzc (plot 2603) in electrolytes containing different ionic radius ions. FIG. 26B shows the frequency dependence of gravimetric average power in various aqueous electrolytes (plots 2611-2615 for 0.1 M LiCl, 01 M HCl, 0.1 M NaCl, 0.1 M KCl, and 0.1 M CsCl, respectively). FIG. 26C shows the dependencies of OCV, the voltage across an external load resistance that maximizes the peak power, and the output power delivered to the external load in response to applied sinusoidal (plots 2622, 2632, and 2642, respectively), square (plots 2623, 2633, and 2643, respectively), and sawtooth-2 (plots 2624, 2634, and 2644, respectively) strain waves. FIG. 26D shows the frequency dependencies of peak power (graph 2651) and energy per cycle (graph 2661) in 0.1 M aqueous LiCl electrolyte for a 40% stretch when using sinusoidal (plots 2652 and 2662, respectively), square (plots 2653 and 2663, respectively) and sawtooth deformations, which combine square-wave and triangle-wave deformations, namely, sawtooth-1 (plots 2654 and 2664, respectively), sawtooth-2 (plots 2655 and 2665, respectively), and sawtooth-3 (plots 2656 and 2666, respectively). The strain ratios of square-wave to triangle-wave deformations for sawtooth-1, 2, and 3 waves are 0.6:0.4, 0.7:0.3, and 0.8:0.2, respectively. FIG. 26E shows, for FIG. 26A, the cyclic voltammograms (scan rate: 30 m V/s) with (plot 2672) and without (plot 2671) a 3-Hz applied sinusoidal stretch of 10% strain in 0.1 M HCl aqueous electrolyte.

FIG. 27A shows the frequency dependence of peak power when a OPS harvester is sinusoidally stretched to 40% strain in 0.1 M HCl, 0.1 M LiCl, 0.1 M NaCl, 0.1 M KCl, and 0.1 M CsCl aqueous electrolytes (plots 2701-2705, respectively).

FIG. 27B shows the frequency dependence of energy per cycle when a OPS harvester is sinusoidally stretched to 40% strain in 0.1 M HCl, 0.1 M LiCl, 0.1 M NaCl, 0.1 M KCl, and 0.1 M CsCl aqueous electrolytes (plots 2711-2715, respectively).

FIGS. 28A-28B show the transferred charge (ΔQ) between shorted electrodes for 10% square-wave strain of an OPS harvester when stretched and stretch-released at 0.1 Hz in 0.1 M LiCl aqueous electrolyte. FIG. 28A shows the short-circuit current (SCC) versus time for the OPS harvester when stretched (plot 2801) and stretch-released (plot 2802). The transferred charge (ΔQ) for stretch (areas of plot 2801) and stretch-release (areas of plot 2802) were the areas under the SCC curves. FIG. 28A further shows an illustration of an OPS harvester in electrolyte 2803. The distance between harvester working electrode and counter electrode is d. FIG. 28B shows the dependence of transferred charge for the OPS harvester on the distance between the harvester working electrode and counter electrode (with transfer charge during stretch and during release in plots 2811-2812, respectively, and the difference of these shown in plot 2821).

FIG. 29A shows the OCP versus strain for the OPS harvesters stretched in 0.1 M HCl (pH 1), 0.1 M LiCl (pH 7), 0.6 M NaCl (pH 7), 0.1 LiOH (pH 13) and 0.1 M KOH (pH 13) aqueous electrolytes (plots 2901-2905, respectively).

FIG. 29B shows the potential of zero charge (pzc) for the OPS harvesters stretched in above solutions, respectively.

FIGS. 30A-30D show the OPS harvesters were stretched to 20% strain with using square wave in 0.1 M LiCl aqueous electrolyte. FIG. 30A shows the stretch rate dependence of OCV, peak power, and energy per cycle for an OPS harvester stretched at 1 Hz (plots 3001-3003, respectively). FIG. 30B shows illustration of square waves with duty ratio of 50:50, 70:30 and 90:10. For this comparison, the time for one stretch cycle is the same, although the square waves have different duty ratios. FIG. 30C shows the frequency dependence of energy per cycle and average power for an OPS harvester stretched by a square wave having duty ratios of: (a) 50:50 (plots 3011 and 3021, respectively); (b) 70:30 (plots 3021 and 3022, respectively); (c) 90:10 (plots 3013 and 3023, respectively); (d) 30:70 (plots 3014 and 3024, respectively); and (e) 10:90 (plots 3015 and 3025, respectively). FIG. 30D shows the frequency dependence of energy per cycle and average power for an OPS harvester stretched by a square wave having duty ratios of: (a) 50:50 (plots 3031 and 3041, respectively); (b) 70:30 (plots 3031 and 3042, respectively); (c) 90:10 (plots 3033 and 3043, respectively); (d) 30:70 (plots 3034 and 3044, respectively); and (e) 10:90 (plots 3035 and 3045, respectively). The load resistances used in the measurement of energy per cycle and average power correspond to those which maximize peak power for FIG. 30C and maximize average power for FIG. 30D, respectively.

FIGS. 31A-31B show the time dependence of the OCV, the voltage across an external load resistor, the output power, and the output energy for an OPS harvester during (FIG. 31A) a continuous 25%, 1 Hz sinusoidal stretch and (FIG. 31B) a 4-second interrupted 25%, 1 Hz sinusoidal stretch. A 0.1 M LiCl aqueous electrolyte was used.

FIGS. 32A-32B show the dependence of average power and energy per cycle for 40% strain of a Pt-wire-wrapped OPS harvester on the interval time between stretch cycles for (a) a 0.1 Hz sinusoidal wave (FIG. 32A, plots 3201-3202, respectively) and (b) a 1 Hz sinusoidal wave (FIG. 32B, plots 3211-3212, respectively).

FIG. 32C shows the energy per cycle as a function of the stretch frequency for this harvester during a continuous sinusoidal deformation (plot 3221) and an 8-second-interrupted sinusoidal deformation (plot 3222).

FIGS. 33A-33B show the dependencies of input mechanical energy per cycle (plots 3301 and 3311, respectively), output electrical energy per cycle (plots 3302 and 3312, respectively), and energy conversion efficiency (plots 3303 and 3313, respectively) for 40% strain of a Pt-wire-wrapped OPS harvester on, for FIG. 33A, the deformation interrupted time between 0.1 Hz sinusoidal deformation cycles and, for FIG. 33B, the deformation frequency for a 8 s deformation interruption time

FIG. 34A shows the time dependence of the generated voltage and output power of a 35-mm-long 3-ply yam harvester working electrode (WE) and a 40-mm-long counter electrode (CE) that were sewn into a cotton textile as an elbow support for arm bending. Both electrodes were overcoated with a solid electrolyte of 0.1 M LiCl/10-wt¾-PVA gel, which connects the two electrodes. FIG. 34A further shows photographs 3401-3402 taken during arm bending from 0° to 90°.

FIG. 34B shows the time dependence of the generated OCV for different angles of arm bending. FIG. 34B further shows photograph 3411 taken during arm bending by 60°.

FIGS. 35A-35F show torsional mechanical energy harvesting by a 3-ply, 14.7-mm-long OPS harvester in 0.1 M HCl aqueous electrolyte. FIG. 35A shows the OCV and capacitance for an OPS harvester as a function of the inserted twist density (plots 3501-3502, respectively). FIG. 35A further show an illustration of an OPS harvester 3503 during isometric (constant length) twist. FIG. 35B shows the time dependence of the OCV (graph 3511 with plots 3512-2512 for number of terns and OCV, respectively)) and the output power (graph 3514) for the OPS harvester during isometric twist at a twist speed of 120 rpm. The shaded areas under the power curves in graph 3514 were the output electrical energy. FIG. 35C shows the OCV and load resistance versus isometric twist speed for the OPS harvester (plots 3521-3522, respectively). FIG. 35D shows the peak power, average power, and energy per cycle versus isometric twist speed for the OPS harvester (plots 3531-3533, respectively). FIG. 35E shows the peak power, average power, and energy per cycle for 6.8 turns/cm change in twist density were maintained for the investigated 5,000 isometric twist cycles at 120 rpm (plots 3541-3543, respectively). FIG. 35F shows the twist-speed-dependencies of input mechanical energy per cycle, output electrical energy per cycle, and the energy conversion efficiency (plots 3551-3553, respectively).

FIGS. 36A-36F show results of applications using embodiments. FIG. 36A shows the frequency dependencies of peak power, peak OCV, and energy per cycle for a coiled rGO@CNT harvester undergoing 46% stretch in 0.6 M aqueous NaCl (plots 3601-3603, respectively). FIG. 36B shows gravimetric and absolute power outputs of a 400-μg rGO@CNT ocean-wave harvester for mimic wave frequencies of ˜0.8 Hz, providing 20% to 30% twistron stretch in 0.6 M NaCl. FIG. 36B further shows a schematic of the harvester's configuration 3605. FIG. 36C is optical image of the high-volume-state of a wine-rack frame twistron harvester. In each of the four wine-rack cells, ten TOP twistron harvester yarns under 17.5% tensile strain were suspended in both the horizontal and vertical directions as opposing twistron electrodes. Each twistron yarn was 1.7-cm-long and weighed 80 μg. FIG. 36D is a magnified optical image of box 3611 of FIG. 36C that focuses on one of the four wine rack cells. FIG. 36E is an illustration of the morphing of a wine-rack twistron harvester between equivalent structures having rhombic angles of 81.7° and 98.3°. The negative and positive linear compressibility directions (with 35% and 0% tensile strain, respectively) switch between horizontal and vertical in going between these structures. FIG. 36F shows the peak OCV and SCC at 1 Hz and 38% strain for series (plot 3621) and parallel (plot 3622) connected solid-state harvesters. The rGO@CNT homochiral harvester yarn was coated with a 10 wt % PVA/0.1 M HCl gel electrolyte and heterochirally wrapped with a gel-electrolyte-coated CNT harvester yarn. FIG. 36 further shows an SEM image of the solid-state harvester 3623, without the needed gel coatings.

FIG. 37A-37E show application demonstrations for TOP CNT twistrons. FIG. 37A shows the peak-to-peak SCC for a 1 Hz, ±80% strain for two parallel connected seesaw harvester yams operated in 0.1 M aqueous HCl electrolyte. FIG. 37B shows the time dependence of the gravimetric power generated by a wind-driven seesaw-structure CNT harvester 3701 that operated at 8 Hz in 0.1 M aqueous HCl, which harvester 3701 is shown in FIG. 37B. FIG. 37C shows the time dependence of the gravimetric power output of a 0.58-mg TOP coiled yam, when operated as an ocean-wave harvester for ocean-wave frequencies of 0.5 to 1 Hz. The maximum stretch is mechanically limited to 50% in sea-water, which is the electrolyte for the twistrons. FIG. 37C also shows the schematic illustration of the harvester 3702 and a photograph 3703 of the harvester being used in shallow ocean water. FIG. 37D shows the peak OCV and SCC during a 1 Hz, 35% sinusoidal strain for series (plot 3711) and parallel (plot 3712) connected wine-rack frame harvester cells. The wine-rack cells contain 0.1 M aqueous HCl electrolyte. FIG. 37D also shows an illustration of wine-rack frame harvesters 3713. Ten 1.7-cm-long twistrons, each weighting 80 μg, were placed parallel in the negative and positive compressibility directions of each of the four wine rack cells. The initial tensile strain for each twistron in the square configuration was 17.5%. FIG. 37E shows, for FIG. 37A, the time dependence of the applied strain and the OCV of the interelectrode voltage of a one-body seesaw harvester.

FIGS. 38A-38E show a comparison of energy harvesting in 0.1 M aqueous HCl by an rGO@CNT single-stretched-electrode twistron harvester with that for a dual-stretched-electrode harvester that uses a seesaw structure. FIG. 38A is an optical image of a dual-stretched-electrode harvester using the seesaw structure. The top harvester was pre-strained by 42%. The top and bottom twistrons were insulated, but mechanically connected in the center. Moving the center of the one-body harvester causes one twistron electrode to contract in length, while the other twistron yam expands. FIGS. 38B-38D show the time dependencies of applied strain (FIG. 38B), generated OCV (FIG. 38C), and SCC (FIG. 38D) for the single-stretched-electrode and the dual-stretched-electrode harvesters. A non-deformed CNT-wrapped Pt mesh counter electrode was used for the single-stretched-electrode harvester, and the working electrode and counter electrode are sinusoidally stretched 180° out-of-phase by using the seesaw structure for dual-stretched-electrode harvester. FIG. 38E shows the frequency dependencies of peak power and average power for the single-stretched-electrode harvester (plots 3801-3802, respectively) and for the dual-stretched-electrode harvester (plots 3811-3812, respectively).

FIGS. 39A-39D show dual-electrode, one-body harvester using a seesaw structure that is operated in 0.1 M aqueous HCl. FIG. 39A is an illustration of a one-stretched-body, two-electrode harvester that uses a seesaw structure to increase the output voltage compared to that for a harvester in which only one electrode is stretched. The weight of each of the pictured CNT electrodes (working electrode 3901 and counter electrode 3902) was 101 μg and the length of each electrode was 10 mm. The Pt mesh 3903 electrode is used only for OCV measurements and not as an electrode for energy harvesting. FIG. 39B shows the time dependence of applied strain and OCV (relative to the Pt mesh electrode) when the working electrode (plots 3911 and 3921) and the counter electrode (plots 3912 and 3922) are sinusoidally stretched 180° out-of-phase by using the seesaw structure. A total strain of 123% was applied. FIG. 39C is an illustration of two one-stretched-body harvesters that are operated in parallel using the seesaw structure. The two harvesters in the double seesaw structure are separated by 1 cm. FIG. 39D shows the peak power, average power, and load resistance that maximizes the average power versus frequency for the single seesaw structure shown of FIG. 39A (plots 3931-3933, respectively) and the double seesaw structure of FIG. 39C (plots 3941-3943, respectively). A total strain of 61% was applied during harvesting for both structures.

FIGS. 40A-40B are illustrations of the experiment for evaluating the possible dependence of the load-resistance-optimized peak and average power on (a) the lateral separation between twistron working electrode 4001 and twistron counter electrode 4002 shown in FIG. 40A and (b) the longitudinal separation between twistron working electrode 4003 and twistron counter electrode 4004 shown in FIG. 40B. These coiled TOP twistrons had identical structures, lengths (10 mm) and weights (66 μg) before only the working electrode was sinusoidally stretched to generate electrical energy.

FIGS. 40C-40D show the frequency dependencies of the peak power (solid symbols in plot 4011) and the average power (open symbols in plot 4012) for a stretch to a total strain of 60% for different center-to-center lateral (FIG. 40C) and longitudinal (FIG. 40D) separations between the stretched twistron working electrode and the non-stretched twistron counter electrode. As indicated by the pictured superposition of data points for separations between 1 and 50 mm (lateral in FIG. 40C), and between 20 and 50 mm (longitudinal in FIG. 40D), identical values of peak power and average power were obtained at each frequency, independent of the separation between working and counter electrodes. FIGS. 40C-40D further show inset graphs 4013 and 4023 showing frequency dependencies of the impedance for the different center-to-center separations.

FIGS. 41A-41B show use of a Scotch yoke structure for converting input rotational mechanical energy to the seesaw stretch of TOP twistrons in 0.1 M aqueous HCl. FIG. 41A shows a photograph 4101 of a Scotch yoke structure and attached twistron electrodes that undergo seesaw-like tensile deformation during harvesting. FIG. 41A further shows an illustration 4102 of the extreme deformation states during a rotation. Ten equivalent, parallel-connected TOP twistrons were used for each electrode. The weight of each of single yam in a CNT electrode was 42 μg and its length was 12 mm, so the total twistron weight in the harvester was 0.84 mg. FIG. 41B shows the peak power, average power, and load resistance versus frequency for the harvester of FIG. 41A when a 20% tensile strain change was applied by the Scotch yoke structure (plots 4111-4113, respectively).

FIG. 42 shows illustrations of American Sign Language hand gestures, and the corresponding OCV profiles generated when the solid-state harvesters were woven into a glove.

FIG. 43 shows the dependencies of OCV and capacitance decrease for twisted yarn harvesters (plots 4301-4302, respectively) coiled yarn harvesters (plots 4311-4312, respectively), and 3-ply yarn harvesters (plots 4331-4302, respectively) on the applied lateral pressure. The harvesters were wrapped on a ceramic plate having a pore diameter of about 10 μm, and an identical porous plate was used to apply pressure

FIG. 44A shows the frequency dependencies of peak power, average power, and energy per cycle for 40% stretch of the 3-ply yarn harvester, without (plots 4401-4403, respectively) and with (plots 4411-4413, respectively) a coiled 25-μm-diameter Pt wire current collector.

FIG. 44B shows an SEM image of a 3-ply yarn harvester with incorporated Pt wire (scale bar: 100 μm).

FIG. 45A shows the strain dependencies of per-cycle input mechanical energy and output electrical energy, and energy conversion efficiency of a 3-ply yarn harvester sinusoidally stretched at 0.1 Hz in 0.1 M HCl electrolyte, with continuous stretch (plots 4501-4503, respectively) and with interrupted stretch (plots 4511-4513, respectively).

FIG. 45B shows, for a 3-ply yarn harvester twisted isometrically at 12 rpm, the dependencies of the per-cycle input mechanical energy, output electrical energy, and energy conversion efficiency on the twist density used for torsional mechanical energy harvesting, with continuous twist (plots 4521-4523, respectively) and with interrupted twist (plots 4531-4533, respectively).

FIG. 46 shows the tensile energy conversion efficiency for the frequency of a sinusoidal twistron tensile deformation that maximizes this efficiency versus the average power at this frequency (symbols 4601-4605 for 3-ply CNT yarn, coiled rGO@CNT yarn, coiled CNT yarn, coiled plied CNT yarn, and pied coiled CNT yarn, respectively) and the torsional energy conversion efficiency for the twist speed of an isometric twist that maximizes this efficiency versus the average power at this twist speed (symbols 4611-4603 for 3-ply CNT yarn, coiled rGO@CNT yarn, and coiled CNT yarn, respectively).

FIG. 47A shows the strain dependencies of OCV, Poisson's ratio, and yarn density when continuously stretching a twisted yarn at a lower strain rate (1% s⁻¹) than is required for the OCV to become rate insensitive (plots 4701-4703, respectively). The Poisson's ratio at a particular strain is the average value of Poisson's ratio up to that strain.

FIG. 47B shows, for tensile stretch at 1 Hz and isometric twist at 161° cm⁻¹ s^{-1,} the dependencies of the peak OCV, percent capacitance decrease, and the ratio of capacitance change to the capacitance for a given deformation on percent yarn density increase of twisted yarns, with 1 Hz sinusoidal stretch (plots 4711-4713, respectively) and with isometric twist (plots 4721-4723, respectively).

FIG. 47C shows the dependencies of OCV, for a sinusoidal stretch at a sufficiently low frequency (1 Hz) that the OCV is strain-rate insensitive, and the static capacitance and Poisson's ratio for 3-ply yarn harvesters (plots 4731-4733, respectively), twisted yarn harvesters (plots 4741-4743, respectively), and coiled yarn harvesters (plots 4751-4753, respectively) on the static density.

FIG. 48A shows the flow velocity dependence of the generated plateau OCV for a 31.6-mm-long 3-ply yarn harvester, when used as a self-powered air flow velocity sensor in 0.6 M NaCl/10-wt %-PVA gel electrolyte.

FIG. 48B shows the time dependence of the generated OCV for different air-flow velocities.

FIG. 48C shows the device configuration utilized for FIGS. 46A-46B. A 31.6-mm-long 3-ply yarn harvester working electrode was connected to a piston rod, and mechanically limited to <20% strain. The flowing air contacts a 3.5-cm-diameter circular disk, whose movement stretches the twistron that is contained in a 1.5-cm-diameter electrolyte container. The electrolyte was a 0.6 M NaCl/10-wt %-PVA gel.

FIG. 49A shows the generated OCV for 1 Hz, 30% sinusoidal stretch of four 2.2-cm-long, 0.80-mg-weight 3-ply yarn harvesters connected in series.

FIG. 49B shows the time dependence of the rectified voltage obtained using a Schottky diode full-bridge rectifier.

FIG. 49C is a photograph of the integrated booster converter circuit.

FIG. 49D is a photograph of a plied CNT yarn harvester array that includes four 0.80-mg, 2.2-cm-long, plied CNT yarn harvesters. Four twisted yarns with a twist density of 10 turns cm⁻¹ were used as counter electrodes.

FIG. 49E is an illustration of the integrated boost converter circuit.

FIG. 49F shows supercapacitor voltage versus time during charging a 220-μF supercapacitor to 2.8 V by using the boost converter circuit of FIG. 49C.

FIGS. 49G-49L are photographs showing he charged supercapacitor (220 μF, 2.8 V) was used to power five 2.7 V green LEDs (FIGS. 48G-48H, power off and on, respectively), a 2.5 V electronic watch (FIGS. 481-48J, power off and on, respectively), and a 1.5 V digital temperature/humidity monitor having a 4.5×5.7 cm (2.8-inch) liquid-crystal display (FIGS. 48K-48L, power off and on, respectively).

### DETAILED DESCRIPTION

Stretching a coiled carbon nanotube (CNT) yarn can provide large, reversible electrochemical capacitance changes, which convert mechanical energy to electricity. It has been discovered that the performance of these “twistron” harvesters can be increased by optimizing the alignment of precursor CNT forests, plastically stretching the precursor twisted yarn, applying much higher tensile loads during pre-coiling twist than for coiling, using electrothermal pulse annealing under tension, and incorporating reduced graphene oxide nanoplates. In embodiments, the peak output power for a 1 Hz and a 30 Hz sinusoidal deformation were 0.73 and 3.19 kW kg-1,which are 24 and 13-fold that of previous twistron harvesters at these respective frequencies. This performance at 30 Hz was over 12-fold that of other prior-art mechanical energy harvesters for frequencies between 0.1 Hz and 600 Hz. The maximum energy conversion efficiency was 7.2-fold that for previous twistrons. Twistron anode and cathode yarn arrays were stretched 180° out-of-phase by locating them in the negative and positive compressibility directions of hinged wine-rack frames, thereby doubling the output voltage and reducing the input mechanical energy

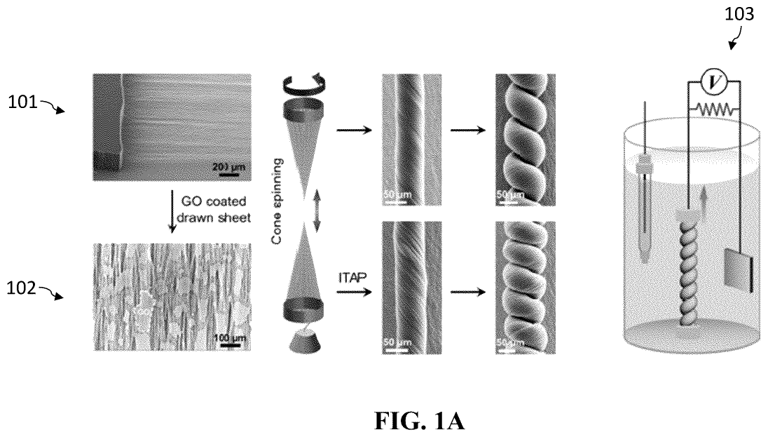

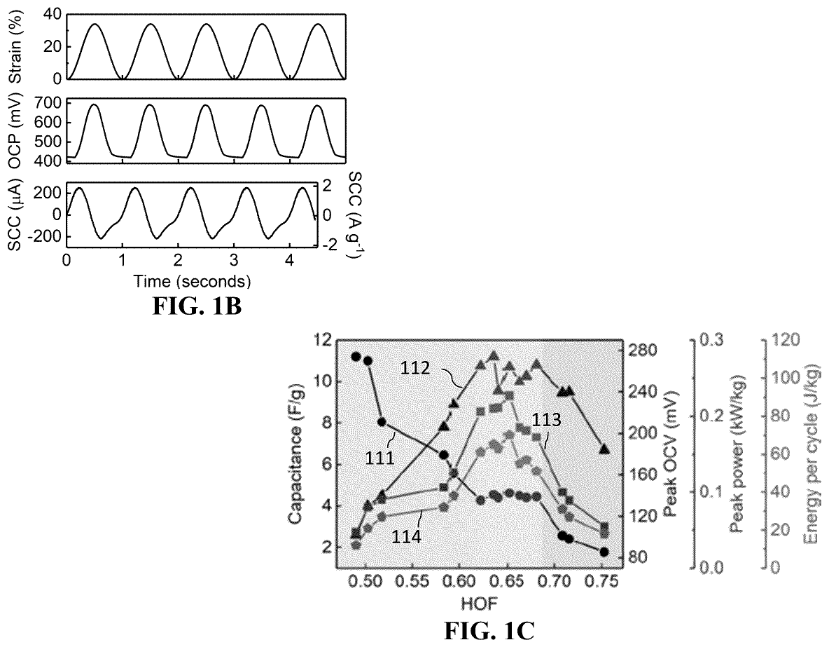

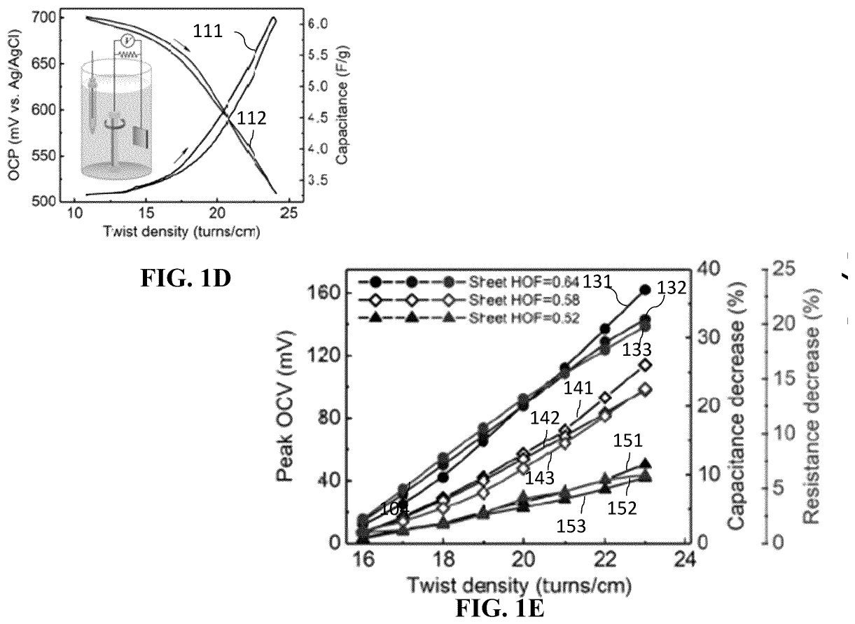

In some embodiments, a cone spinning process (such as disclosed in Kim 2017) can be used to obtain highly elastic fully-coiled yarn harvesters by inserting extreme twist into cylindrically configured forest-drawn CNT sheets [Zhang 2005; Malik 2014] while they were under tensile load. See FIG. 1A showing method 101 for fabricating twisted and coiled neat CNT yarns from forest-drawn CNT sheets, method 102 which is a modification for making rGO@CNT yarns (bottom), and electrochemical cell 103 used for characterizing coiled harvester yarns. For example, these coiled yarns were untwisted by 8% of the total inserted twist [Kim 2017], which reduces twist-induced densification without causing coil loss, thereby improving harvesting by increasing the electrochemically accessible area and the reversible tensile strain range. Yarns that are twisted and not coiled and both twisted and coiled are called “twisted yarns” and” coiled yarns,” respectively.

Unless otherwise described for isobaric self-coiling, in the representative embodiments discussed herein, the twisted yarn's diameter before coiling onset was 60 to 90 μm, the stress applied during twist insertion was about 30 MPa (when normalized to the yarn's cross-sectional area immediately before coiling onset), and the coiled yarn's spring index was about 0.45. A typical harvester characterization used a coiled twistron working electrode, a high capacitance CNT-sheet-wrapped Pt mesh counter electrode, and an Ag/AgCl reference electrode (electrochemical cell 103 in FIG. 1A). The electrolyte was 0.1 M aqueous HCl and the applied strain was sinusoidal, unless otherwise noted. Such embodiments are representative, and the present invention is not restricted by such yarn diameter and spring index range, and various aqueous and non-aqueous electrolytes can be usefully deployed for the twistron harvesters of invention embodiments. Moreover, while this counter electrode was used for embodiments disclosed and described herein, various other counter electrode can be usefully deployed and the reference electrode is principally useful only for obtaining fundamental scientific understanding.

Solid-state twistron harvesters can also be utilized in embodiments, which can be used to eliminate the need for a liquid electrolyte bath. Stretching a torsionally tethered homochiral coiled yarn (with the same chirality of twist and coiling) partially converts the twist of yarn coiling to yarn twist, while stretching a heterochiral coiled yarn (with opposite chirality of twist and coiling) results in an opposite change in yarn twist. The corresponding oppositely directed electrode potential changes enables an all-solid-state twistron harvester comprising parallel, simultaneously stretched homochiral and heterochiral yarn electrodes.

The capacitance changes produced by stretch-induced twist changes, as well as the output voltages and electrical power and energy, can be simultaneously increased by incorporating conducting nanoplates into CNT yarns. Twistron fabrication methods can be modified to increase performance, such as by using plastic deformation to increase CNT alignment and using the incandescence tension anneal process (ITAP) and the new tension optimization process (TOP).

### Optimizing Harvesting by Using Forest Selection to Tune CNT Alignment

Since increasing the density of active catalyst particles on the growth substrate increases forest density, which typically increases CNT alignment in a forest [Zhang 2005; Malik 2014] and in forest-derived sheets and yarns, the CNT alignment that optimizes twistron performance was obtained by tuning catalyst density. Additionally, twisted yarns were mechanically stretched to provide plastic deformation that increases CNT alignment. CNT alignment was quantified by the Herman's Orientation Factor (HOF), which was obtained from fast Fourier transforms of scanning electron microscope images of CNT sheets. [Zhang 2005] The HOF ranged from about 0.49 to 0.75 for sheets drawn from high-density forests (see FIG. 1C, which shows the dependencies of the pre-stretch capacitance 111, peak OCV 112, peak electrical power 113, and energy per cycle 114 of coiled CNT twistrons on the HOF of the precursor forest-drawn CNT sheets), where HOFs of 0 and 1 correspond to random and perfect orientation, respectively. FIG. 1B shows the large change in open-circuit potential (OCP versus Ag/AgCl) and short-circuit current (SCC) that results from sinusoidally stretching (by 35% at 1 Hz) a coiled twistron made from a sheet having a high orientation factor (0.64).

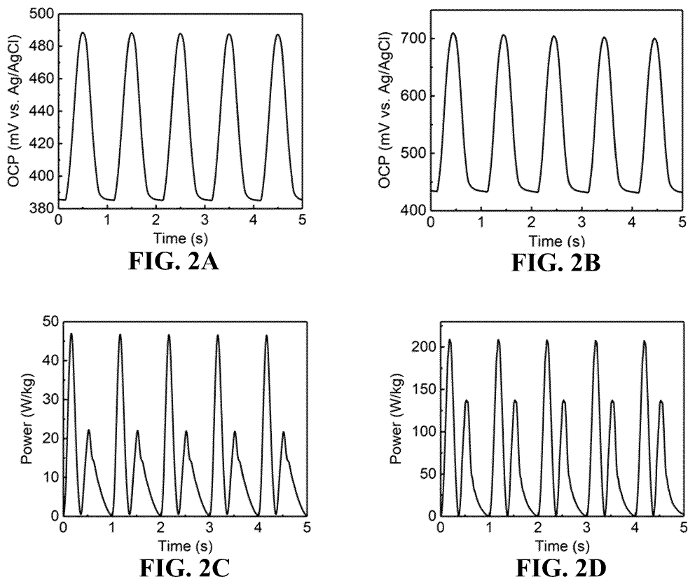

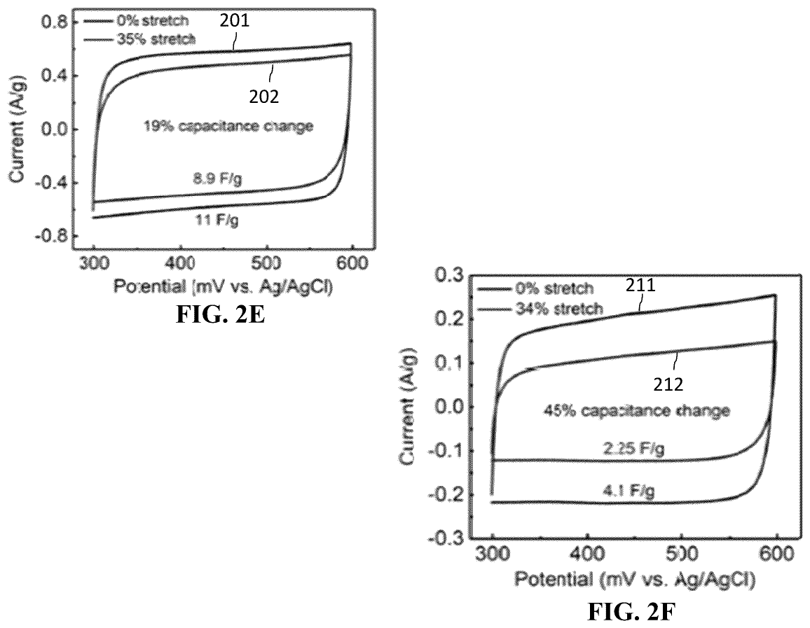

The peak OCV, peak power, and energy per cycle for coiled twistrons initially increase with increasing HOF, reach approximate plateaus for a HOF between 0.62 to 0.68, and decrease for further HOF increase. See FIG. 1C. A peak OCV, peak power, and energy per cycle of 274 mV, 210 W kg⁻¹, and 65 J kg⁻¹ were achieved for a twistron made from a sheet with a HOF of 0.64. See FIGS. 2A-2F. The large initial increase in harvester performance with increasing HOF arises because the electrochemical double-layers of poorly aligned CNTs interact over the small regions where CNT bundles intersect and these capacitance-changing areas increase with increasing CNT alignment.

Further increasing forest density, which yields forest-drawn sheets with a HOF above 0.7, decreases energy harvesting due to the large bundle diameters resulting from very high CNT alignment, and correspondingly decreased gravimetric surface area and capacitance. The above peak power and output energy per cycle at 1 Hz for an optimally aligned twistron are 5.1 and 5.4 times, respectively, the values previously reported in Kim 2017 for sinusoidal stretch of a twistron harvester at 1 Hz.

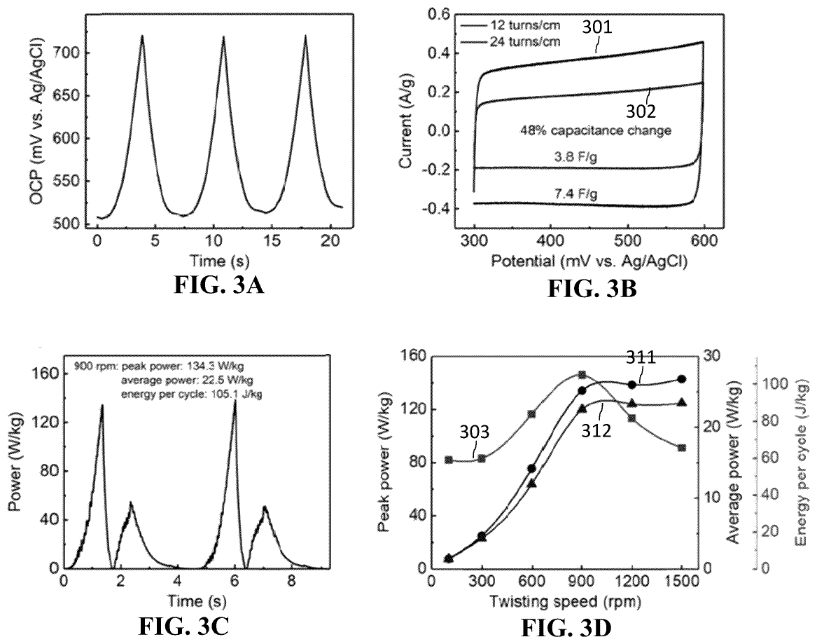

This performance increase, from optimized alignment of the precursor CNT sheets, is also evident in energy harvesting by isometric twist insertion and removal from non-coiled CNT yarns. FIGS. 3A-3D. FIG. 1D shows the dependence of the OCP and capacitance (plots 111-112, respectively) on inserted twist for a twisted yarn fabricated from a highly aligned sheet, with a HOF of 0.64. Increasing bundle alignment from 0.52 to 0.64 increases twist-induced decreases in capacitance and yarn resistance (FIG. 1E), which increases the peak OCV and the harvested energy. FIG. 1E shows the peak OCV, percent capacitance decrease, and percent resistance decrease (relative to their values at 12 turns cm⁻¹) as a function of twist density during isometric twist for non-coiled yarns made from CNT sheets having (a) a HOF of 0.64 (plots 131-133, respectively), (b) a HOF of 0.58 (plots 141-143, respectively), and (c) a HOF of 052 (plots 151-153, respectively).

The harvested electricity per cycle reaches 105 J/kg for a yarn that is twisted between 12 and 24 turns/cm at 900 rpm to obtain a twist-cycle frequency of 0.21 Hz. See FIGS. 3A-3D. This exceeds the 67 J/kg energy per cycle obtained for a 35%, 0.2 Hz stretch of a coiled yarn that was made from the same HOF (0.64) sheet. This higher harvesting for the non-coiled yarn during twist than for the coiled yarn during stretch is consistent with the larger capacitance change during twist (48%) than during stretch (41%).

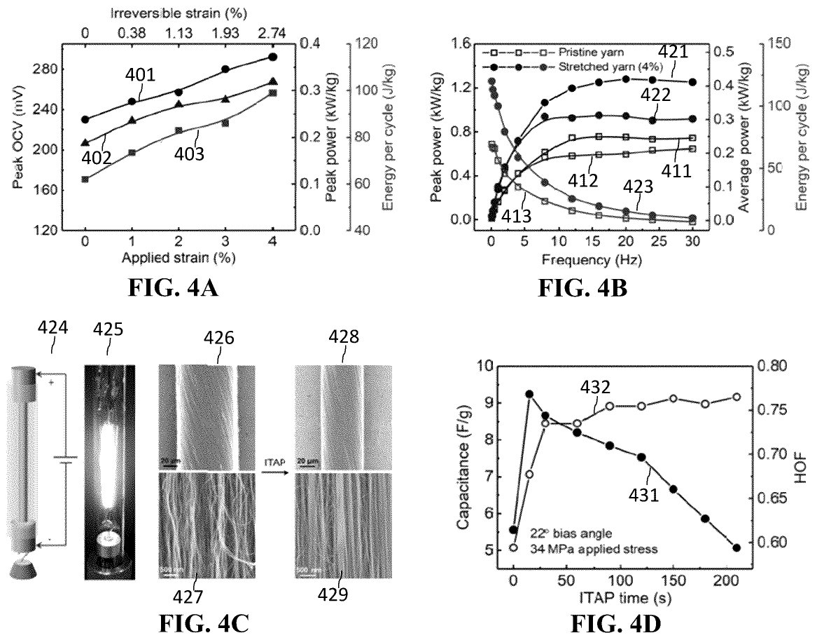

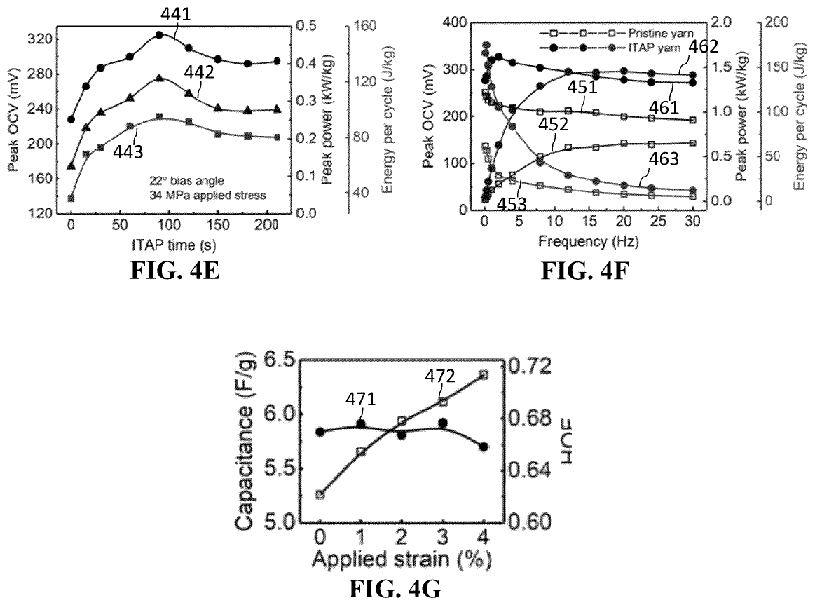

Irreversibly stretching the twisted yarn prior to isobaric coiling increases harvester performance to above that resulting from optimally aligning the precursor forest. See FIGS. 4A-4B. A yarn with a surface HOF of 0.62 was made by inserting 16 turns/cm of twist into an optimally aligned CNT sheet stack with a HOF of 0.59, so that a bias angle of 22° resulted. By keeping the precursor twisted yarn at an applied tensile strain until the applied force becomes constant, the degree of irreversible stretch was measured for each applied strain. FIG. 4A. With increasing applied strain up to close to the fracture strain of 4.25%, the HOF of the twisted yarn and the harvester performance of the coiled yarn monotonically increased, while the coiled yarn's capacitance was little effected. FIG. 4G. The 2.74% irreversible stretch of the precursor twisted yarn increased the reversible peak OCV, peak power, and harvested energy per cycle of the coiled yarn by factors of 1.3, 1.7, and 1.6, respectively, during 1 Hz harvesting to 35% strain. FIG. 4B shows the frequency dependence of the enhanced performance resulting from this plastic deformation of the precursor yarn.

### Increasing Harvesting by the Incandescence Tension Anneal Process (ITAP)

Harvesting was increased by the incandescence tension anneal process (ITAP), wherein an electric pulse heats in vacuum a mechanically loaded, torsionally tethered, twisted yarn. FIG. 4C. [Kim 2017]. For the use as shown below of ITAP at ˜3000° C., the precursor CNT sheets had a HOF of 0.59. Micrographs showed structural evolution as a function of electric pulse time for a twisted yarn (with a bias angle of 22°) that was twist inserted and ITAP treated under 34 MPa stress. CNT alignment and bundle size increase after ITAP. FIG. 4C. The yarn's HOF abruptly increased from 0.59 to 0.74 during 30 s of ITAP, and then gradually increased to 0.77 over the next 180 s of ITAP. FIG. 4D. The capacitance of the coiled twistron yarns increased from 5.56 to 9.24 F g⁻1 after 15 s of ITAP and then decreased with further increased ITAP time, likely because of CNT bundling increases and CNT welding. The ITAP was most usefully deployed for twisted yarn with a bias angle of about 22°, rather than for highly twisted or coiled yarns. This is because ITAP partially freezes the ability of highly twisted or coiled yarns to untwist [Di 2016], likely because of ITAP-produced welding between nanotubes, which also decreases ITAP-produced CNT orientation for the highly twisted yarn.

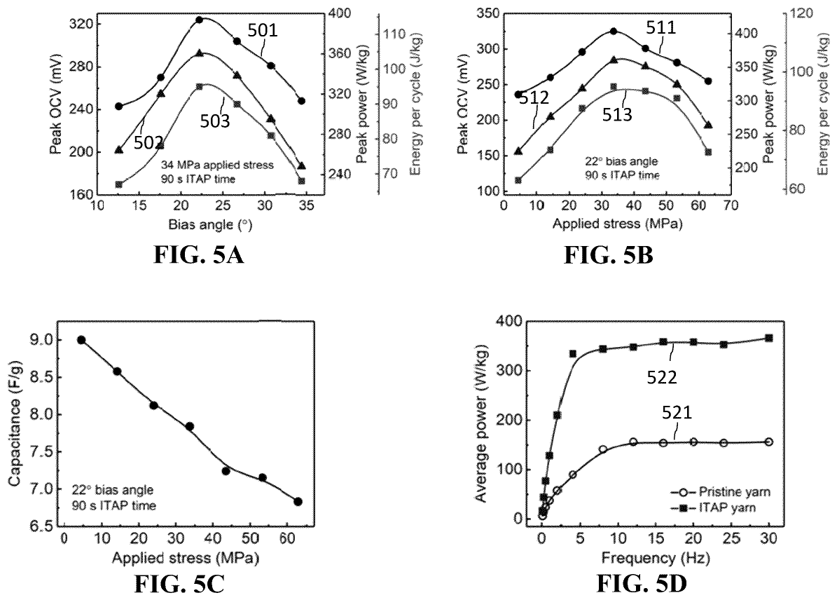

FIG. 4E shows the dependence of coiled yarn harvesting on ITAP time for the precursor twisted yarns. Insertion of the ITAP (annealing at ˜3000° C. for 90 s under 34 MPa) increased the peak OCV, peak power and energy per cycle for a 1 Hz stretch from 228 mV, 126 W kg⁻¹, and 36 J kg⁻¹ to 325 mV, 360 W kg⁻¹, and 95 J kg⁻¹. These peak power and energy per cycle are 8.7 and 7.9 times, respectively, values reported at this frequency for previous twistron yarns. [Kim 2017; Baughman '422 Patent]. For a 12 Hz stretch, the peak power and average power increased from 604 and 156 W kg⁻¹, respectively, for the pristine yarn to 1451 and 348 W kg⁻¹, respectively, for the ITAP yarn, and plateaued with further frequency increase. FIGS. 2F and FIGS. 5A-5D. Performance increases by varying the tensile stress during twistron fabrication

Since high work capacity artificial muscles were previously made by both twisting and coiling under the same tensile load [Haines 2014; Lima 2021], this method was previously used to make self-coiled twistrons. However, it has now been discovered that the tensile load during twist insertion should be much higher than the 35 MPa previously used for making twistrons [Kim 2017; Baughman '422 Patent] and the load applied during subsequent coiling should be as low as enables complete yarn coiling without the being so low that the stretch process is not highly reversible. This new fabrication method, which does not change the twistrons potential of zero charge (pzc), is the “tension optimizing process” (TOP).

This use of a low load during coiling produces a high spring index yarn, which snarls when the yarn is under low strain. This snarling, corresponding to the plying of the coiled yarn upon itself, increases the average power output of a TOP twistron yarn. However, unless otherwise mentioned, this power enhancement effect is not used for comparative purposes since it necessitates separating harvester electrodes in a harvester array. Additionally, the first few cycles of stretching a high spring index yarn are not perfectly reversible. Hence, the initial length from which strains are calculated is the length of the non-plied yarn after these first few cycles, so the initial strain for a yarn that snarls during strain release is negative.

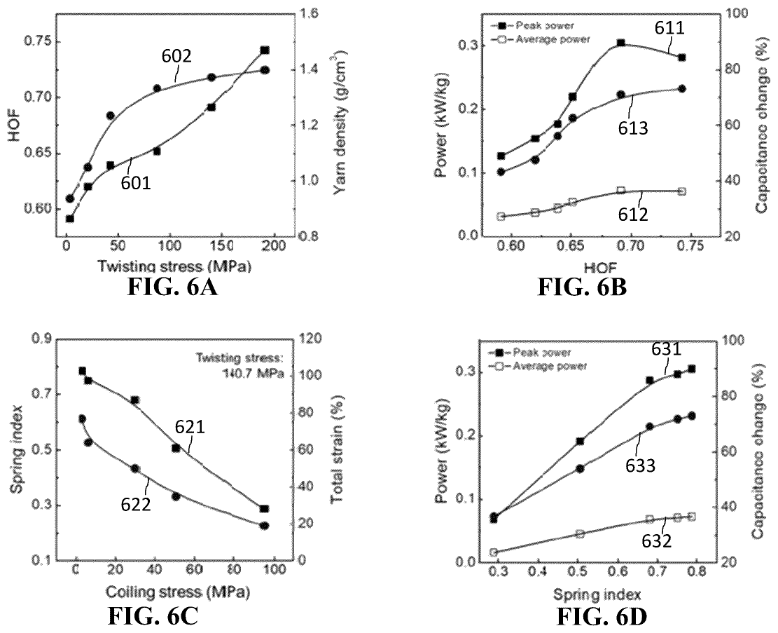

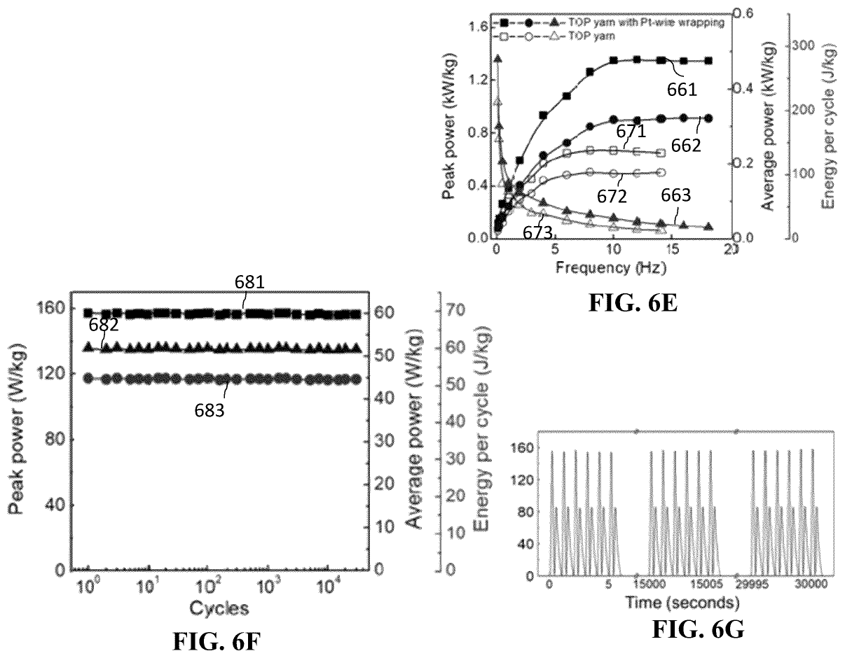

FIGS. 6A-6G shows the major performance increases resulting from the high stress applied during the pre-coiling TOP process for energy harvesting by twistrons coiled at low stress. These results show that the peak and average power increase with increasing load during twist insertion until the twist-increased value of yarn HOF exceeds 0.69. This is similar to the performance advantage (FIGS. 1C and 4A) resulting from increasing orientation by using precursor forest-drawn sheets having a high HOF and by introducing stretch-induced alignment for a low-twist precursor yarn.

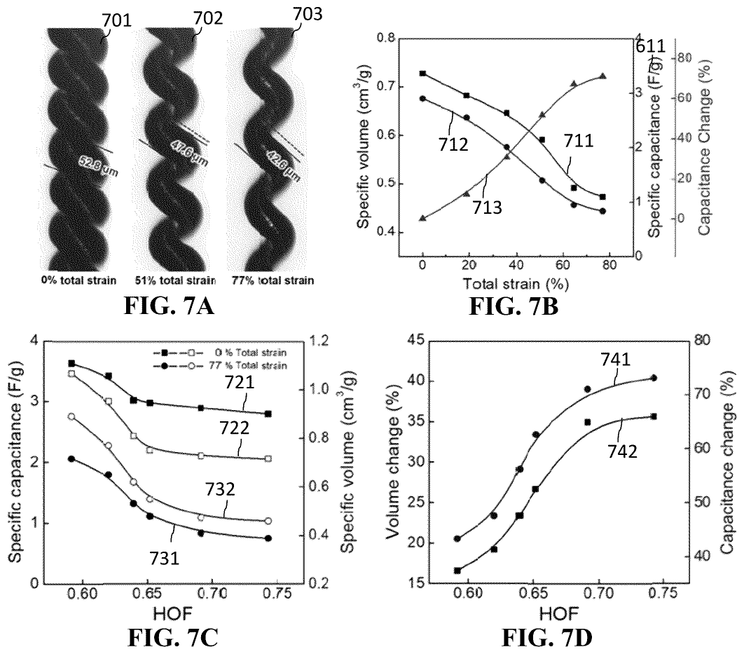

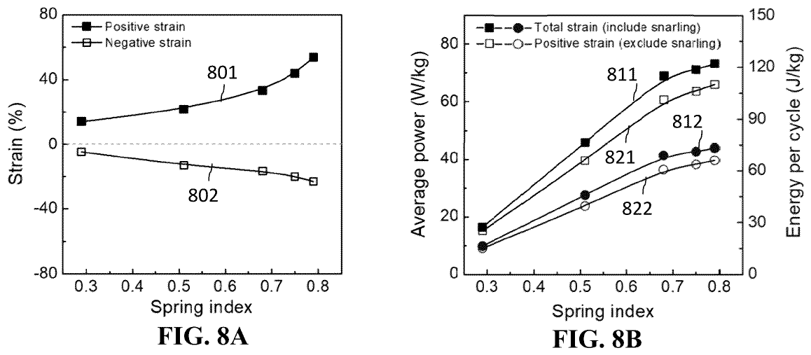

The peak power and average power at 1 Hz reached 305 and 75 W/kg (FIG. 6B), respectively, compared with 80 and 22 W kg⁻¹, respectively, for harvesting at this frequency by previously reported isobarically prepared twistron. [Kim 2017; Baughman '422 Patent]. While the peak power of the isobarically prepared twistron dramatically decreased for spring indices above 0.51, both the peak and average power of this TOP twistron increased with increasing spring index for the entire spring index range from 0.29 to 0.79. FIG. 6D. It is believed that the reason is that an applied stress below 20.6 MPa is needed to obtain a spring index above 0.51 for isobarically prepared twistrons [Kim 2017; Baughman '422 Patent], which is insufficient to provide high CNT orientation during pre-coiling twist. On the other hand, the high stress applied during the twist insertion, pre-coiling part of the TOP generates this high CNT orientation. FIGS. 7A-7D. These results for TOP twistrons include the contribution from strains where snarling occurs, but FIG. 8B shows that snarling contributes only about 10% of the total average power during harvesting, while it contributes about 30% to the total strain that can be used for harvesting. FIG. 8A.

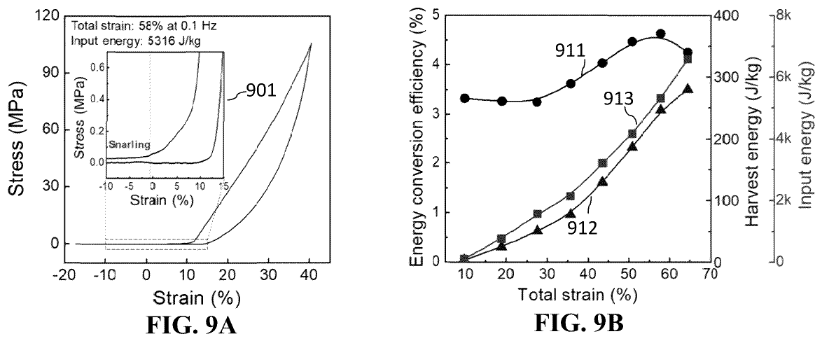

Upon frequency increase, the peak and average power reached plateaus of 670 and 179 W kg-1, respectively, at 8 Hz for a total strain of 65%. However, the energy per cycle increased with decreasing frequency to reach 213 J/kg at 0.1 Hz. Wrapping a Pt-wire on the coiled CNT yarn reduced twistron resistance, thereby increasing the plateau value of peak power and average power to 1350 and 318 W kg⁻¹, respectively, at 10 Hz. The maximum energy per cycle was 280 J/kg at 0.1 Hz, which provided an energy conversion efficiency of 4.66% for a total strain of 58% (FIGS. 9A-9B), which is 4.4 times the previously reported maximum energy conversion efficiency for a twistron. [Kim 2017; Baughman '422 Patent]. If the strain is limited to 40%, to eliminate snarling, the efficiency was 3.74%.

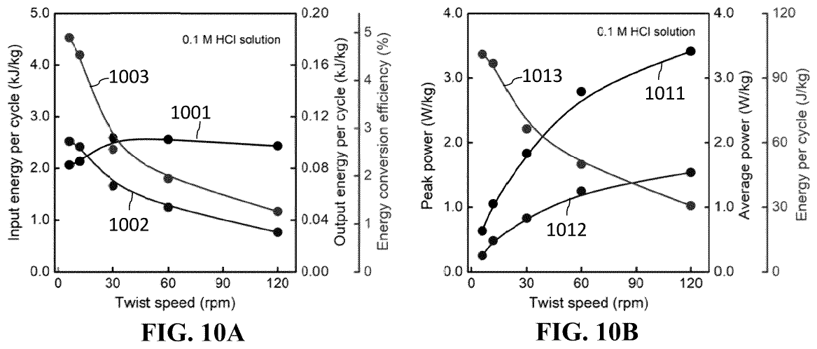

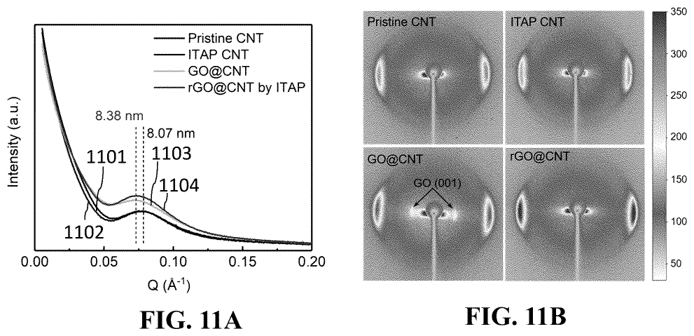

For comparison, the maximum efficiency for twist insertion and removal from a fully coiled TOP yarn was 4.89% (for a twist speed of 6 rpm). FIGS. 10A-10B. The peak and average power (157 and 52 W kg⁻¹) of the TOP twistron were maintained for over 30,000 cycles to 60% total strain at 1 Hz.

### The Performance Advantage of Biscrolled rGO@CNT Harvesters

Harvesting was greatly increased by putting high surface area, conducting nanoplates between neighboring CNT yarn layers by biscrolling. [Lima 2011 (showing biscrolling)]. This improved performance results from the dramatically increased interactions between 1D nanotube bundles and 2D nanosheets compared with those between nanotube bundles, which increased the capacitance change from 54% for an ITAP-treated CNT twistron to 65% for an ITAP-treated rGO@CNT twistron. This guest was deposited on the upper surface of each CNT sheet, and trapped between CNT yarn layers when a stack of sheets was cone spun. Since large diameter graphene oxide (GO) platelets (10-25 μm) are easily dispersed in water [Xiang 2013; Jalili 2017] and spray coated on individual CNT sheets, and later converted to reduced graphene oxide (rGO), they were used to make about 80-μm-diameter biscrolled rGO@CNT yarns. FIG. 1A.

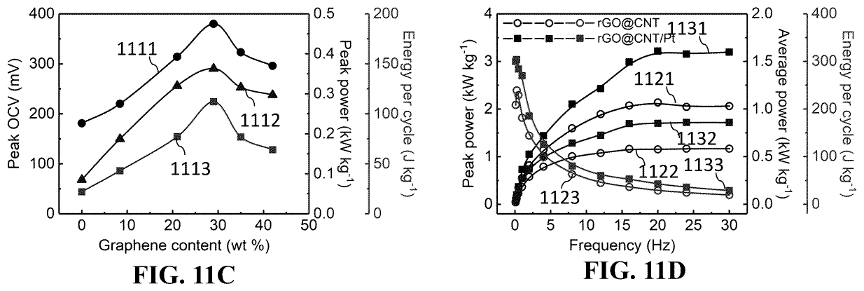

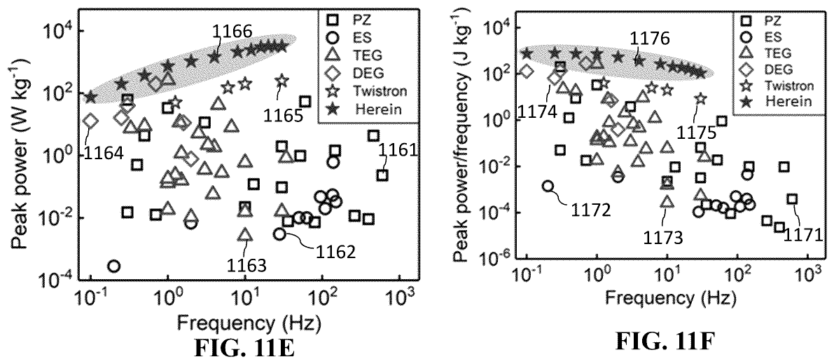

Twist was inserted into the GO-coated CNT sheet stack until a low twist-density GO@CNT yarn (with a bias angle of about 22°) was produced. ITAP (30 s at ˜3000° C.) was then applied to convert these GO@CNT yarns to rGO@CNT yarns. X-ray diffraction results indicate this reduction, since the long inter-layer spacing due to reacted oxygen disappears after ITAP. FIG. 11B. These results also show that the GO platelets in a pre-ITAP yarn and the rGO platelets in a post-ITAP yarn are oriented parallel to the yarn axis and that these platelets increased the average separation between neighboring CNTs in a bundle from 8.07 nm to 8.38 nm. See FIGS. 3A-3B.

The harvesting of a coiled biscrolled rGO@CNT twistron was maximized when the amount of rGO was 29 weight percent (wt %). A 48%, 1 Hz stretch produced a peak OCV of 380 mV, a peak power of 363 W kg⁻¹, and an energy per cycle of 112 J kg⁻¹. FIG. 11C. This OCV is 2 times the previous record for a twistron. [Kim 2017; Baughman '422 Patent]. Upon increasing the HOF of the CNT sheet used for biscrolling from 0.54 to 0.59, the peak power and energy per cycle for a 45%, 1 Hz stretch was further increased to 545 W kg⁻¹ and 182 J kg⁻¹, although the peak OCV decreased to 346 mV. This peak power and energy per cycle are over 10 times values previously reported at 1 Hz for a twistron. FIG. 11D. Reduction of GO to rGO in the biscrolled yarn is essential for this remarkable performance. Without reduction, the coiled GO@CNT has only a peak OCV of 45 mV and a peak power of 7.4 W kg⁻¹ during a 45%, 1 Hz stretch, which is 1.6% of that for the rGO@CNT twistron.

The frequency dependencies of peak power, average power and energy per cycle are shown in FIG. 11D for this 29 wt % rGO@CNT twistron. With frequency increase, the peak power increased to 2.07 kW kg⁻¹ at 16 Hz and then plateaued. The plateau in peak power, as well as average power, provides a major advantage over low-strain resonant harvesters, such as piezoelectrics, whose output power drastically decreases if the vibration frequency slightly differs from the resonance frequency. [Wei 2017]. Coiling a 25-μm-diameter Pt wire with a 29 wt % rGO@CNT twistron increased the maximum peak power and energy per cycle to 3.22 kW kg⁻¹ and 304 J kg⁻¹, when ignoring the Pt wire's weight (FIG. 11D). This wire increased the average output electrical power for a 16 Hz sinusoidal deformation from 0.58 to 0.85 kW kg⁻¹. Hence, 2 mg of a twistron yarn harvester would provide the power needed [Heinzelman 2000] to transmit a 2-kB packet of data over a 100-m radius every 10 s for the Internet of Things. The peak power and average power (184 and 71 W kg⁻¹) of a rGO@CNT twistron were largely maintained for 10,000 cycles to 27% strain at 1 Hz in 0.1 M HCl.

FIGS. 11E-11F compare the peak power output and peak power output divided by frequency for thereby improved twistrons with the performance of previously investigated mechanical energy harvesters of all types. For deformation frequencies between 0.1 Hz and 600 Hz, the peak power and frequency-normalized peak power of the twistron harvesters disclosed herein are higher than for any other material-based mechanical energy harvesting technologies. The peak power at 2 Hz and at 30 Hz were 1.05 and 3.19 kW kg⁻¹, respectively. This peak power at 30 Hz was over 12-fold that of other prior-art mechanical energy harvesters for frequencies between 0.1 Hz and 600 Hz. The twistron harvesters provide a higher average gravimetric power output than for any other self-powered harvester. While the comparison dielectric elastomer harvesters provide a higher average output power for frequencies at or below 0.54 Hz than do the twistrons disclosed and taught herein, this low frequency advantage of the dielectric elastomer harvesters is expected to disappear when the weight of the power source needed to generate their thousand-volt or higher bias voltage is included in the harvester's weight. This record performance at low frequencies requires biaxial stretching of the dielectric elastomer harvesters, which provides additional complexity and weight.

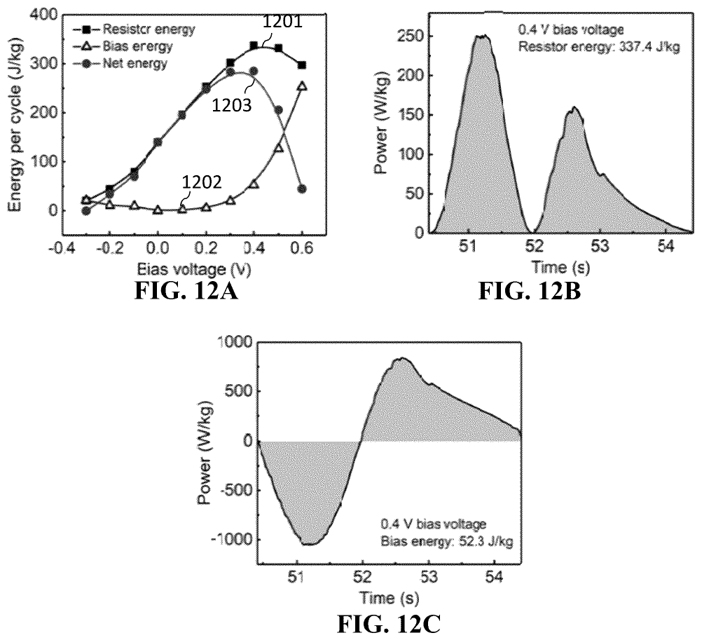

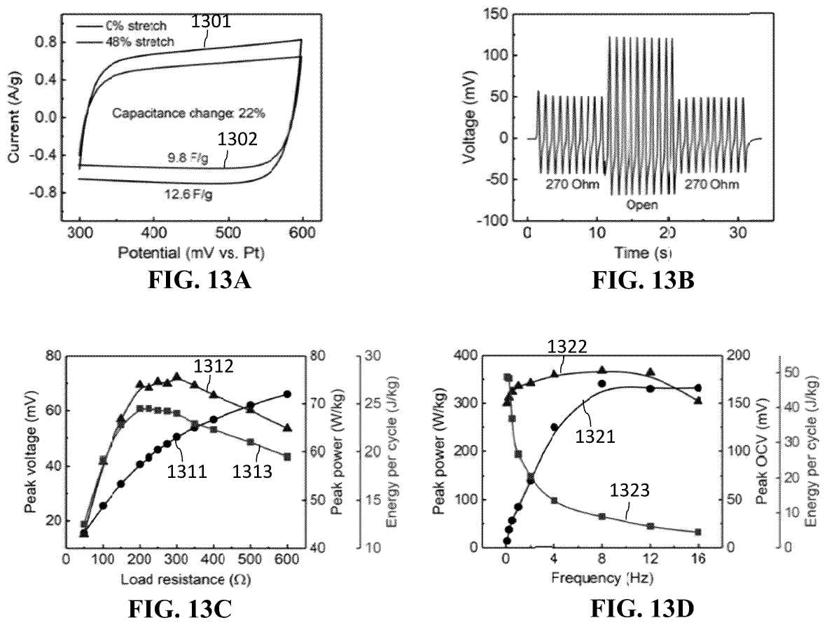

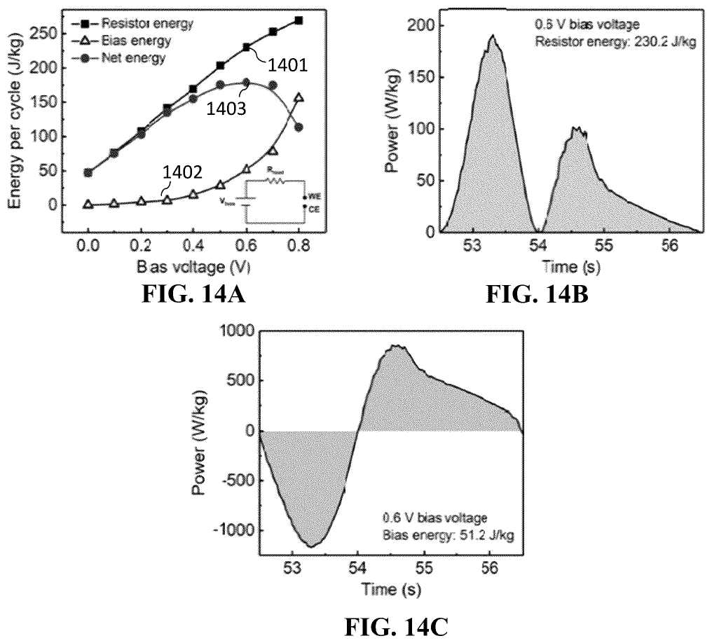

The rGO@CNT twistron yarns can generate an intrinsic bias voltage of ˜0.6 V (the difference between the OCP and the pzc at 0% strain) in 0.1 M HCl because of charge injection from the electrolyte. For a sinusoidal stretch of 46% at 0.25 Hz, applying an external bias voltage of 0.4 V increased the net energy harvested per cycle from 140 to 285 J kg⁻¹. FIG. 12A-12C. Further bias voltage increase decreased the net energy harvested, due to increased electrolytic losses. Since an electrolyte of 0.1 M LiBF₄ in acetonitrile has lower electrolytic losses, the bias voltage that optimized the net energy harvested could be increased to 0.6 V. FIGS. 13A-13D and 14A-14C.

Cycling of a rGO@CNT twistron yarn at 0.25 Hz to 48% strain in 0.1 M HCl resulted in an energy conversion efficiency of 3.89%. Applying a 0.4 V bias voltage increased this efficiency to 4.85%, compared to 1.05% for the previously reported CNT twistron harvesters. [Kim 2017] Further increase is possible without using a bias voltage, since the energy conversion efficiency for a 7.5%, 0.25 Hz sinusoidal cycle increases with increasing initial strain until this strain exceeds 15%. A higher energy conversion efficiency was obtained for twist insertion and removal from a non-coiled, twisted rGO@CNT twistron (7.6%) when no bias voltage was applied.

The harvesters of invention embodiments can contain an electrode that includes a high surface area material. For instance, this high surface area material, which provides high gravimetric capacitance because of its high surface area, can usefully comprise a high-surface-area carbon material that is selected from a group consisting of carbon nanotubes, carbon nanohorns, graphene, fullerene, activated carbon, carbon black, carbon nanofibers, a pyrolized organic material, and combinations thereof.

### Performance Increases by Tuning the Tensile Strain Profile During a Mechanical Cycle and the Time Between Successive Pulses of Mechanical Energy

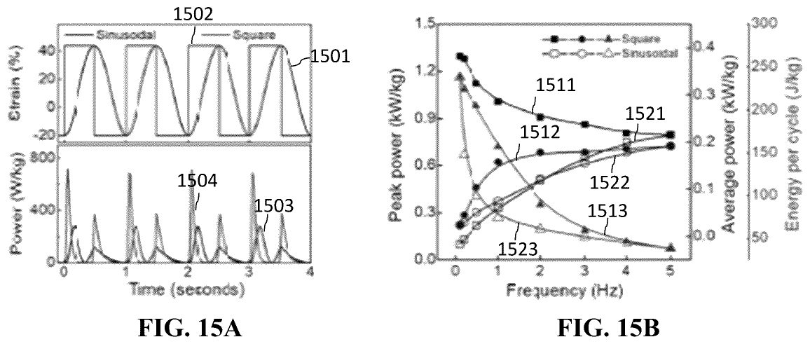

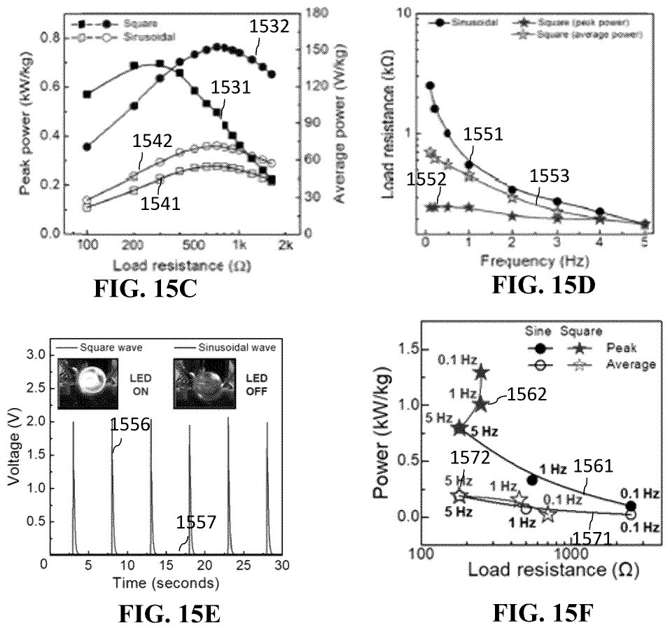

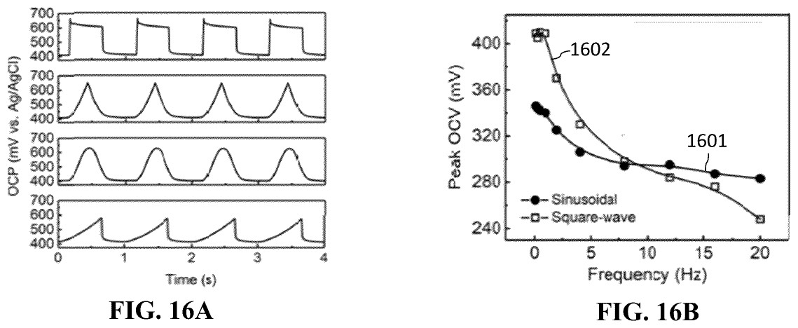

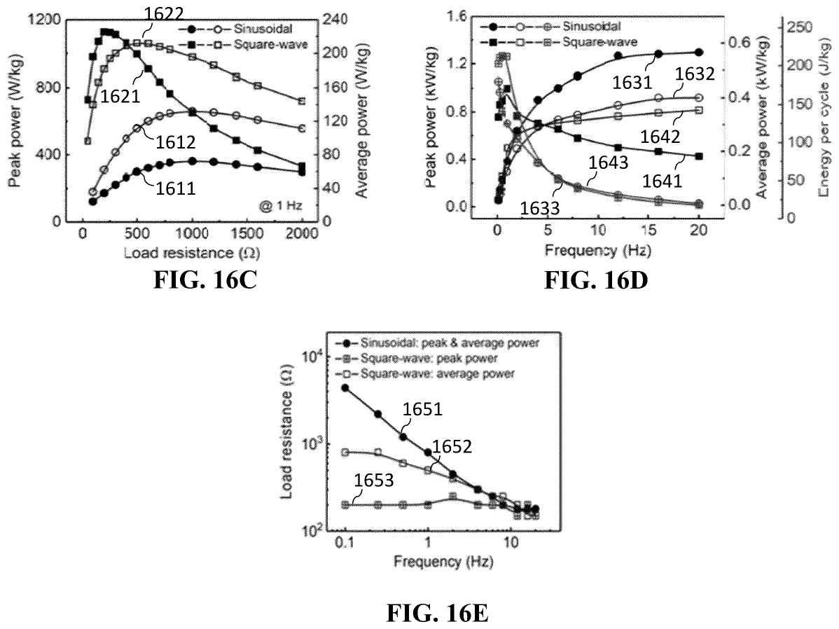

Since the shape of the strain-versus-time curve during a mechanical energy delivery cycle and the cycle frequency can be mechanically transformed, it was wondered what strain profile would increase energy harvesting. Although the ratio of peak power for a square wave to a sinusoidal wave dramatically decreases with increasing frequency, the peak power at 1 Hz is still much higher for a square wave stretch (710 W/kg) than for a sinusoidal stretch (280 W/kg) with the same total strain (64%). FIGS. 15A-15F. For both TOP and rGO@CNT twistrons, it was found that a square-wave strain provides a higher peak and average electrical power output than a sinusoidal strain for deformation frequencies between 0.2 Hz and 4 Hz. FIGS. 15B-15C. The maximum ratio of harvested energy per cycle for the square wave to that for the sinusoidal wave is at the same frequency (1 Hz) and has nearly the same value for the TOP twistron (2.1) and the rGO@CNT twistron (1.7). At higher frequencies, both deformations provide nearly the same harvested energy per cycle, because this is partially determined by internal deformation times of the twistron, such as those for the extrusion and reabsorption of electrolyte. FIG. 15E shows the powering of a 100-mW green light-emitting diode by one square-wave 0.2 Hz stretch of a TOP twistron weighing only 1.04 mg, which is possible because the peak power for the square wave is 9.7 times that for the sinusoidal wave at this frequency. The peak power quasi-linearly increases with total strain for a 0.2 Hz square-wave stretch of a TOP twistron. Similar frequency dependencies, although much higher peak power and average power, are obtained for sinusoidal and square-wave deformations for rGO@CNT twistrons. FIGS. 16A-16E.

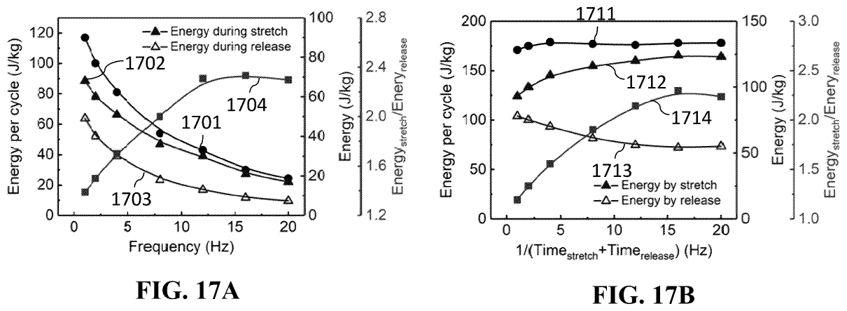

For many applications, there will be time delays between successive mechanical deformations, and latches can be used to temporarily maintain stretched states. It has next been shown that harvesting during these time delays can increase the energy harvested from mechanical energy pulses, as well as the efficiency of mechanical energy harvesting. FIG. 17A shows that the electrical energy per cycle during continuous sinusoidal deformation dramatically decreases with increasing frequency for a rGO@CNT twistron. However, the total harvested energy per cycle increases and becomes essentially frequency independent for frequencies up to 20 Hz when sinusoidal stretch and stretch release are separated by 2 s intervals (FIG. 17B), during which harvesting occurs but no external mechanical deformation. By including this extra 2 s of energy harvesting for a Pt-wire-wrapped rGO@CNT twistron, the energy conversion efficiency at 0.1 and 0.25 Hz increased from 5.3% and 5.5% to 6.4% and 7.6%. Allowing this extra time enables structural relaxation that enhances harvesting. The need for this extra harvesting time is most clearly seen by noticing that the twistron buckles during high frequency stretch-release, rather than merely contracting. Due to the time required for electrolyte extrusion from the yarn during high frequency stretch, the relaxation time also degrades energy harvesting during yarn elongation.

### Plied Twistron Harvesters

The only types of twistron harvesters that have previously been shown to generate significant electrical power densities from tensile mechanical energy had structures that were both twisted and coiled. However, it has now been surprisingly discovered that high power densities can be obtained from twisted and plied twistron harvesters that have the same chirality for all plied yarns and the same chirality for plying as for twisting. More specifically, it has been found that 3-ply yarns having the same chirality for twist in all yarns as the chirality of plying can generate a gravimetric peak power of up to 1340 W/kg and a gravimetric average power of 415 W/kg when cycled at 50 Hz, as well as up to an output gravimetric electrical energy of 353 J/kg per mechanical cycle at 0.1 Hz.

Moreover, it has now been discovered that the energy conversion efficiency that is obtained for these plied twistrons is much higher than was obtained for harvesters that are twisted and coiled. More specifically, these 3-ply fully homochiral non-coiled harvesters provide a high mechanical-to-electrical energy conversion efficiency of up to 16.6% for tensile energy harvesting and 19.0% for torsional energy harvesting. For comparison, the highest efficiency obtained for prior-art twistrons [Kim 2017; Baughman '422 Patent] was 1.05%. Also, the highest harvesting herein for twisted and coiled harvesters is 7.6% for tensile deformation and 7.6% for torsional deformation of twisted non-plied, non-coiled twistron harvesters. However, the maximum peak power and average power output of plied twistron harvesters are lower than these herein described twisted and coiled twistron harvesters. Hence, these plied fully-homochiral harvesters are most valuable for applications where the input mechanical energy is limited.

While the CNT forests that were used for the plied yarn harvesters had a HOF of about 0.5, which is lower than the HOF that maximized the performance of the twisted and coiled yarn harvesters, a high load was applied during twist insertion (42 MPa). This load increased the HOF of the CNTs on the surface of the twisted yarns to about 0.68, which is similar to that for the precursor sheets that provide the highest performance for the twisted and coiled yarns.

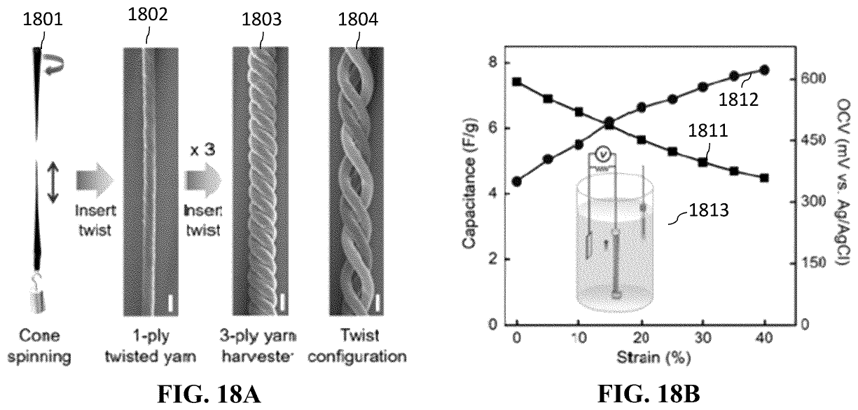

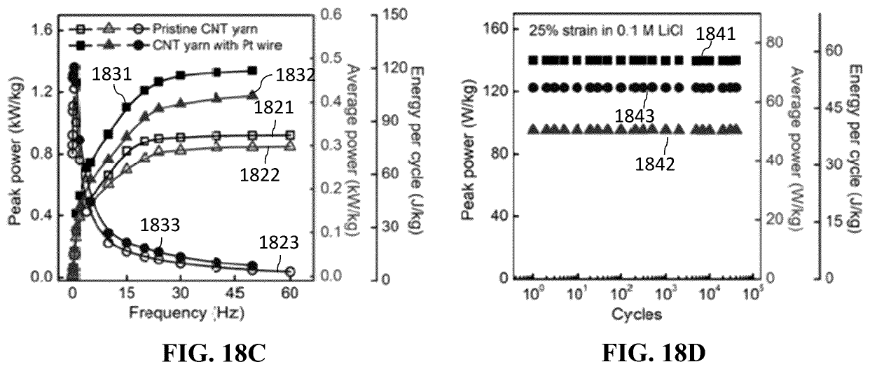

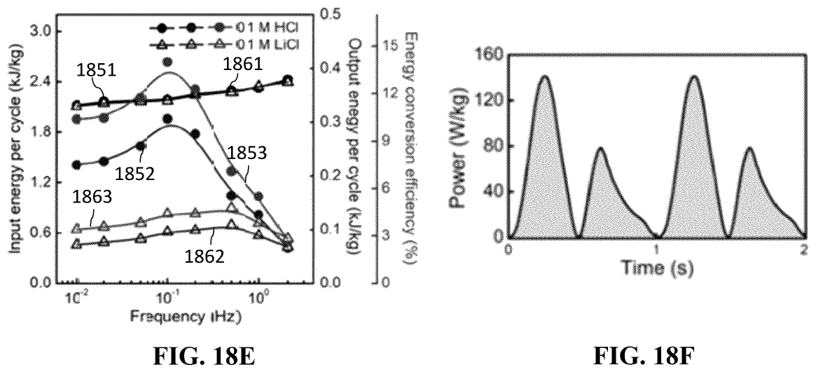

A 3-ply CNT yarn harvester was fabricated by plying three identical cone-spun CNT yarns (81-μm in diameter and twist density of 28 turns/cm) of forest-drawn MWNTs. FIG. 18A. Insertion of more twist would result in yarn coiling, which is not desired. The twist density for plying was 16 turns/cm under an applied stress of 18 MPa and the plying direction was the same as the twist direction for the individual cone-spun yarns. FIG. 18A.

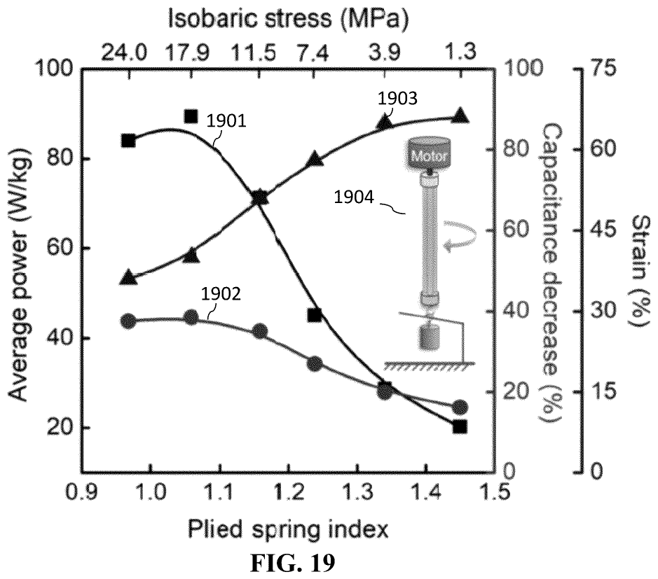

The resulting 3-ply yarn has a close-pack structure with a ply spring index of 1.06. The ply spring index (PSI) is defined as the ratio PSI=(D−d)/d, where D is the diameter of 3-ply yarn harvesters and d is the diameter of individual yarn. Unless otherwise noted, a 3-ply yarn harvesters with a ply spring index of about 1.06 were used for all performance characterizations. As shown by the results of FIG. 19, the average power generated by the 3-ply harvester reaches a peak when the spring index is below 1.2, which is preferred for the invention embodiments for the plied yarn harvesters. FIG. 19 shows that the spring index of the 3-ply yarn decreases with increasing applied stress during plying, so the stress applied during plying should preferably be above 9.5 MPa in order to provide a high average power.

Since 3-ply yarns made using the above optimized parameters provide optimal energy harvesting performance, these harvesters are referred to as optimized-ply-structure (OPS) harvesters. The SEM image of the 3-ply OPS, from which 15% of the plying twist was removed, is shown in FIG. 18A (SEM 1804) and each individual CNT yarn was shaded with different shades to illustrate the ply configuration. This ply structure, which can maximize the volume change and electrochemically accessible surface area during stretching, is very different from the coiled structure of the earlier twistron energy harvesters [Kim 2017; Baughman '422 Patent].

For characterizing the performance of the plied twistron harvesters, a three-electrode electrochemical system was used, with an OPS harvester as working electrode, a high-surface-area CNT counter electrode, and an Ag/AgCl reference electrode (electrochemical cell 1813 shown in FIG. 18B). When slowly stretched from 0% to 40% strain, the capacitance of an OPS harvester in 0.1 M LiCl aqueous electrolyte decreased from 7.42 F/g to 4.49 F/g, and the corresponding open-circuit potential (OCP) increased by 282 mV. FIG. 18B. The maximum peak-to-peak OCP of the OPS harvester was about 2 times that (140 mV) of our previous twistron energy harvester for a 1 Hz sinusoidal stretch [Kim 2017; Baughman '422 Patent]. Unless otherwise noted, the representative electrolyte used herein is 0.1 M LiCl aqueous solution, the counter electrode is a high-surface-area carbon electrode, and the reference electrode is Ag/AgCl. The observed OCV varied synchronously in response to an applied 1 Hz, 40% sinusoidal stretch and reached a peak of 282 mV. The gravimetric peak SCC reached 1.55 A/g, which is about 4.4 times that (0.35 A/g) of previous twistron harvesters [Kim 2017; Baughman '422 Patent].

The frequency dependencies of OCV, output power, and energy per cycle for an OPS harvester was measured from 0.01 Hz to 60 Hz in 0.1 M LiCl solution. For a sinusoidal, 40% stretch at 60 Hz, the gravimetric peak power and average power for the OPS harvester were 922 W/kg and 298 W/kg, respectively, while the maximum output gravimetric energy per cycle at 0.5 Hz reached 108.3 J/kg. FIG. 18C. To increase the output power and energy by decreasing the internal electrical resistance, a 25-um-diameter platinum wire was incorporated into the OPS harvester during plying. This increased the peak power and average power to 1340 W/kg and 415 W/kg, respectively, when the harvester was stretched to 40% strain at 50 Hz.

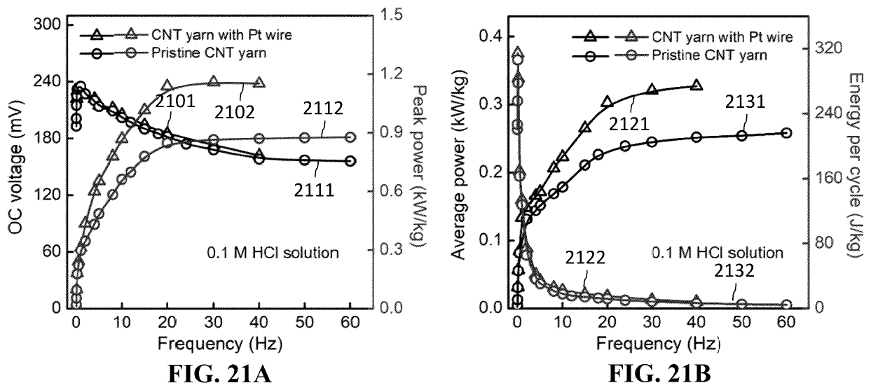

While the performance of twisted and coiled harvesters was higher in 0.1 M HCl aqueous electrolyte than in 0.1 M LiCl aqueous electrolyte, this was not the case for the OPS harvester. Using a 0.1 M HCl aqueous electrolyte, instead of the 0.1 M LiCl aqueous electrolyte, decreased the average power to 258 W/kg at 60 Hz, but provided a higher output energy per cycle of 306.2 J/kg at 0.1 Hz. FIG. 21A. When a platinum wire was incorporated, the average power and output energy per cycle for the OPS harvester in 0.1 M HCl solution was 327 W/kg (at 40 Hz) and 314.3 J/kg (at 0.1 Hz), respectively. FIG. 21B. This energy per cycle for the OPS harvester in 0.1 M HCl is 7.6 times the maximum output energy per cycle for our previous twistron energy harvesters (41.2 J/kg) [Kim 2017; Baughman '422 Patent].

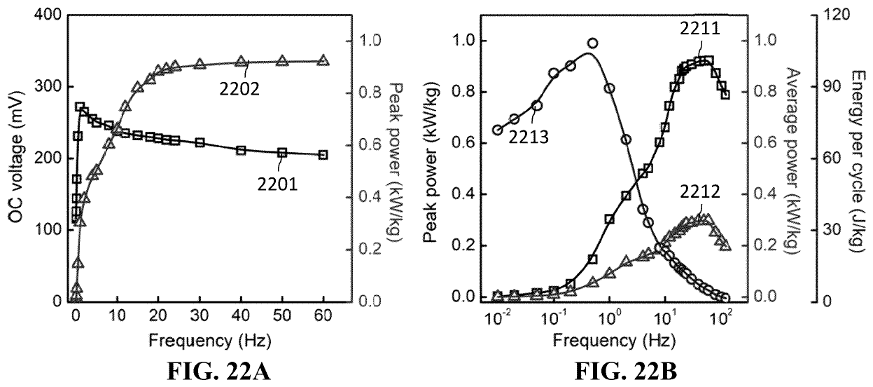

Due to insufficient time for energy collection for OPS harvesters operated at very high frequencies, the output peak power and average power decrease with increasing deformation frequency for harvesters sinusoidally stretched to 40% strain at above 60 Hz in 0.1 M LiCl aqueous electrolyte. FIG. 22B. Nevertheless, the peak power and average power for an OPS harvester reached 788.5 W/kg and 196.8 W/kg at 120 Hz, respectively, for a 40% strain. FIG. 22B. Decreasing the frequency to 60 Hz increased the peak power and average power for the OPS harvester to 922.4 W/kg and 297.6 W/kg, respectively. This 40% sinusoidal strain for an OPS harvester that incorporated a Pt wire current collector produced even higher peak power at 30 Hz (1311 W/kg). For comparison, the highest peak power value reported in the literature for other solid-state harvesters at very high frequencies were 54 W/kg at 60 Hz for a piezoelectric harvester and 0.84 W/kg at 34 Hz for a triboelectric harvester. Also, a maximum peak power at 30 Hz of 250 W/kg was reported for previous twistrons [Kim 2017; Baughman '422 Patent].

The durability of the OPS harvesters is very important for harvesting energy through mechanical stretch. The generated OCV, output power, and energy per cycle were reversible for the investigated 40,000 sinusoidal stretch cycles at 1 Hz to 25% strain. FIG. 18D. These results demonstrate that the OPS harvesters of the present invention show exceptional structural stability during mechanical stretch/release cycles in an inexpensive aqueous salt electrolyte.

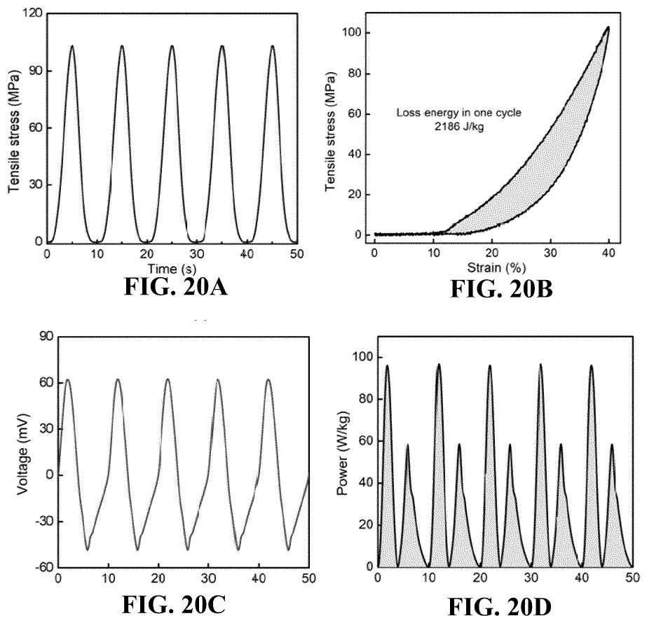

Using the ratio of the output electrical energy per cycle to the input mechanical energy per cycle, the mechanical-to-electrical energy conversion efficiency for the OPS harvesters was measured over the frequency range from 0.01 to 2 Hz. As a typical example of how energy conversion efficiencies were calculated for all mechanical energy harvesters, this method is illustrated in FIGS. 20A-20D for the specific case of OPS harvesters. With increasing frequency in this frequency range, the input mechanical energy per cycle for an OPS harvester increased by ˜14% (FIG. 18E), although the mechanical energy needed per cycle was nearly the same for both 0.1 M HCl and 0.1 M LiCl aqueous electrolytes. Moreover, the input mechanical energy per cycle that corresponds to the maximum output energy per cycle (306.2 J/kg at 0.1 Hz) was 2186 J/kg for the OPS harvester in 0.1 M HCl electrolyte. As a result, the highest energy conversion efficiency for the OPS harvester reached 14.0%, which is about 14 times the 1.05% of the prior reported twistron harvesters [Kim 2017; Baughman '422 Patent]. This indicates that these harvesters are more efficient for harvesting low-frequency (<2 Hz) mechanical energy, such as the mechanical energy generated by ocean waves.

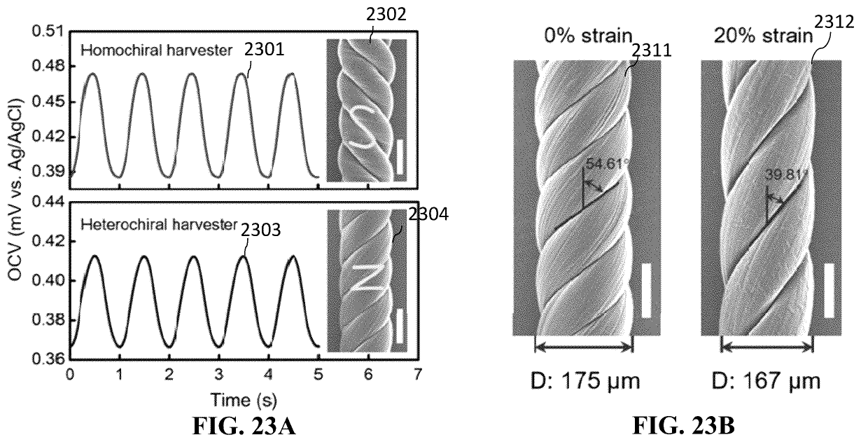

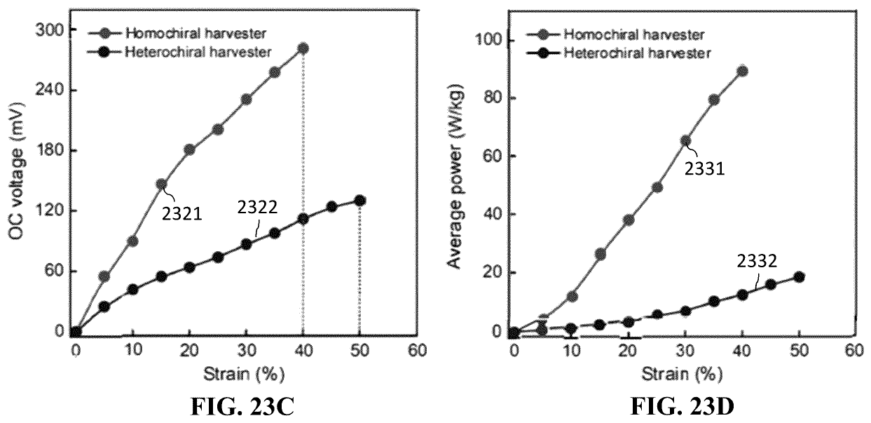

The relative chiralities of yarn twist and yarn plying strongly affects the performance of the OPS harvesters of the present invention. When the handedness of ply direction is the same as the twist direction of the individual yarns, the OPS harvester is called a “homochiral harvester.” On the other hand, if the plying direction is opposite to the twist direction of the individual yarns, the final plied yarn is called a “heterochiral harvester.” FIG. 23A. For a heterochiral harvester, twist insertion during plying results in untwist of individual yarns, which increases the stretchable strain for the harvester and decreases the capacitance change during harvesting. As a result of this decreased capacitance change, the maximum OCV (282 mV) for the homochiral harvester for 40% sinusoidal strain was 2.17 times that for a heterochiral harvester for 50% sinusoidal strain (130 mV at 1 Hz). FIG. 23C. Hence, the maximum average power (89.4 W/kg at 1 Hz) for the homochiral harvester was 4.67 times that for the heterochiral harvester (19.1 W/kg at 1 Hz) (FIG. 23D), indicating that the homochiral harvesters are more useful for harvesting tensile mechanical energy compared with the heterochiral harvesters.

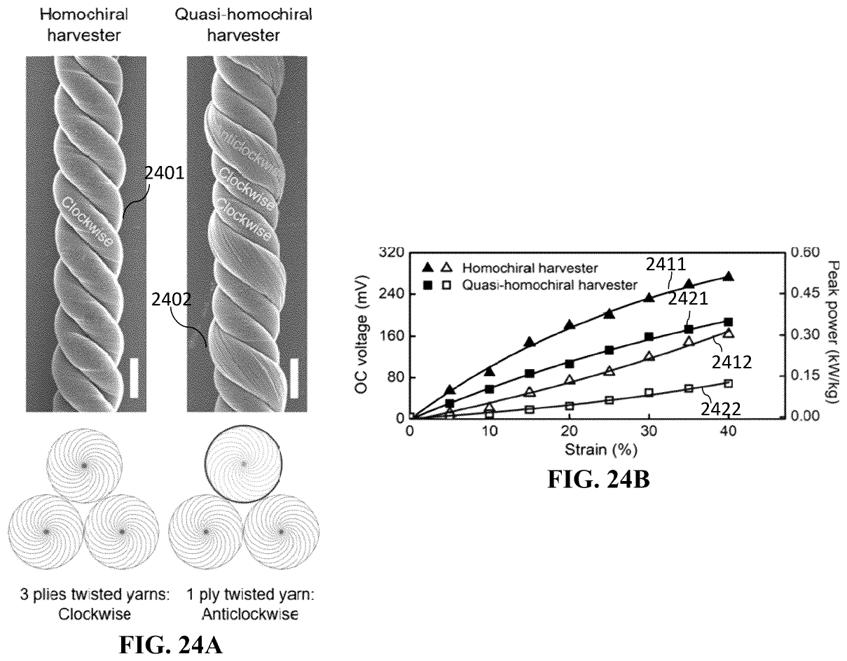

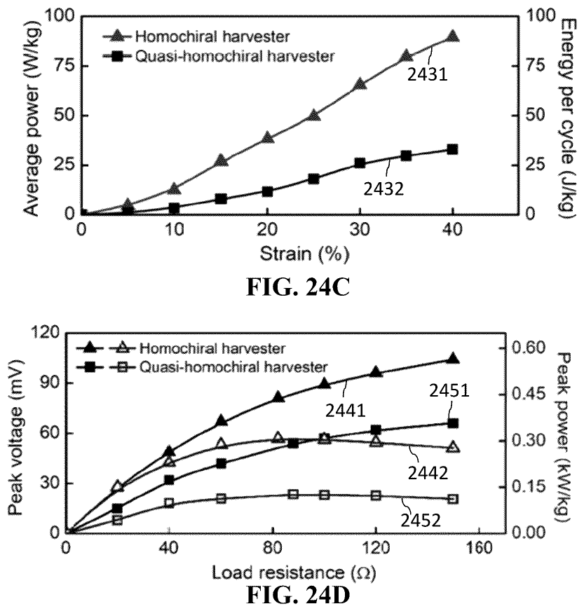

It has also been found that harvester performance was optimized by having the same chirality of twist direction for all of the plied CNT yarns. FIGS. 24A-24D. When one or more of the plied individual yarns has an opposite twist direction to that of the other yarns, the plied yarn is called quasi-homochiral as long as most of plied yarns has a chirality of twist that is the same as the chirality of plying. A quasi-homochiral harvester in which one of the three plied yarns has a different chirality than the chirality of plying produced an OCV of 187 mV and a peak power of 122 W/kg when stretched to 40% strain at 1 Hz. This performance was much lower than for a homochiral 3-ply yarn harvester. FIGS. 24B-24D.

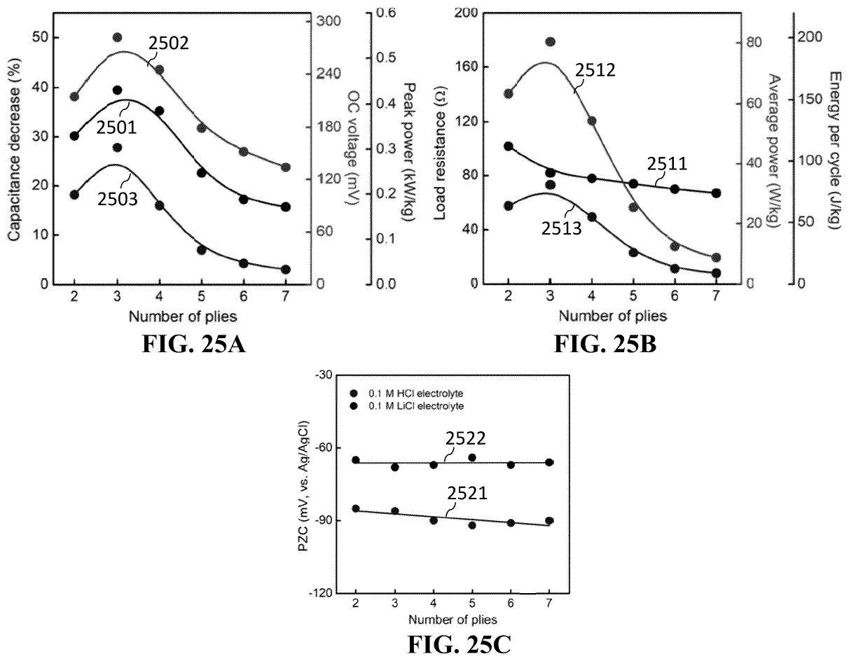

FIGS. 25A-25C show the performance of multi-ply yarn OPS harvesters as a function of the number of single yarns plied and the relative chirality of these yarns. Each individual yarn used for the fabrication of multi-ply harvesters were produced identically, expect for the chirality used for twist insertion. FIG. 18A. Of the investigated multi-ply harvesters, the 3-ply homochiral configuration generated the highest OCV and the highest output power, as a consequence of its record decrease in capacitance when stretched to the maximum reversible strain. FIG. 25A. In contrast, the 7-ply configuration generated the smallest decrease in capacitance (15.7%), which resulted in the lowest OCV (134 mV) and the lowest peak power (33.1 W/kg). FIG. 25A.

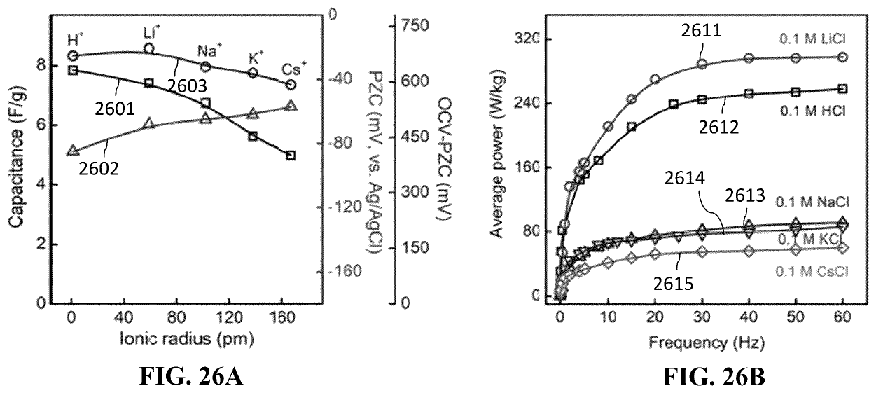

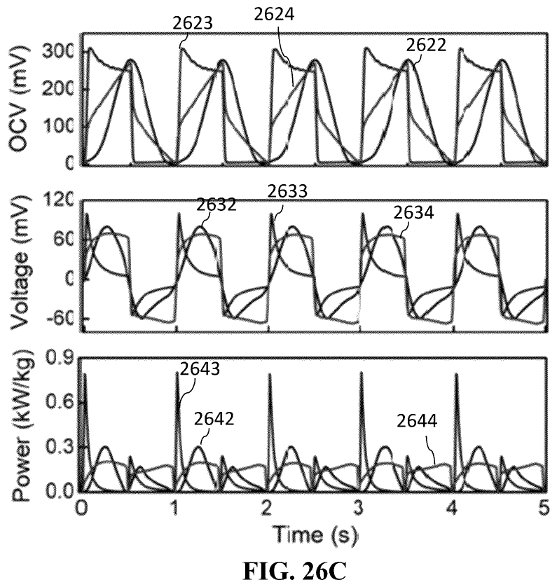

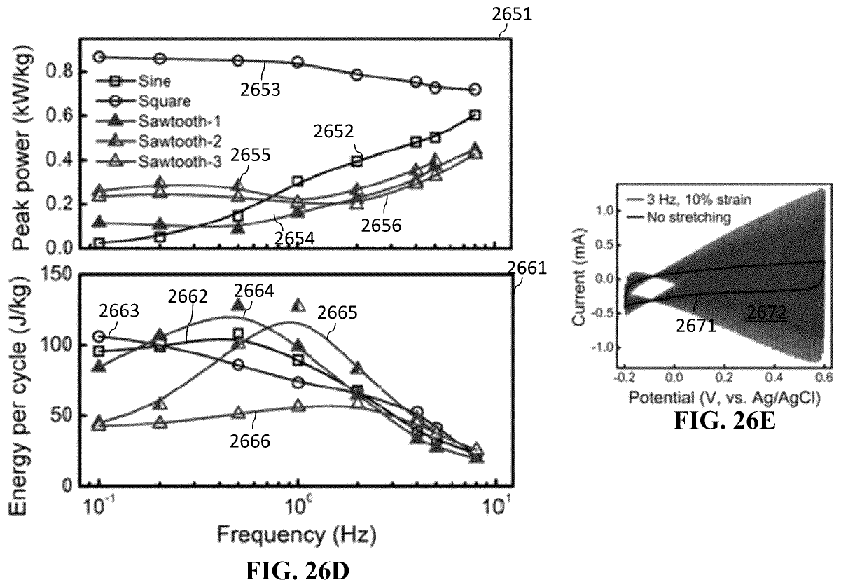

OPS harvesters were characterized in various acid and salt aqueous electrolytes (i.e., 0.1 M HCl, 0.1 M LiCl, 0.1 M NaCl, 0.1 M KCl and 0.1 M CsCl solution). FIG. 26A shows that the capacitance for OPS harvesters at 0% strain increased from 4.99 to 7.85 F/g when the ionic radius decreased from 167 picometer (cesium ion) to 1.2 (hydrogen ion). This is a surprising result, since the hydrated ion size increases as the ionic radius decreases, and one would expect that the hydrated ion size determines the electrochemically accessible surface area within twisted yarns.

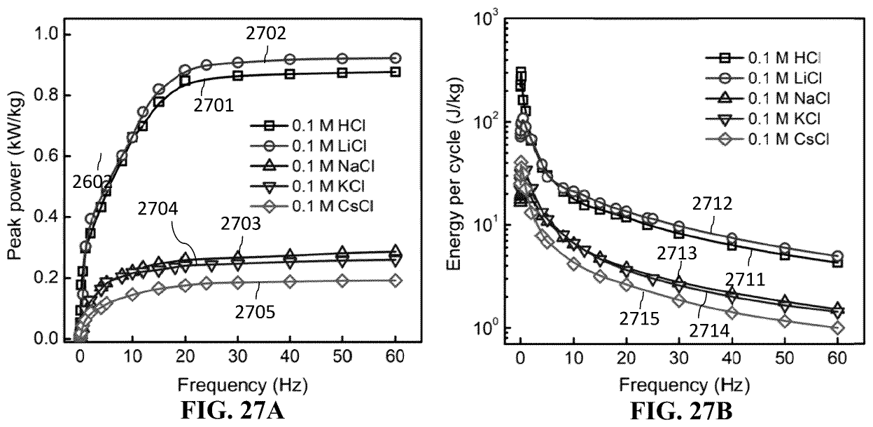

FIG. 26B shows the frequency dependence of average power for OPS harvesters in the above electrolytes. The 0.1 M LiCl electrolyte provided the highest average power (298 W/kg) for a 40% strain at 60 Hz, which is nearly 5 times that for a 0.1 M CsCl electrolyte. The corresponding peak power (FIG. 27A) and energy per cycle (FIG. 27B) for the OPS harvesters in these electrolytes were characterized for frequencies from 0.01 to 60 Hz, and show similar trends as observed for average power.

To provide further insights into the electrochemical mechanism of voltage generation, the equilibrium charge state of OPS harvesters was evaluated by using piezoelectrochemical spectroscopy (PECS) to measure the potential of zero charge (pzc). The pzc for the OPS harvesters decreased from −86 to −57 mV as the ionic radius increased from 1.2 to 167 pm. FIG. 26A. FIG. 26E shows the PECS characterization for an OPS harvester in 0.1 M HCl electrolyte, which was obtained by CV scanning while the OPS harvester was simultaneously stretched sinusoidally by 10% strain. Comparing CV scans with (plot 2672) and without stretching (plot 2671), the dependence of the magnitude of the stretch-induced current was determined versus applied potential. From the plots shown in FIG. 26E, the pzc of the OPS harvester in 0.1 M HCl electrolyte was −86 mV versus Ag/AgCl, as determined by the potential at which the stretch-induced component of electrical current was smallest. The intrinsic bias voltage (the difference between the pzc and the OCV at 0% strain) for the OPS harvesters varied from 690 to 592 mV as the ionic radius varied from 1.2 to 167 pm. FIG. 26A. This indicates that a positive equilibrium charge exists on the harvester electrode, due to charge injection from the electrolyte, which is utilized for electricity generation.

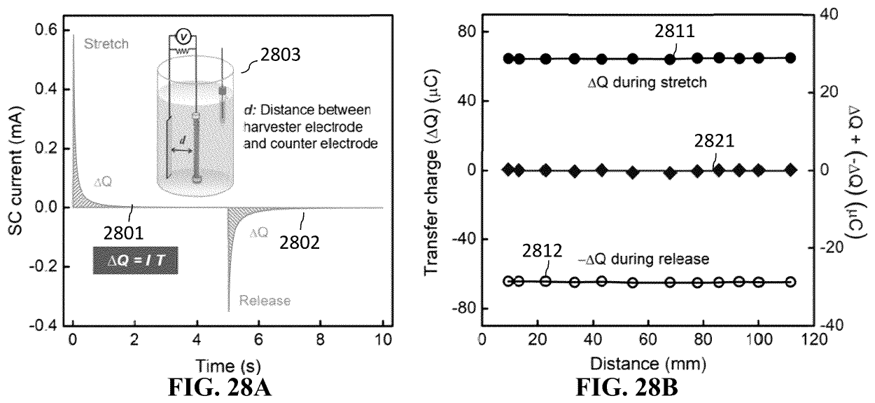

The charge transfer was also characterized during harvesting (AQ) for OPS harvesters operated in 0.1 M LiCl electrolyte. FIG. 28A shows that the charge transfer for stretch and stretch-release were equal when an electrically shorted OPS harvester was stretched to 10% using a 0.1 Hz square-wave. Moreover, the transferred charge for both stretch and stretch-release was constant for the investigated separations between the harvester working electrode and counter electrode (9.4 to 112 mm). FIG. 28B. This indicates that the performance of the harvester was independent of electrode separation in this separation range.

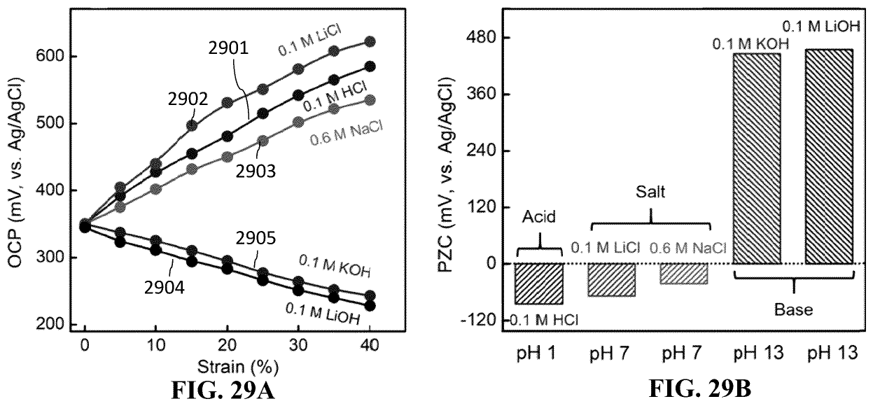

The effect of the electrolyte's pH on the generated OCV and pzc for OPS harvesters was also investigated. FIGS. 29A-29B. The sign of the generated OCV was opposite for the high-pH electrolytes than for the low-pH and neutral pH electrolytes (FIG. 29A), indicating that electron injection for a high-pH electrolyte (0.1 M LiOH and 0.1 M KOH, pH=13), and hole injection occurred for a low-pH electrolyte (0.1 M HCl, pH=1) and a neutral-pH electrolyte (0.1 M LiCl and 0.6 M NaCl, pH=7).

Of the electrolytes investigated, 0.1 M LiCl aqueous electrolyte provided the highest OCV (282 mV) for a 40% strain at 1 Hz, corresponding to a peak power of 303.8 W/kg and an average power of 89.4 W/kg. In contrast, 0.6 M NaCl aqueous electrolyte (a concentration similar to that of seawater) provided an OCV of 185 mV and an output peak power of 100.3 W/kg, which allows these harvesters to be used for harvesting wave energy in the ocean.

The results in FIG. 29A show that the voltage generation capability of the OPS harvester is surprisingly superior to that previously reported for our twisted and coiled twistron harvesters [Kim 2017; Baughman '422 Patent]. More specifically, the results of FIG. 29A show that a 30% strain changes the OCP by 200, 152, and −86 mV for 0.1 M HCl, 0.6 M NaCl, and 0.1 M KOH aqueous electrolytes, which are all higher than the OCP changes previously obtained for the prior twisted and coiled harvesters (170, 65, and −60 mV, for these respective electrolytes) [Kim 2017; Baughman '422 Patent].

These increased potential changes during stretch mean that, independent of the used electrolyte, the OPS harvester configuration provides higher output voltages for twistron application as self-powered strain sensors. In addition, in 0.6 M NaCl aqueous electrolyte, the peak and average power obtained for the OPS harvester for a 1 Hz sinusoidal strain of 30% (82 W/kg and 22 W/kg, respectively) was higher than previously reported in this electrolyte for the same frequency and strain for our previous twisted and coiled twistron harvester (46.3 W/kg and 15.3, respectively) [Kim 2017; Baughman '422 Patent]. This improved performance in NaCl electrolyte is especially of import for harvesting the energy of ocean waves.

Further investigated were ways in which the output power and energy per cycle of the OPS harvester can be increased by changing the shape of the applied time-dependent deformation. FIG. 26C shows the time dependence of OCV, voltage across the load resistor, and the power generated by an OPS harvester during sinusoidal, square-wave, and sawtooth-wave stretch to 40% strain at 1 Hz. For all of the applied frequencies, a square-wave deformation provided the highest peak power. This peak power for a square-wave deformation was maximized at 0.1 Hz to provide a peak power of 867 W/kg and an average power of 10.6 W/kg. The average power for a square-wave deformation was highest (220 W/kg) for a higher frequency of about 6 Hz. For these measurements, the stretch rate for a square-wave deformation was kept within the range of 310% to 360% strain per second. The duty cycle for square-wave deformation is defined as the ratio of the time when fully stretched to the time when this stretch is fully released.

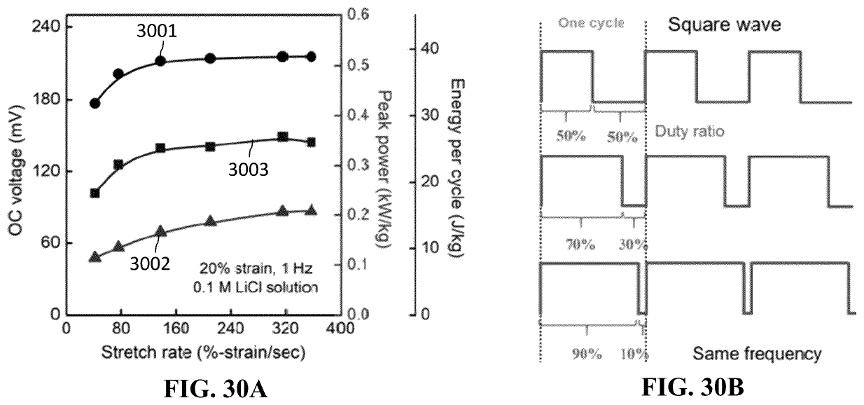

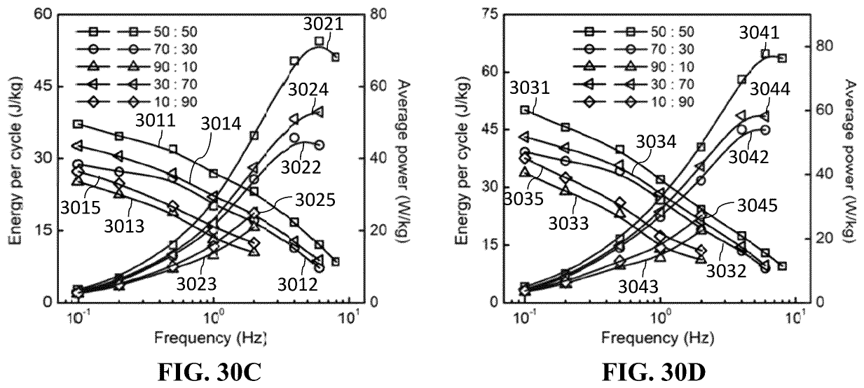

A duty cycle of about 1 provided the maximum output average power and maximum peak power. FIGS. 30A-30D. While sawtooth deformation provided a much lower peak power than a square-wave at all frequencies, an optimized sawtooth wave provided the highest maximum energy per cycle (127 J/kg) at 1 Hz, which is 1.42 times and 1.73 times that for a sinusoidal wave and square wave deformations, respectively. Sawtooth waves consist of two combined strokes during deformation: an initial square-wave deformation (stroke-A) followed by a constant strain rate deformation (stroke-B). FIG. 26C. The ratio of stroke-A to stroke-B was varied to optimize the energy per cycle for the OPS harvesters. The energy per cycle reached a global maximum (127 J/kg at 1 Hz) when a sawtooth wave having a 0.7 stroke ratio was used. FIG. 26D.

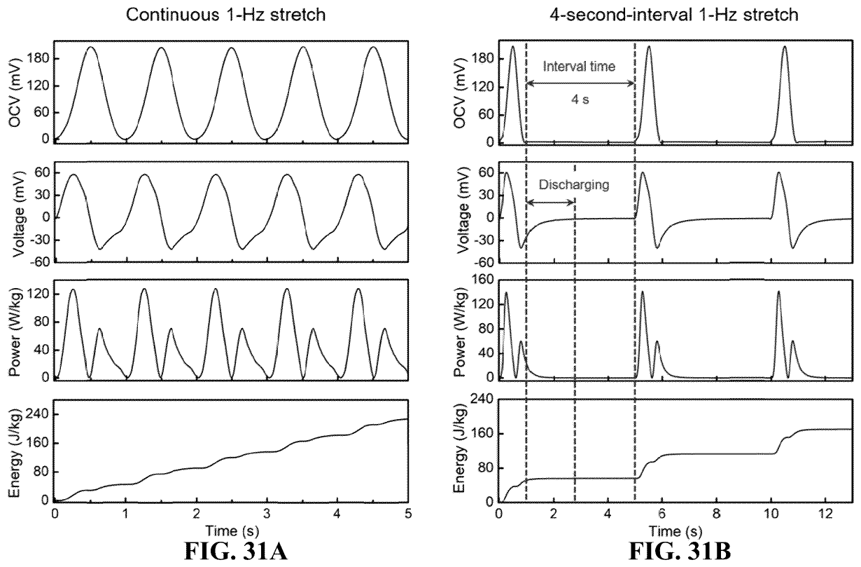

It was discovered that the harvested energy per cycle for OPS harvesters can be increased by inserting time intervals where harvesting is conducted, but the harvester is not undergoing deformation (either after stretch or after stretch-release). In the next example, the benefit is shown of applying this interrupted deformation method after a sinusoidal stretch-release. A 4-second-interval in which harvesting was conducted, but deformation was not allowed, was inserted between 1 Hz sine wave deformations for an OPS harvester. The harvesting was conducted in 0.1 M LiCl aqueous electrolyte to 25% strain. The harvested energy per cycle for this interrupted sine wave deformation was increased by 25.6% compared to that for a continuous 1 Hz sinusoidal deformation. FIGS. 31A-31B.

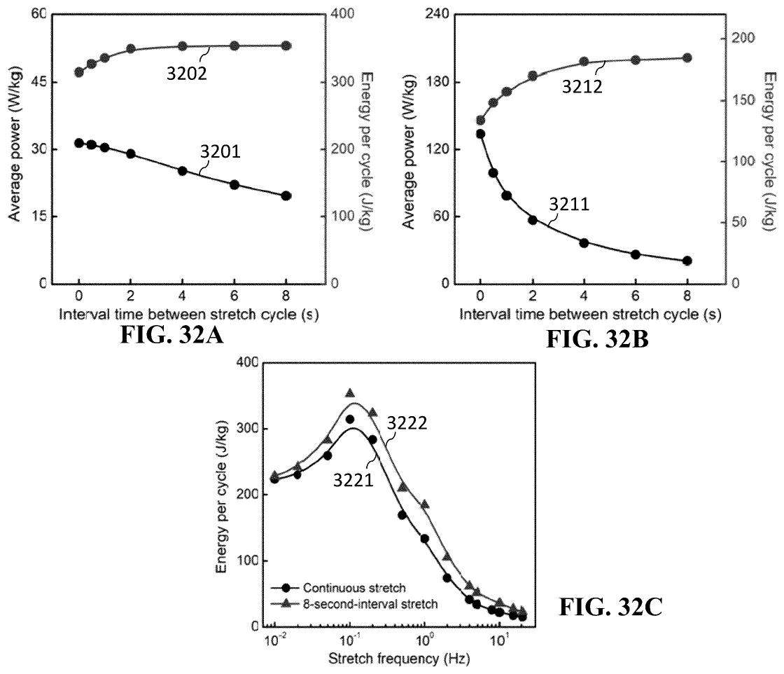

This increase resulted from the longer time for energy harvesting in each deformation cycle. When operating a Pt-wire-wrapped OPS harvester in 0.1 M HCl aqueous electrolyte using a 40% strain, it was found that use of the interrupted deformation method increased the per cycle energy output for a 0.1 Hz and a 1 Hz sinusoidal deformation by 12.3% and 37.6%, respectively, compared with the energy output for a continuous sinusoidal deformation. FIGS. 32A-32C. For the same Pt wire wrapped OPS harvester and the same electrolyte and maximum applied strain,

FIGS. 32A-32C show the dependence of harvested energy per sinusoidal cycle on the time interval where deformation is interrupted but harvesting is conducted. These results for sinusoidal deformations at 0.1 Hz (FIG. 32A) and 1 Hz (FIG. 32B) show that the energy per cycle monotonically increases with increasing interruption time and reaches an approximate plateau at 2 s and 6 s, respectively. However, in both cases the average power decreases with increasing interruption time.

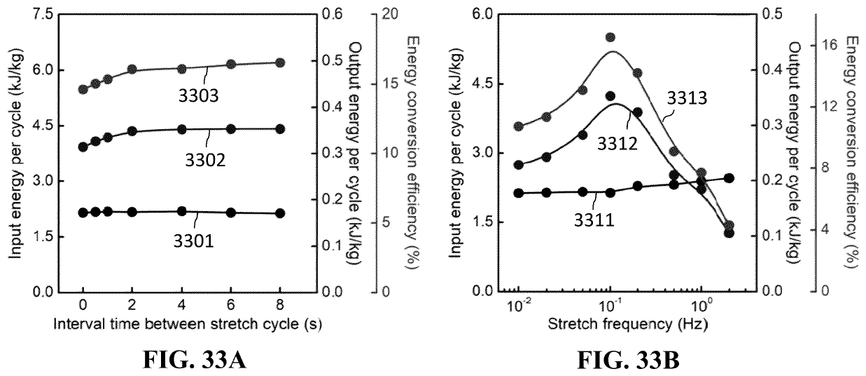

Of note, the results of FIGS. 33A-33B (for the same Pt wire wrapped OPS harvester and the same electrolyte and the same maximum applied strain) show that the introduction of the interruption time substantially increases the energy conversion efficiency. This energy conversion efficiency peaks at 16.6% for a 0.1 Hz sinusoidal deformation that is interrupted by 8 s. For comparison, elimination of the interruption time decreased the energy conversion efficiency for a 0.1 Hz sinusoidal deformation to 14.6%.

Various means that are known in the prior-art can be used to mechanically convert energy that is generated by a mechanical energy source, such as the wind or ocean waves, to a tensile deformation that is periodically interrupted. One example is a Scotch yoke [Tao 2017] that provides dwell times in which rotational energy is not converted to tensile deformations.

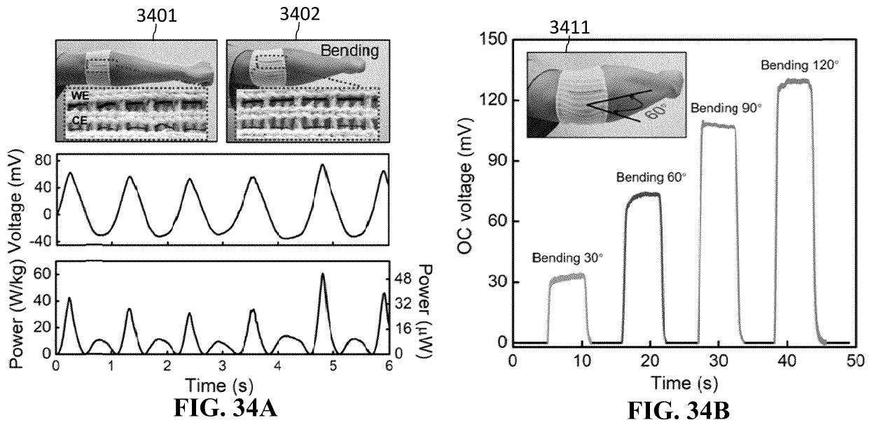

FIGS. 34A-34B show the geometries of a harvesting electrode and a non-harvesting counter electrode for a self-powered body-motion sensor that is woven into a textile, which uses an OPS yarn for the harvesting electrode. Both the harvesting OPS electrode and a single twisted yarn (10 turns/cm) counter electrode were first sewn in-parallel along the arm direction of a cotton elbow brace, and then jointly overcoated with a solid electrolyte (0.1 M LiCl/10-wt %-PVA gel). While the harvesting electrode was sewn into the textile in a largely straight configuration, with firmly tethered ends, the non-harvesting counter electrode was sewn in a zigzag pattern with non-tethered ends, so that it was little deformed during arm bending. When the arm was bent about 90°, the voltage generated across a load resistance (108Ω) was about 63 mV. FIG. 34A. Each cycle of such arm bending generated about 9.60 μW of power, which corresponded to a gravimetric power of 11.3 W/kg, when normalized to the weight of the harvesting electrode. The total generated energy from 5.5 cycles of arm bending was 67.8 J/kg, which corresponds to an average energy per cycle of about 12.2 J/kg. FIG. 34B shows the different OCVs generated by the arm bending sensor for different angles of arm bending.

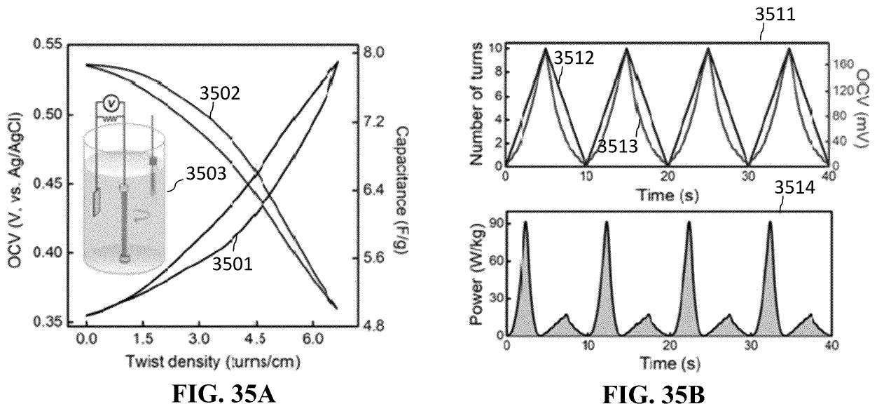

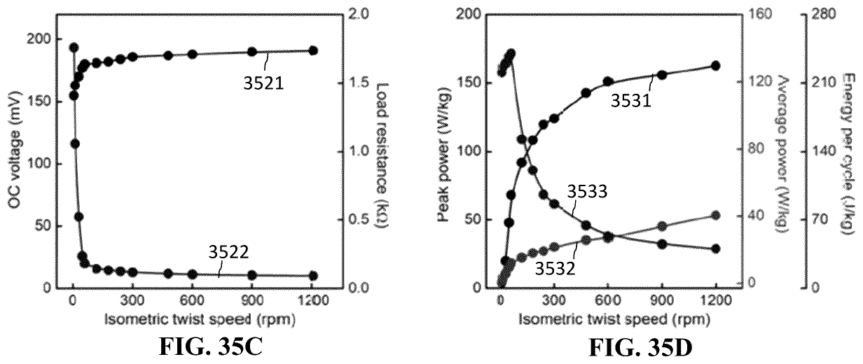

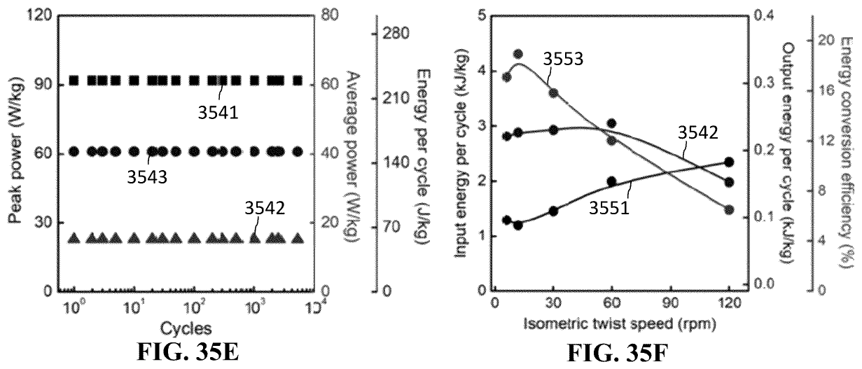

In addition to harvesting tensile mechanical energy, the OPS harvesters of the present invention can also be used for harvesting torsional mechanical energy. This was accompanied reversibly by isometrically inserting twist in the same twist direction as used for both yarn twist and yarn plying. Isometrically twisting 14.7-mm-long 3-ply OPS harvester in 0.1 M HCl aqueous electrolyte by 10 turns (6.8 turns/cm) generated an OCV of ˜184 mV, corresponding to a capacitance decrease of 36.4%. FIG. 35A. FIG. 35B shows the time dependence of the inserted number of twist turns and the resulting output electrical power. The OCV increases with increasing twist speeds up to 60 rpm and then reaches an approximate plateau for higher twist speeds. FIG. 35C. With increasing twist speed, the load resistance that maximizes average output electrical power dramatically decreases with increasing twist speed until a quasi-plateau region is obtained for twist speeds above 60 rpm. FIG. 35C.

While the energy per cycle obtained for a load resistance that maximizes average power reaches a peak of 240 J/kg for a 60 rpm twist speed, the peak power and average power monotonically increase with increasing twist speed until reaching maximum values of 162.6 and 40.4 W/kg, respectively, at the highest twist speed investigated, 1200 rpm. FIG. 35D.

FIG. 35E shows that the peak power, average power, and energy per cycle for the OPS harvester were maintained for the investigated 5,000 isometric twist cycles to 10 turns (6.8 turns/cm) at 120 rpm. Notably, the maximum torsional energy conversion efficiency for the OPS harvester in this 0.1 M HCl aqueous electrolyte reached 18.95% for twist insertion from 0 to 6.8 turns/cm at 12 rpm. FIG. 35F.

The above results for our newly invented OPS harvesters provide major performance improvements compared to previously known twisted and coiled twistron harvesters [Kim 2017; Baughman '422 Patent]. First, it was found that 3-ply OPS yarns provide much higher performance tensile energy harvesting at all frequencies than do the previously known twisted and coiled harvesters. Second, it was found that the new OPS harvesters provide much higher performance torsional energy harvesting than do prior-art twistron harvesters. Third, it was found that the OPS harvesters provide an energy conversion efficiency of 16.6% at 0.1 Hz and 7.7% at 1 Hz for tensile energy harvesting and up to 19.0% (12 rpm) for torsional energy harvesting. For comparison, the highest reported energy conversion efficiency was 1.05% (at 1 Hz) for previous twistron harvesters [Kim 2017; Baughman '422 Patent].

More specifically, the 3-ply OPS harvesters of the present invention can generate a gravimetric peak power of 1340 W/kg and a gravimetric average power of 415 W/kg when sinusoidally stretched at 50 Hz, which were 5.4 times and 3.3 times, respectively, the maximum values for prior-art twistrons, which were at 30 Hz [Kim 2017; Baughman '422 Patent]. These OPS harvesters generated a maximum electrical energy output per cycle of 314 J/kg at 0.1 Hz, which is 8.3 times the maximum electrical energy per cycle for the prior-art twistrons, which was at 0.25 Hz [Kim 2017; Baughman '422 Patent]. By combining our the OPS configuration of the present invention with the newly discovered interrupted deformation method, a maximum energy harvesting per cycle of 353 J/kg was obtained, which is 8.6 times the maximum energy harvested per cycle of prior-art twistrons [Kim 2017; Baughman '422 Patent].

### Application Demonstrations

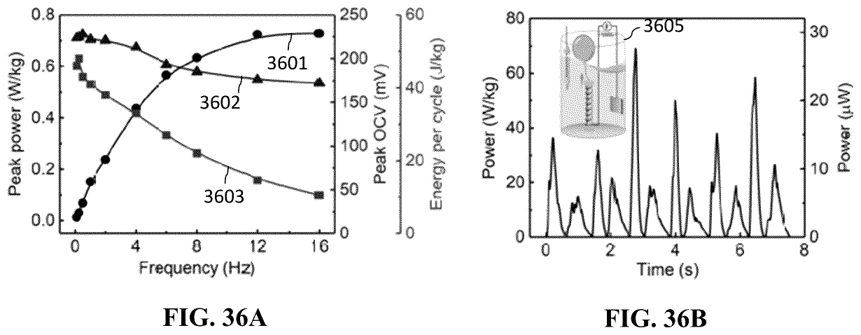

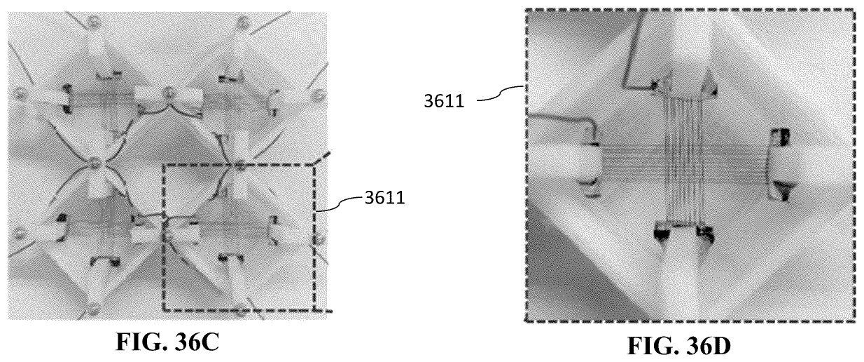

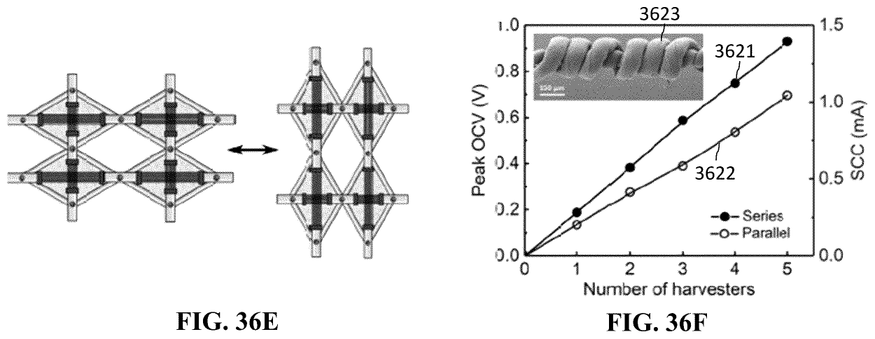

For potential use of these improved twistrons for harvesting ocean wave energy [Wang II 2017], rGO@CNT twistrons were tested in 0.6 M aqueous NaCl, a typical seawater concentration. A 725 W kg⁻¹ plateau in peak power was observed for a 46% sinusoidal deformation above 12 Hz. FIG. 36A. Harvesting was little changed for temperatures from 0 to 60° C., which can be important for use in varying temperature oceans. FIG. 36B shows the power output of a 400-μg rGO@CNT ocean-wave harvester for a simulated wave frequency of ˜0.8 Hz that provided 20% to 30% stretch in 0.6 M NaCl. One end of the yarn was tethered to the bottom of the salt water bath and the other end was attached to a balloon floating on the surface (see configuration 3605 in FIG. 36B), so the yarn was stretched with each incoming wave.

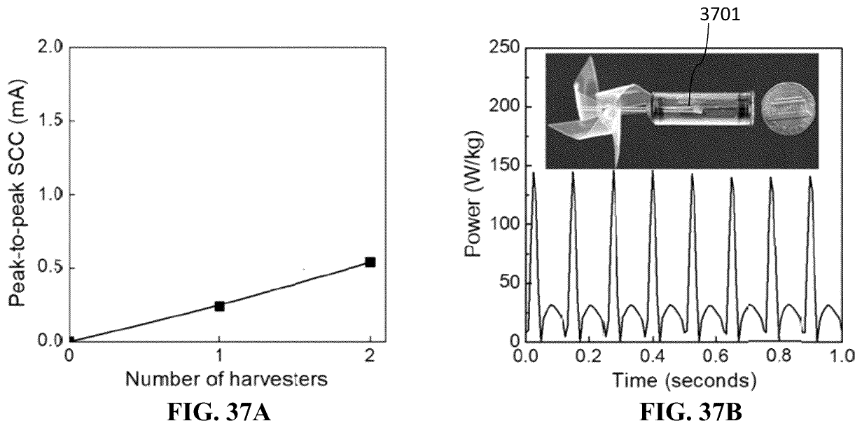

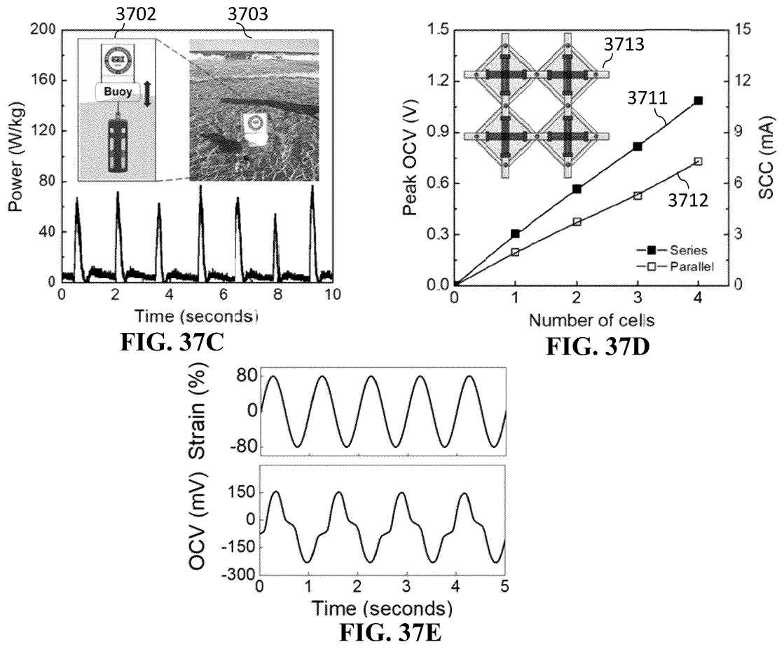

This rGO@CNT harvester generated an average output power of 11.8 W kg⁻¹, which was 7.1 times that obtained in the ocean for our previous twistron harvester [Kim 2017; Baughman '422 Patent] for about the same strain (25%) and frequency (0.9-1.2 Hz). Operating in the ocean, our TOP twistron provided an average output power of 10.7 W kg⁻¹ for ocean wave frequencies between 0.5 and 1 Hz when the tensile deformation was mechanically limited to below 50%. FIG. 37C.

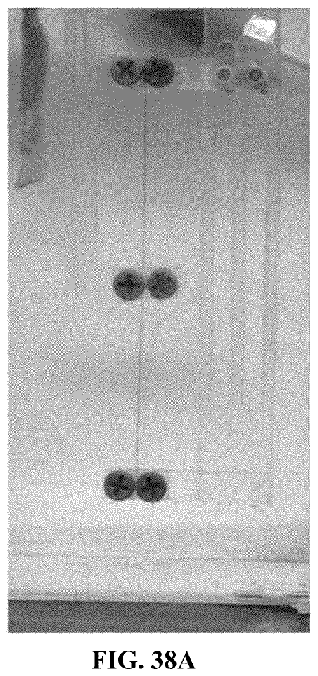

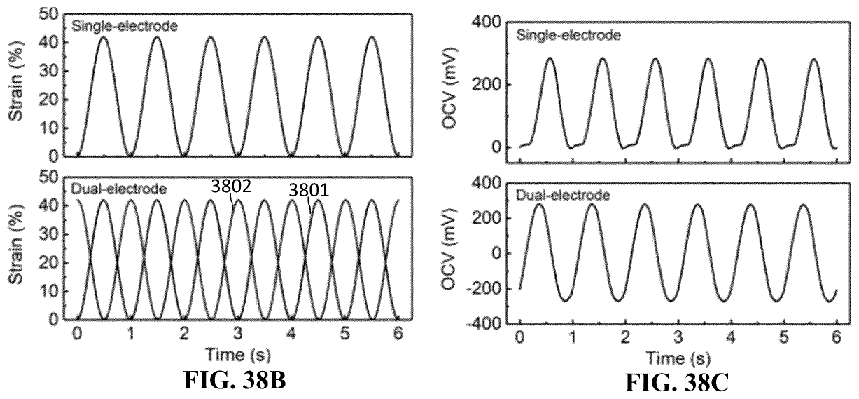

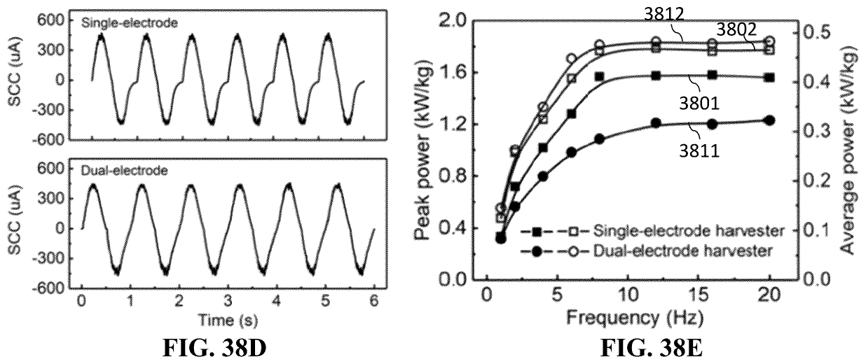

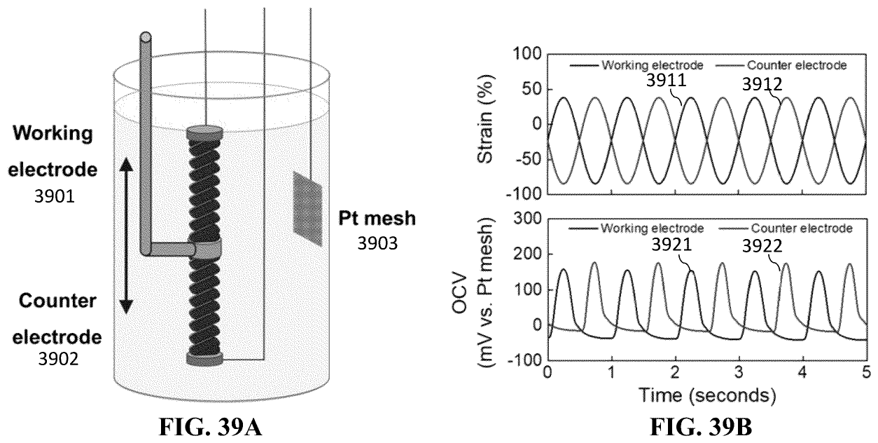

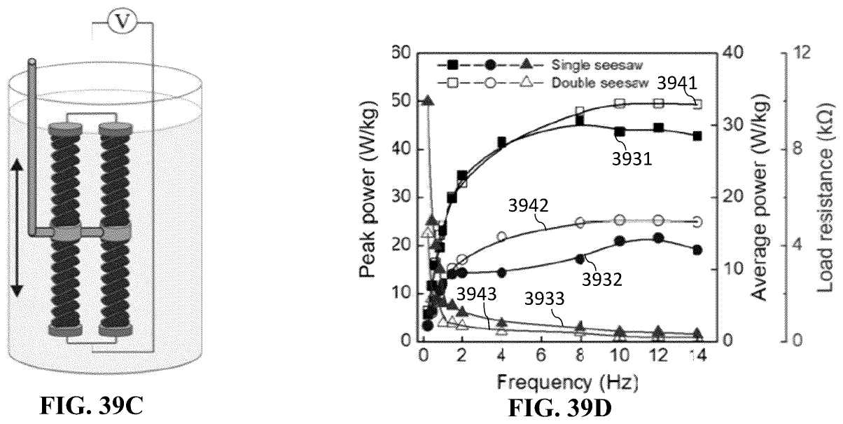

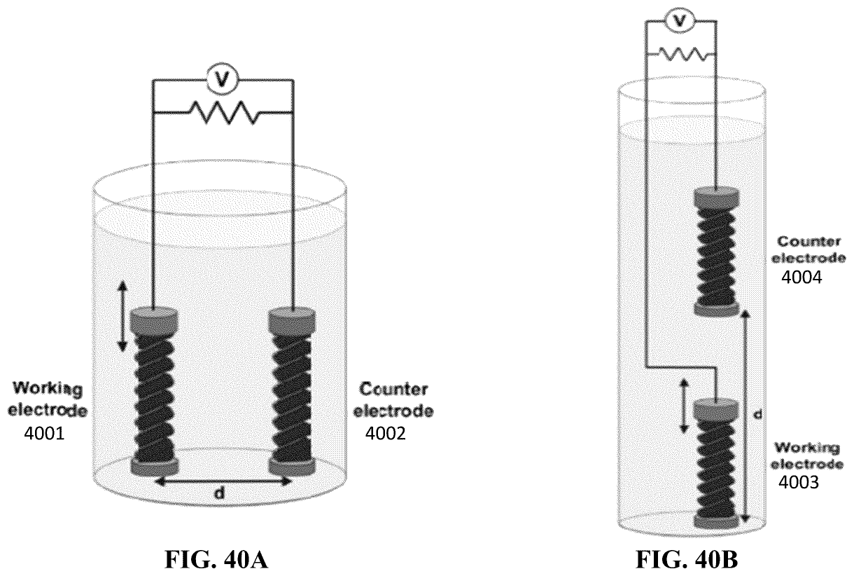

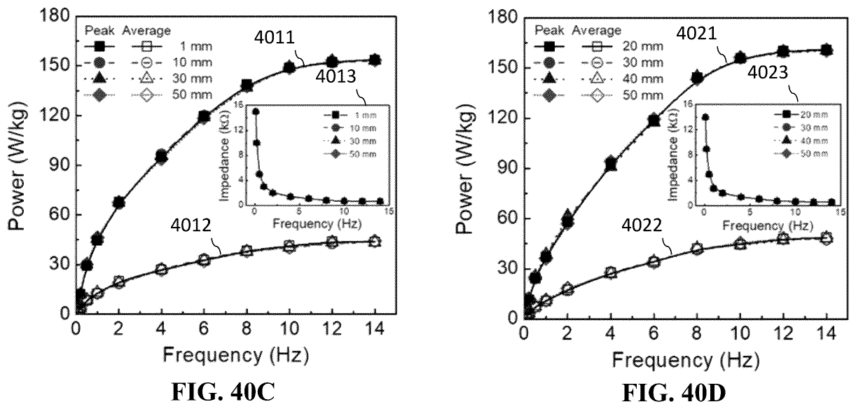

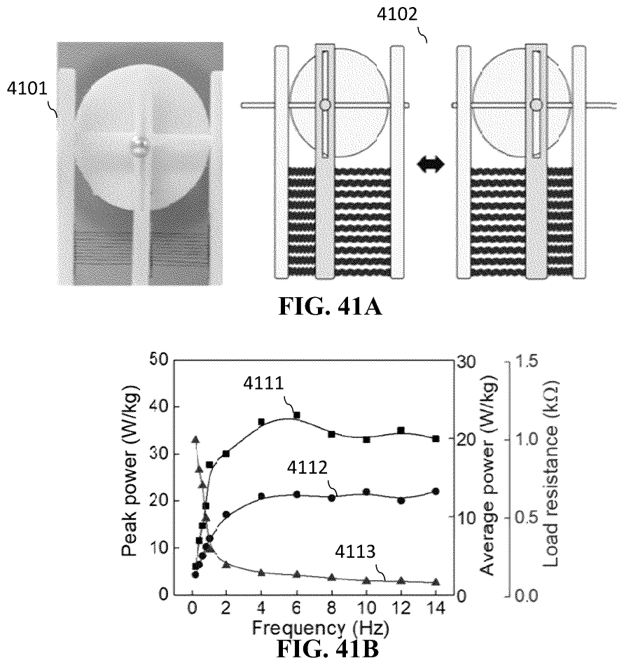

It is useful for many applications to eliminate the weight, volume, and cost of a non-harvesting electrode, as well as to fully utilize the recoverable part of the mechanical energy that is introduced into twistrons during stretch. It has been found that identical twistron yarns can be linearly configured as anode and cathode to provide about the same average output electrical power per total twistron weight at all frequencies as a single twistron harvester, thereby eliminating the need for a non-harvesting counter electrode. This was demonstrated by using the rGO@CNT (FIGS. 38A-38E) and TOP twistrons (FIGS. 39A-39D and 40A-40D) in a seesaw configuration, in which identical, mechanically-connected, torsionally-tethered anode and cathode twistrons are deformed 180° out-of-phase by axially translating the mechanical junction between these twistrons. Since the initially inserted strain energy in one twistron is released as the strain energy in the other twistron is increased, the mechanical energy input is correspondingly decreased. Since both electrodes provide opposite potential changes, the peak-to-peak open circuit voltage was doubled to 0.59 V by using the seesaw, although the short-circuit current was little changed. FIGS. 38A-38E.

To realize the benefits of the seesaw structure, while reducing inter-electrode diffusion distances and enabling upscaling, opposing twistron electrodes were located in the negative and positive linear compressibility directions [Baughman 1998; Zhou 2016] of hinged wine-rack frames. FIG. 36E and wine-rack frame harvesters 3713 shown in FIG. 37D. Ten 1.7-cm-long twistrons, each weighting 80 μg, were placed parallel in the negative and positive compressibility directions of four wine-rack cells. FIGS. 36C-36D. During harvesting, the structure morphs between two equivalent structures (FIG. 36E), in which the twistrons in the short and long diagonal directions are simultaneously stretched and stretch-release, respectively. Each wine-rack cell provided a peak OCV of 306 mV and SCC of 1.97 mA, and a peak and average power of 76 and 23 W kg⁻¹ when stretched 35% at 1 Hz. When the four cells were connected in series and in parallel, the output OCV and SCC increased to 1.09 V and 7.31 mA (FIG. 37D), even though the total twistron weight was only 6.4 mg. Since rotary mechanical energy is available from wind or water turbines, and the highest electrical power densities in the investigated embodiments were for tensile harvesters, twistron harvesters were also demonstrated that use Scotch yokes [Tao 2017] to scalably convert input rotational energy to tensile energy. FIGS. 41A-41B.

While small diameter twistron yarn harvesters can provide increased power densities at high deformation frequencies, larger diameter twistron yarn harvesters are often more economically fabricable. Hence, in some embodiments, the twistron yarn electrode or electrodes that are mechanically deformed during energy harvesting can have a diameter between 100 nm and 500 μm.

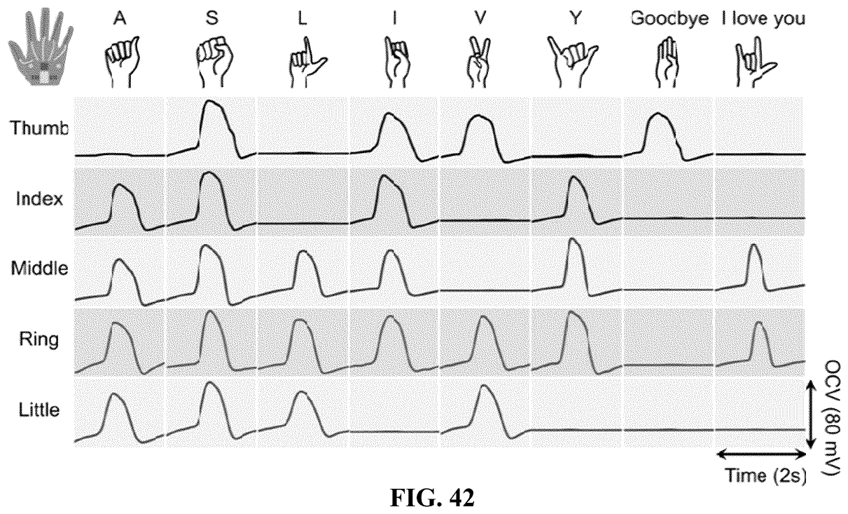

Since eliminating the electrolyte bath can be useful for many applications, a new type of solid-state twistron harvester was devised, in which a solid-electrolyte-coated twisted CNT yarn is coiled around a solid-electrolyte-coated homochiral yarn. See solid-state harvester 3623 shown in FIG. 36F. In-phase stretch of the anode and cathode twistrons usefully generates 180° out-of-phase voltages, since one twistron is homochiral and the other is heterochiral. The resulting solid-state harvester generated a peak OCV of 188 mV when stretched 38% at 1 Hz and can provide arbitrarily high voltages or currents if multiple harvesters are connected in-series or in-parallel, respectively [Wang 2020]. See FIG. 36F. This harvester was used as a self-powered strain sensor that usefully provides quasi-linear changes in the OCV and capacitance with applied strain. These solid-state harvesters were sewn into a glove as self-powered strain sensors for recognizing sign language. FIG. 42 compares American sign language hand gestures with the OCV profiles these gestures generated. Different letters and phrases can be easily differentiated by the output OCV profiles, which is promising for applications like sign-to-speech translation. [Li 2021; Zhou 2020; He 2019]

In embodiments, CNT alignment can determine twistron performance and a host of twistron fabrication methods have been discovered that notably increase harvesting. These methods include selecting highly aligned precursor forests, applying plastic deformation, and using the ITAP and TOP processes. It has also been found that the output voltages and electrical power and energy are simultaneously increased by biscrolling conducting rGO nanoplates into CNT yarns. The peak and average output power for a 30 Hz sinusoidal deformation were 3.19 and 0.86 kW kg⁻¹, respectively, which are over 12-and 3-fold that of the highest values reported for other prior-art mechanical energy harvesters for frequencies between 0.1 Hz and 600 Hz. The maximum energy conversion efficiency obtained by the discovered interrupted deformation process was 7.2-fold that for previous twistrons. These powerful twistrons were integrated into hinged wine-rack frames and Scotch yokes to harvest tensile and torsional mechanical energy and used as self-powered strain sensors for recognizing sign language.

### Further Characterizations and Applications

### Compressive Mechanical Energy Harvesting

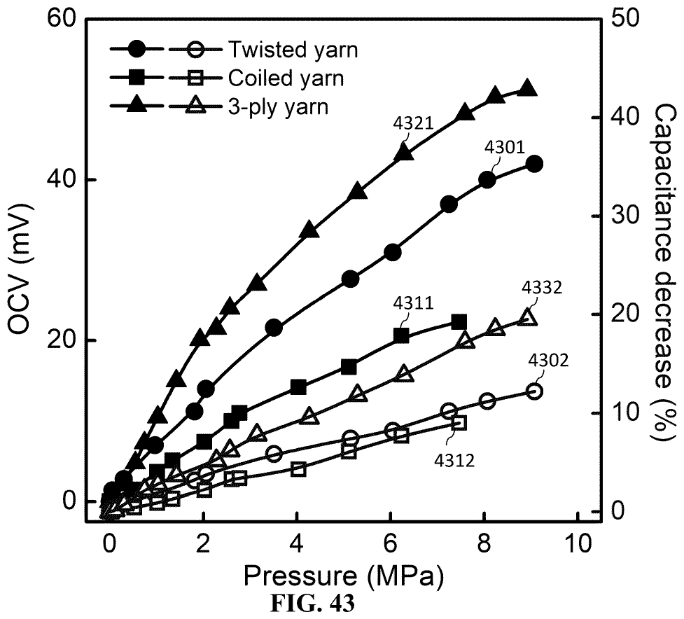

The lateral compression of either a twisted, plied, or coiled CNT yarn produces capacitance changes and resulting OCVs that generate electricity has been shows. Yarns that were plied, twisted, or coiled were subjected to yarn thickness direction compression while under constant tensile strain in the yarn direction. FIG. 43 shows that such uniaxial compression, using up to ˜7 MPa pressure (normalized to the midpoint cross-sectional area of a parallel array of undeformed twistron yarns), produces reversible capacitance decreases that generate OCVs of 48 mV, 37 mV, and 20 mV for 3-ply, twisted, and coiled yarn, respectively.

### Harvesting Performance of Plied Twistrons in 0.1 M Aqueous HCl

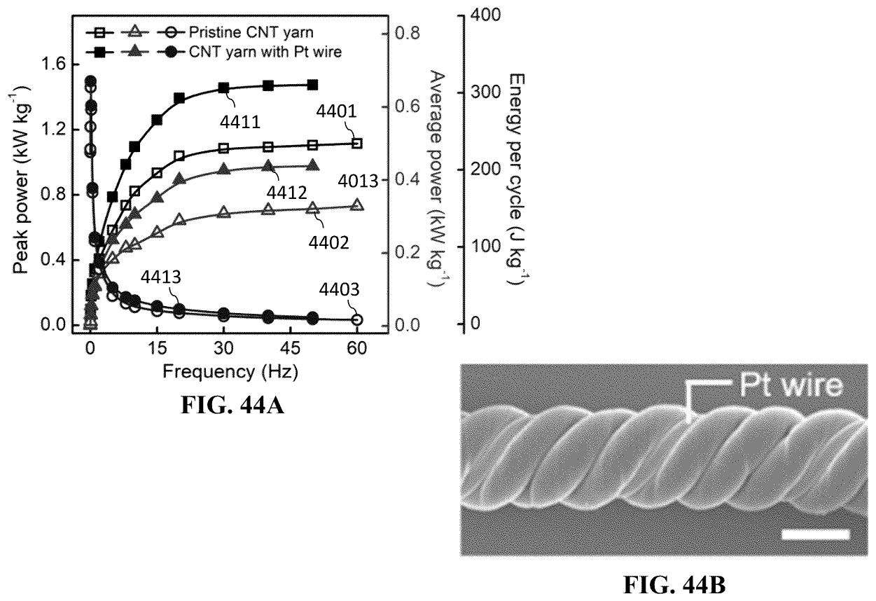

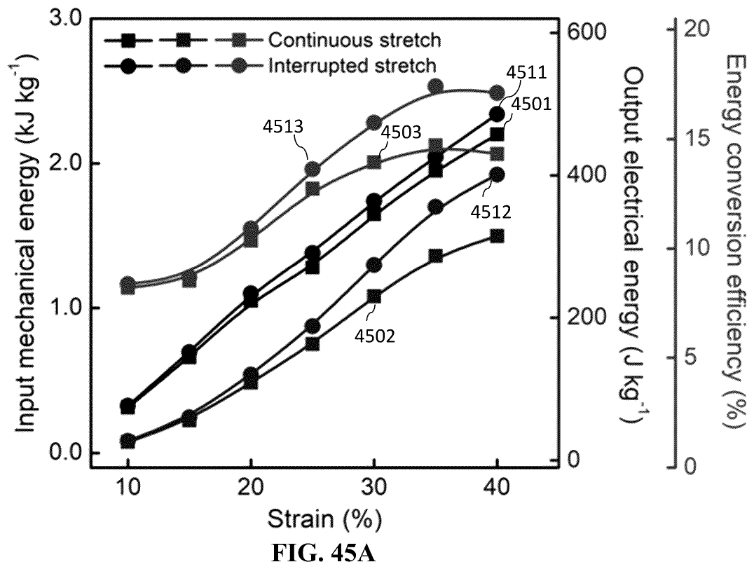

For 40% stretch at 60 Hz, the peak and average power for the OPS harvester were 1115 and 329 W kg⁻¹, respectively, while the maximum output energy per cycle at 0.1 Hz reached 307 J kg⁻¹. FIG. 44A. To increase the output power and energy by decreasing the internal resistance, a 25-μm-diameter Pt wire was incorporated into the OPS harvester during plying. FIG. 44B. This increased the peak and average power to 1475 and 438 W kg⁻¹, respectively, for a 40% strain at 50 Hz. Moreover, the energy per cycle reached 315 J kg⁻¹ for 0.1 Hz deformation.

### Energy Conversion Efficiency of Plied Twistrons

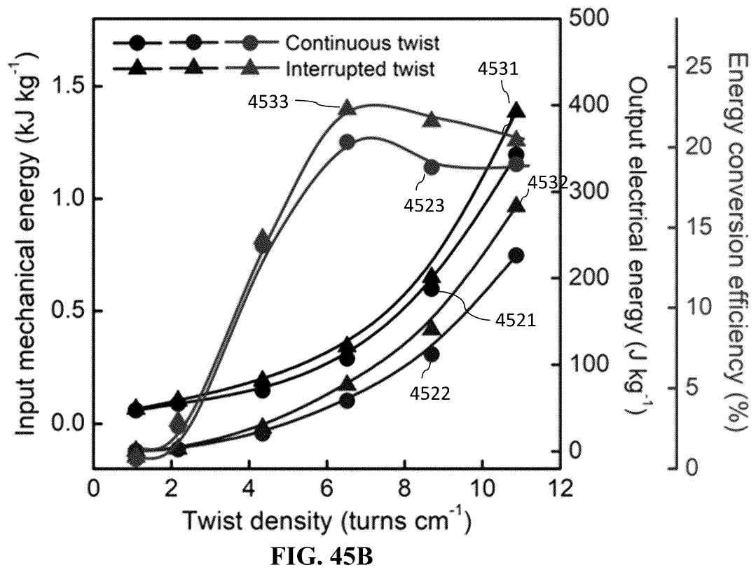

The energy conversion efficiency and output energy were increased by using the above-described interrupted deformation harvesting (IDH) method, in which time intervals are inserted where harvesting is conducted at one or more strain extremes, while the harvester is not being deformed. If IDH is applied for both strain extremes or only at the zero strain or maximum strain extremes, this is called the IDH₀ₘ, IDH₀, or IDHₘ method, respectively. The time interval of IDH for the used sinusoidal deformations in 0.1 M HCl electrolyte is the measured interval for capturing nearly all of the electricity. By inserting a 15s-IDH₀ₘ during 0.1 Hz, 40% deformation of a Pt-wire-plied OPS harvester, the harvested energy per cycle and the energy conversion efficiency were increased to 401 J kg⁻¹ and 17.1%, respectively, compared to the 315 J kg⁻¹ and 14.3% for continuous deformation. FIG. 45A. Use of a 15s-IDH₀ₘ during a 0.1 Hz, 35% deformation increased the electrical energy per cycle to 356 J kg⁻¹ and the energy conversion efficiency to 17.4%.

By extending harvesting for an optimized time of 40 s after twist insertion was completed and after twist removal ended, the per cycle energy harvested was increased from 226 to 283 J kg⁻¹ when using a 12 rpm twist speed for 10.8 turns cm⁻¹ of twist insertion and removal. The maximum efficiency for torsional energy harvesting, which is for a 6.5 turns cm⁻¹ twist density change, increased from 20.4% to 22.4%. FIG. 45B.

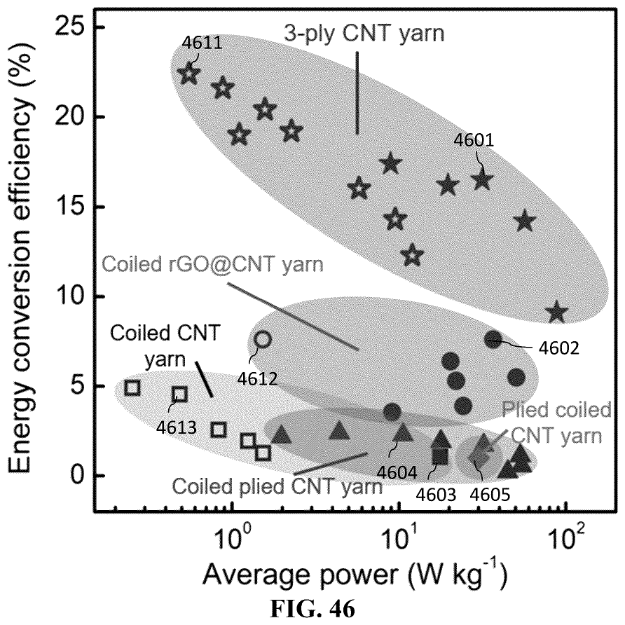

The of 3-ply twistrons with prior-art twistrons in FIG. 46 shows that the simultaneously obtained combination of high energy conversion efficiency and high average power makes the 3-ply twistrons very attractive for applications.

### Poisson's Ratio of Twisted, Coiled, and Plied Twistrons

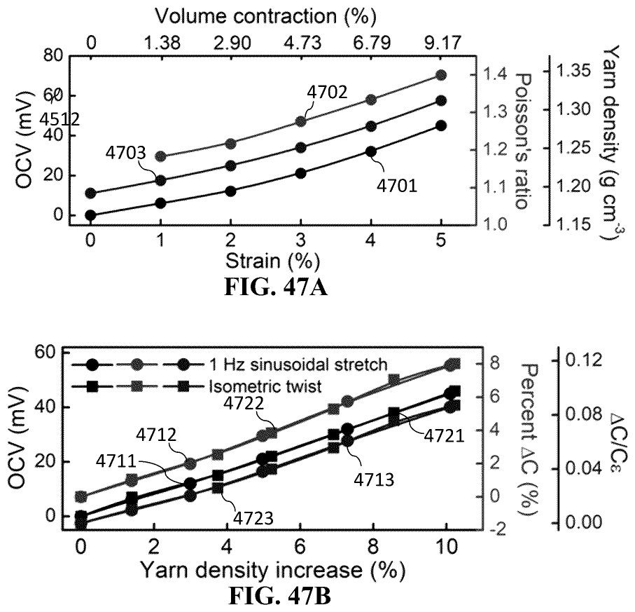

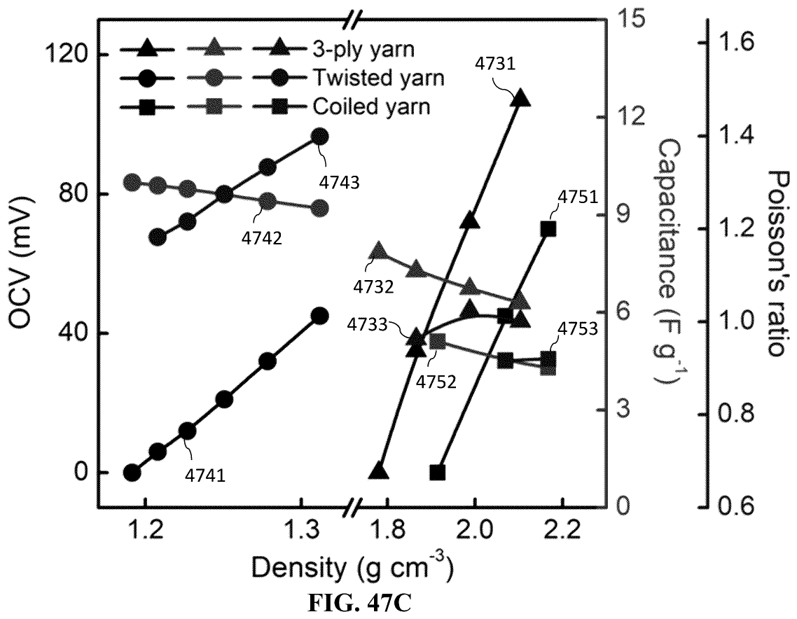

FIGS. 47A-47B show the strain dependence of the OCV, the average Poisson's ratio up to the indicated strain, and the yarn's density for a twisted CNT yarn having an initial bias angle of 33.3° and a twist density of 28 turns cm⁻¹. These results show that the average Poisson's ratio increases from 1.18 for 1% strain to 1.40 for 5% strain, which causes 10.1% stretch-induced densification in going from 0 to 5% strain. Because of this Poisson's ratio effect, the yarn density increased from 1.19 g cm⁻³ at 0% strain to 1.31 g cm⁻³ at 5% strain, which produced an OCV of 45 mV. Using an identically made twistron, about the same yarn density change (from 1.18 to 1.31 g cm⁻³) and OCV (46 mV) was produced by isometrically increasing twist by 2.7 turns cm⁻¹ FIGS. 47A-47B.

In contrast to the large stretch-induced increase in Poisson's ratio of twisted yarns, the Poisson's ratios of a 3-ply yarn and a coiled yarn only weakly depend upon strain, and remain 1.01 and 0.92, respectively, for elongations up to 15%. Due to this large Poisson's ratio of the 3-ply yarn harvester, the density increased from 1.78 g cm⁻³ at 0% strain to 2.10 g cm⁻³ at 15% strain. FIG. 47C. This density increase for the 3-ply yarn was larger than for the coiled yarn when stretched to a given strain.

### Applications of Plied Twistrons

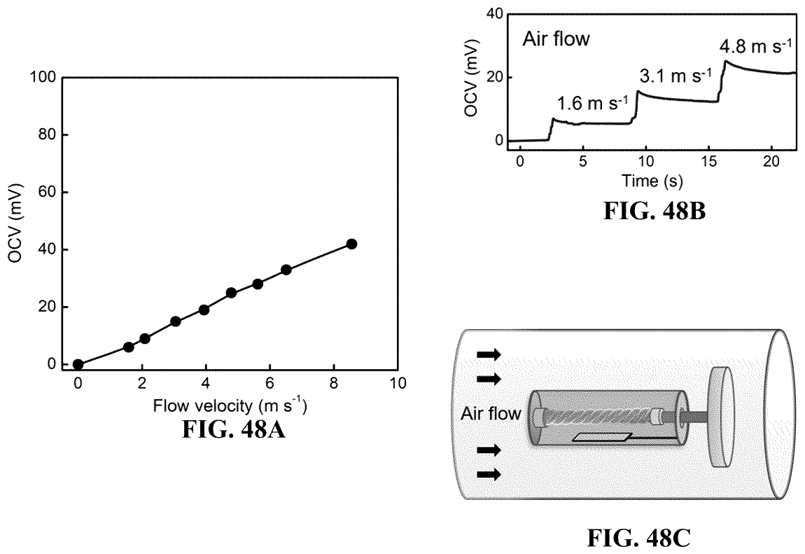

FIGS. 48A-48C shows that the OCV generated by a 31.6-mm-long, 3-ply yarn harvester increased linearly with increasing air flow velocity when this harvester was used as a self-powered air-flow sensor.

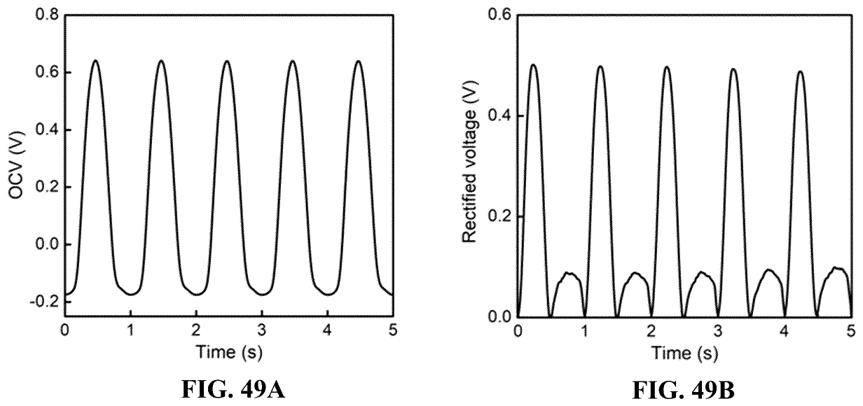

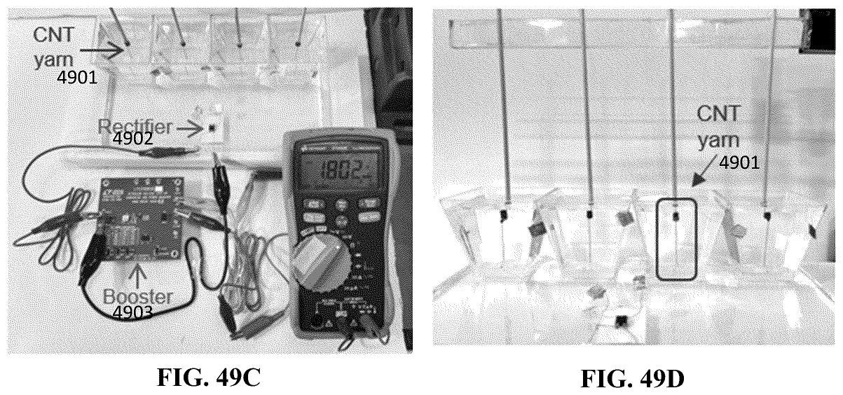

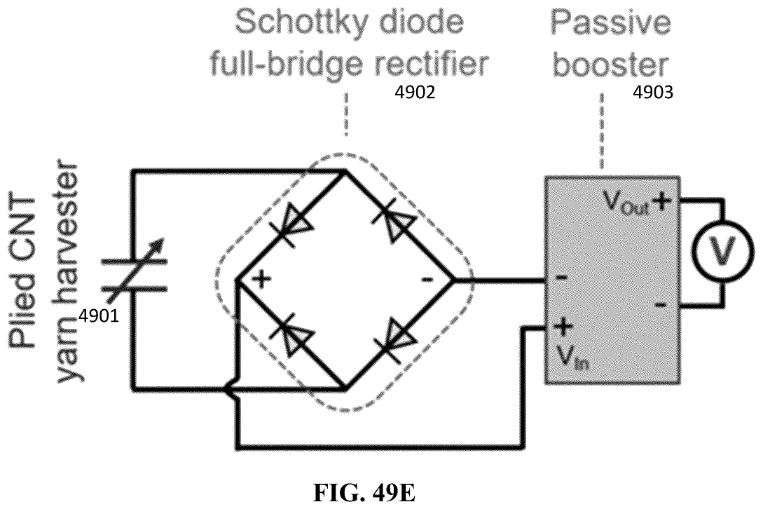

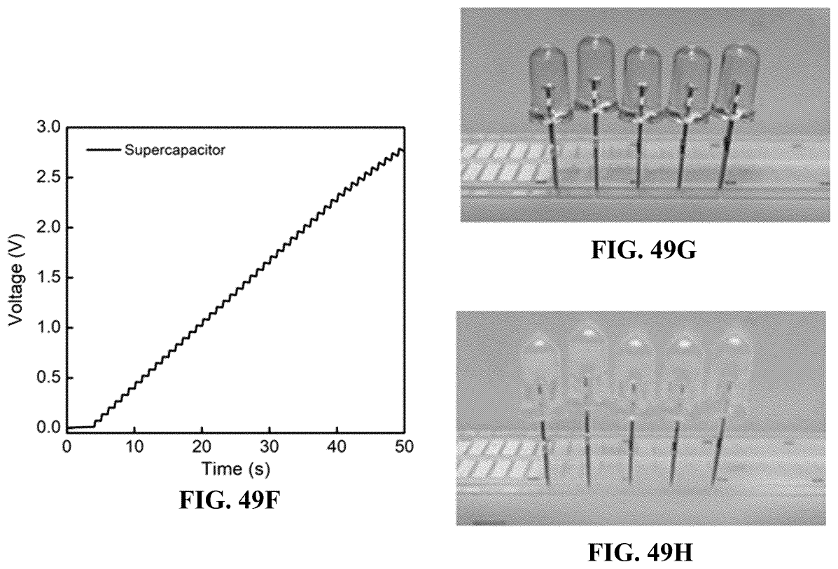

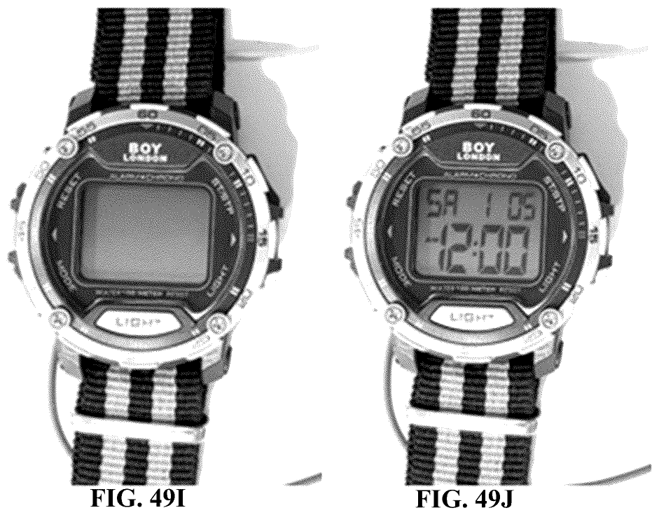

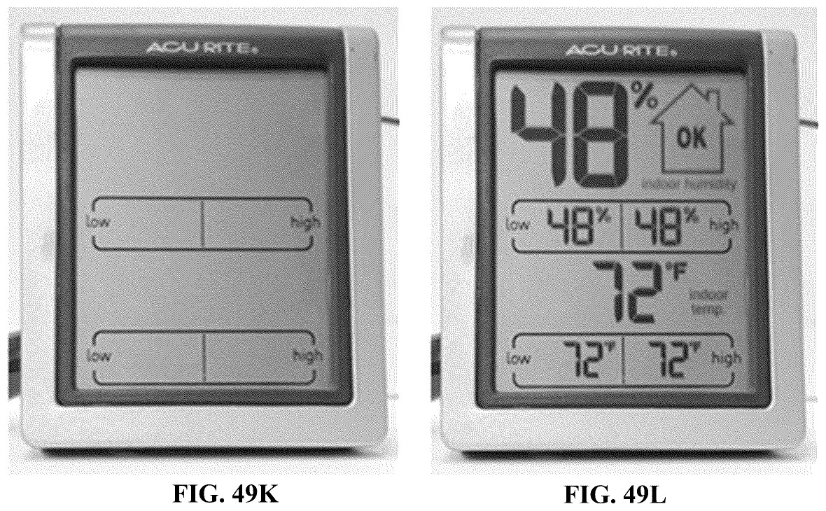

The plied CNT yarn harvesters can be used to power larger devices, including an electronic watch, a digital temperature/humidity monitor, and simultaneously powering 5 LEDs. For example, these were realized by connecting four 0.80-mg, 2.2-cm-long, plied CNT yarn harvesters 4901 in series. FIGS. 49A-49D. Since the OCV is an AC output, a Schottky diode full-bridge rectifier 4902 was used to convert this AC output to DC. As a result, the maximum rectified voltage for these four harvesters was ˜0.5 V. FIG. 49B. To further increase the output voltage, a passive voltage booster 4903 (LTC3108EDE, Linear Technology Corporation) was integrated into the circuit, as shown in FIGS. 49C and 49E. Using this boost converter circuit, 45 stretch-release cycles for this 3.20-mg harvester array charged a 220-μF supercapacitor to 2.8 V. FIG. 49F. The energy stored in the capacitor was used to power five 2.7 V green LEDs, a 2.5 V electronic watch, and a 1.5 V digital temperature/humidity monitor having a 4.5×5.7 cm (2.8-inch) liquid-crystal display. FIGS. 49G-49L.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

U.S. Pat. No. 11,085,422, Coiled and twisted nanofiber yarns for electrochemically harvesting electrical energy from mechanical deformation, issued Aug. 10, 2021, to R. H. Baughman, et al. (“Baughman '422 Patent”).
Bandley, E., et al., Mapping carbon nanotube orientation by fast fourier transform of scanning electron micrographs, Carbon 137, 78-87 (2018) (“Bandley 2018”).
Baughman, R. H., et al., Materials with negative compressibilities in one or higher dimensions, Science 279, 1522-1524 (1998) (“Baughman 1998”).
Chiba, S., et al., Innovative power generators for energy harvesting using electroactive polymer artificial muscles, Proc. SPIE 6927, 692715 (2008) (“Chiba 2008”).
Di, J., et al., Strong, twist-stable carbon nanotube yarns and muscles by tension annealing at extreme temperatures, Adv. Mater. 28, 6598-6605 (2016) (“Di 2016”).
Esconjauregui, S., et al., Measurement of area density of vertically aligned carbon nanotube forests by the weight-gain method, J. Appl. Phys. 113, 144309 (2013) (“Esconjauregui 2013”).
Haines, C. S., et al., Artificial muscles from fishing line and sewing thread, Science 343, 868-872 (2014) (“Haines 2014”).
He, T., et al., Beyond energy harvesting-multi-functional triboelectric nanosensors on a textile, Nano Energy 57, 338-352 (2019) (“He 2019”).
Heinzelman, W. R., et al., Energy-efficient communication protocol for wireless microsensor networks, Proceedings of the 33rd Hawaii International Conference on System Sciences (IEEE, 2000), p. 8020 (“Heinzelman 2000”).
Jalili, R. et al., Scalable one-step wet-spinning of graphene fibers and yarns from liquid crystalline dispersions of graphene oxide: towards multifunctional textiles, Adv. Funct. Mater 23 (43), 5345-5354 (2013) (“Jalili 2013”).
Kim, S. H., et al., Harvesting electrical energy from carbon nanotube yarn twist, Science 357, 773-778 (2017) (“Kim 2017”).
Li, M., et al., Gel-electrolyte-coated carbon nanotube yarns for self-powered and knittable piezoionic sensors, ACS Appl. Electron. Mater. 3(2), 944-954 (2021) (“Li 2021”).
Lima, M. D., et al., Electrically, chemically, and photonically powered torsional and tensile actuation of hybrid carbon nanotube yarn muscles, Science 338, 928-932 (2012) (“Lima 2012”).
Lima, M. D., et al., Biscrolling nanotube sheets and functional guests into yarns, Science 331, 51-55 (2011) (“Lima 2011”).
Liu, A.T., et al., Direct electricity generation mediated by molecular interactions with low dimensional carbon materials-a mechanistic perspective, Adv. Energy Mater. 8, 1802212 (2018). (“Liu 2018”).
Malik, R., et al., “Carbon nanotube sheet: processing, characterization and applications” in Nanotube Superfiber Materials, (William Andrew Publishing, 2014), pp. 349-387 (“Malik 2014”).
Pelrine, R., et al., Dielectric elastomers: generator mode fundamentals and applications, Proc. SPIE 4329, 148-156 (2001) (“Pelrine 2001”).
Shian, S., et al., Optimizing the electrical energy conversion cycle of dielectric elastomer generators, Adv. Mater. 26(18), 6617-6621 (2014) (“Shian 2014”).
Tao, J. X., et al., Energy harvesting from wind by a piezoelectric harvester, Eng. Struct. 133, 74-80 (2017) (“Tao 2017”).
Vallem, V. et al., Energy harvesting and storage with soft and stretchable materials, Adv. Mater. 33(19), 2004832 (2021) (“Vallem 2021”).
Wang, H. et al., Bilayer of polyelectrolyte films for spontaneous power generation in air up to an integrated 1,000 V output, Nat. Nanotechnol. 16(7), 811-819 (2021) (“Wang 2021”).
Wang, Z. L., et al., Toward the blue energy dream by triboelectric nanogenerator networks, Nano Energy 39, 9-23 (2017) (“Wang I 2017”).
Wang, Z. L., Catch wave power in floating nets, Nature 542, 159-160 (2017) (“Wang II 2017”).
Wei, C., et al., A comprehensive review on vibration energy harvesting: Modelling and Realization, Renew. Sust. Energ. Rev. 74, 1-18 (2017) (“Wei 2017”).
Xiang, C., et al., Large flake graphene oxide fibers with unconventional 100% knot efficiency and highly aligned small flake graphene oxide fibers, Adv. Mater. 25, 4592-4597 (2013) (“Xiang 2013”).
Xu, M., et al., Alignment control of carbon nanotube forest from random to nearly perfectly aligned by utilizing the crowding effect, ACS Nano 6, 5837-5844 (2012) (“Xu 2012”).
Xu, W., et al., A droplet-based electricity generator with high instantaneous power density, Nature 578, 392-396 (2020) (“Xu 2020”).
Yang, F., et al., Wafer-scale heterostructured piezoelectric bio-organic thin films, Science 373, 337-342 (2021) (“Yang 2021”).
Zhang, M. et al., Self-powered, electrochemical carbon nanotube pressure sensors for wave monitoring, Adv. Funct. Mater. 30(42), 2004564 (2020) (“Zhang 2020”).
Zhang, M., et al., Strong, transparent, multifunctional, carbon nanotube sheets. Science 309, 1215-1219 (2005) (“Zhang 2005”).
Zhang, Z., et al., Emerging hydrovoltaic technology, Nat. Nanotechnol. 13, 1109-1119 (2018) (“Zhang 2018”).
Zhou, X., et al., 3D cellular models with negative compressibility through the wine-rack-type mechanism, Phys. Status Solidi B 253, 1977-1993 (2016) (“Zhou 2016”).
Zhou, Z. et al., Sign-to-speech translation using machine-learning-assisted stretchable sensor arrays, Nat. Electron. 3, 571-578 (2020) (“Zhou 2020”).

What is claimed is:

1. An electrochemical mechanical energy harvester operable to generate electricity both with and without an external bias voltage, the harvester comprising a first electrode, a second electrode, and at least one electrolyte, wherein:
(a) at least one of the first electrode and the second electrode comprises an electronically conducting yarn that is (i) twisted, (ii) twisted and coiled, (iii) twisted and plied, or (iv) twisted and coiled and then plied;
(b) both the first electrode and the second electrode are electronically conducting, have a high electrochemical surface area, and are in direct contact with an electrolyte;
(c) a path for ionic conductivity exists between the first electrode and the second electrode;
(d) at least one of the first electrode and the second electrode is twisted, twisted and coiled, or twisted and plied, and wherein
(i) both the first electrode and the second electrode have attachments that enable one of the first electrode and the second electrode to be mechanically deformed while mechanical deformation is released from the other electrode;
(ii) at least one of the first electrode and the second electrode is twisted and plied;
(iii) the first electrode and the second electrode are both twisted and coiled, wherein a heterochiral yarn is mandrel coiled around a self-coiled homochiral yarn with a solid or gel electrolyte electronically separating the first electrode and the second electrode; or
(iv) a combination thereof.

2. The electrochemical mechanical energy harvester of claim 1, wherein the energy harvester is operable to convert tensile deformation directly into electrical energy.

3. The electrochemical mechanical energy harvester of claim 1, wherein the energy harvester is operable to convert torsional deformation directly into electrical energy.

4. The electrochemical mechanical energy harvester of claim 1, wherein
(a) both the first electrode and the second electrode have attachments that enable one of these electrodes to be mechanically deformed while mechanical deformation is released from the other electrode; and
(b) one end of the first electrode is mechanically connected to one end of the second electrode through an insulator and the opposite ends of the first electrode and the second electrode are torsionally and positionally tethered, so that displacement of the connection point can cause oppositely directed length changes of the first electrode and the second electrode.

5. The electrochemical mechanical energy harvester of claim 1, wherein
(a) both the first electrode and the second electrode have attachments that enable one of these electrodes to be mechanically deformed while mechanical deformation is released from the other electrode; and
(b) the electrode deformations are produced by either the rotation of a Scotch yoke or the dimensional changes of a wine-rack configuration.

6. The electrochemical mechanical energy harvester of claim 1, wherein one of the first electrode and the second electrode is a harvesting electrode that is deformed during harvesting and that comprises a high surface-area carbon material.

7. The electrochemical mechanical energy harvester of claim 6, wherein the high-surface-area carbon material is selected from a group consisting of carbon nanotubes, carbon nanohorns, graphene, fullerene, activated carbon, carbon black, carbon nanofibers, a pyrolized organic material, and combinations thereof.

8. The electrochemical mechanical energy harvester of claim 6, wherein the energy harvester is operable to provide at least 50 W of peak electrical power per kilogram of the twisted, high-electrochemical-surface-area, conductive yarn when stretched at least one rate that is above 10 Hz.

9. The electrochemical mechanical energy harvester of claim 6, wherein the energy harvester is operable to provide at least 50 J of electrical energy per kilogram of the twisted, high-electrochemical-surface-area, conductive yarn per mechanical cycle when stretched at a frequency that is below 1 Hz.

10. The electrochemical mechanical energy harvester of claim 1, wherein
(a) at least one of the first electrode and the second electrode comprises an electronically conducting yarn that is (i) twisted, (ii) twisted and coiled, (iii) twisted and plied, or (iv) twisted and coiled and then plied; and
(b) the twisted yarn has a diameter between 100 nm and 500 μm.

11. The electrochemical mechanical energy harvester of claim 1, wherein the energy harvester is operable to generate a change of voltage of at least 150 mV during stretch.

12. The electrochemical mechanical energy harvester of claim 1, wherein at least one of first and second electrodes comprises a twisted and plied yarn.

13. The electrochemical mechanical energy harvester of claim 12, wherein the twisted and plied yarn comprises carbon nanotubes.

14. The electrochemical mechanical energy harvester of claim 12, wherein chirality of yarn twist is the same as chirality of yarn plying.

15. The electrochemical mechanical energy harvester of claim 12, wherein three yarns are plied together.

16. The electrochemical mechanical energy harvester of claim 15, wherein coil bias angle that results from plying is over 25°.

17. The electrochemical mechanical energy harvester of claim 15, wherein spring index of the yarn obtained by plying is at most 1.2.

18. The electrochemical mechanical energy harvester of claim 15, wherein the three plied yarns are coiled together.

19. The electrochemical mechanical energy harvester of claim 1, wherein the electrochemical mechanical energy harvester is deployed as a self-powered strain sensor.

20. The electrochemical mechanical energy harvester of claim 1, wherein the electrochemical mechanical energy harvester is deployed for converting wind or wave mechanical energy to electricity.

21. A self-powered strain sensor that comprises the electrochemical mechanical energy harvester of claim 1.

22. The self-powered strain sensor of claim 21, wherein the electrochemical mechanical energy harvester is a self-powered strain sensor.

23. An apparatus for converting wind or wave mechanical energy to electricity that comprises the electrochemical mechanical energy harvester of claim 1.

24. The apparatus of claim 23, wherein the electrochemical mechanical energy harvester is utilized to convert wind or wave mechanical energy to electricity.

25. A textile that comprises the electrochemical mechanical energy harvester of claim 1.

26. An apparatus that comprises the electrochemical mechanical energy harvester of claim 1 connected to an energy storage device.

27. A system that comprises a plurality of electrochemical mechanical energy harvesters of claim 1, wherein the plurality of electrochemical mechanical energy harvester are connected (a) in series to increase output voltage, (b) in parallel to increase output current, or (c) a combination thereof.

28. A method of operating the electrochemical mechanical energy harvester of claim 1, wherein
(a) a first time interval exists soon after electrode deformation to substantially the maximally deformed state, and,
(b) during the first time interval, further electrode deformation does not substantially occur, but during which mechanical energy harvesting is conducted.

29. The method of claim 28, wherein
(a) a second time interval exists soon after deformation release to substantially the minimally deformed state, and
(b) during the second time interval, further electrode deformation does not substantially occur, but during which mechanical energy harvesting is conducted.

30. A method of operating the electrochemical mechanical energy harvester of claim 1, wherein
(a) a first time interval exists soon after electrode deformation to substantially the minimal deformed state, and,
(b) during the first time interval, further electrode deformation does not substantially occur, but during which mechanical energy harvesting is conducted.

31. A method of operating the electrochemical mechanical energy harvester of claim 1, wherein the output peak or average electrical energy for the same percent stretch is increased in the approximate frequency range of 0.1 to 5 Hz by applying a square-wave stretch, rather than a sinusoidal stretch.

32. A process for making a twisted and plied yarn electrode for a mechanical energy harvester, wherein three twisted yarns having the same twist chirality are plied together using the same chirality of plying as for the chirality of yarn twist while under a mechanical stress that is less than one-half of the mechanical stress applied during the fabrication of these twisted yarns.

33. A process for making a twisted and coiled mechanical harvester yarn comprising carbon nanotubes, wherein the process comprises twist insertion into an oriented carbon nanotube sheet that has a Herman's orientation factor that is in the range between approximately 0.45 and approximately 0.75.

34. The process of claim 33, wherein the process forms a twisted and coiled mechanical harvester yarn comprising carbon nanotubes and graphene nanoplatelets, wherein the process comprises depositing graphene oxide nanoplatelets or graphene nanoplatelets on an oriented carbon nanotube sheet.

35. The process of claim 33, wherein
(a) an incandescence tension anneal process is applied to the twisted yarn before the yarn is coiled;
(b) bias angle of the twisted yarn is between 10° and 35°; and
(c) peak temperature applied during the incandescence tension anneal process is above 2000° C.

36. The process of claim 33, wherein
(a) incandescence tension anneal process is applied to the twisted yarn before the yarn is coiled;
(b) applied stress is between 10 MPa and 70 MPa; and
(c) treatment time is between 5 seconds and 300 seconds at a temperature above 2000° C.

37. The process of claim 33, wherein
(a) irreversible plastic deformation is applied to the twisted yarn before the yarn is coiled;
(b) bias angle of the twisted yarn is between 10° and 35°; and
(c) applied strain is below a threshold that would cause the yarn to fracture.

38. A process for making a twisted and coiled yarn electrode for a mechanical energy harvester, wherein the process comprises that mechanical stress is applied during yarn twist that is more than two times the mechanical stress applied during yarn coiling.

39. The process of claim 38, wherein the mechanical loads applied during yarn twist and yarn coiling are sufficient to provide a spring index that is between 0.3 and 0.8.
